(19) United States
(12) Patent Application Publication
(10) Pub. No.: US 2026/0028486 A1
(43) Pub. Date: Jan. 29, 2026

(54) METHODS AND COMPOSITIONS PROVIDING HIGH PERFORMANCE THERMOPLASTIC NANOCOMPOSITE LAYERS FOR USE IN PACKAGING APPLICATIONS

(71) Applicant: Smart Planet Technologies, Inc., Newport Beach, CA (US)

(72) Inventor: Christopher R. Tilton, Laguna Hills, CA (US)

(21) Appl. No.: 19/343,015

(22) Filed: Sep. 29, 2025

Related U.S. Application Data
(63) Continuation-in-part of application No. 19/052,140, filed on Feb. 12, 2025.
(60) Provisional application No. 63/554,615, filed on Feb. 16, 2024.
(60) Provisional application No. 63/713,510, filed on Oct. 29, 2024.

(51) Int. Cl. C09D 5/16; B65D 65/42; C08K 7/00; C08K 9/02; C09D 7/40; C09D 7/62; C09D 123/06

(52) U.S. Cl. CPC C09D 5/1618; B65D 65/42; C09D 7/62; C09D 7/67; C09D 7/68; C09D 7/70; C09D 123/06; B65D 2565/387; C08K 7/00; C08K 9/02; C08K 2201/004; C08K 2201/005; C08K 2201/006; C08K 2201/011; C08K 2201/016

(57) ABSTRACT

This disclosure provides novel thermoplastic nanocomposites having monomodal, bimodal, and multimodal mineral particles dispersed within the polymer matrix to provide high performance thermoplastic nanocomposite barrier layer(s). The thermoplastic nanocomposite barrier layer enhances barrier performance to include moisture, water, and oxygen barrier characteristics used in consumer and industrial packaging applications. Mineral fillers, such as clay nanoparticles combined with micro and colloidal diatomaceous earth, such as calcium carbonate being one example. Bimodal and multi-modal particle combinations can play a significant role in improving intercalation and exfoliation of nanoparticles within the thermoplastic matrix during the compounding and extrusion. The present disclosure includes descriptions of thermoplastic nanocomposites as part of blown films, paper extrusion coatings, and extrusion laminations. The barrier layers may be part of single and multi-layer thermoplastic layers used as films and paper coatings in the range of about 6 to 600 g/m2.

### CROSS-REFERENCE TO RELATED APPLICATIONS

This application is a Continuation-in-Part of U.S. Non-Provisional patent application Ser. No. 19/052,140, filed Feb. 12, 2025, by inventor Christopher R. Tilton, the contents of which are expressly incorporated herein by this reference, and to which priority is claimed. U.S. Non-Provisional patent application Ser. No. 19/052,140 claims the benefit of U.S. Provisional Patent Application No. 63/713,510, filed Oct. 29, 2024, by inventor Christopher R. Tilton, the contents of which are expressly incorporated herein by this reference, and to which priority is claimed. U.S. Non-Provisional patent application Ser. No. 19/052,140 also claims the benefit of U.S. Provisional Patent Application No. 63/554,615, filed Feb. 16, 2024, by inventor Christopher R. Tilton, the contents of which are expressly incorporated herein by this reference, and to which priority is claimed.

### FIELD

The present disclosure relates to a method and composition providing nano particles dispersed within a thermoplastic matrix and/or with other mineral particles in monomodal and multimodal thermoplastic nanocomposites optimizing functional barrier performance. This disclosure is most particularly pertinent for industrial and consumer packaging applications. The disclosures contained herein are derived from thermoplastics packed with combinations dispersed into a polymer matrix.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

Therefore, the present disclosure relates to reduced layer permeation, in general, and more specifically barriers for oxygen, moisture, and water. The present disclosure incorporates the novel use of mineral particles, individually or in combination, dispersed into a polymer matrix. The nanocomposite layer formed from compounded pellets forming a functional barrier layer used as a monolayer or individual layer within a coextrusion formed via extrusion, extrusion lamination, blown films, and the extrusion coating processes Improved performance is achieved by dispersing nanoparticles combined with colloidal and/or micro particles having mean particles sizes from about 0.5 microns to about 6 microns up to about 30 microns. The combined thermal and mechanical attributes of the fillers enhance the tortuous path within the layer, greatly improving barrier performance. Additionally, micro particles alter mechanical conditions within the matrix, accelerating intercalation and exfoliation. The combination of micro and colloidal particles with nanoparticles accelerate nucleation and crystallization density. Because nanoparticles have aspect ratios from about 50-500, and having aspect ratios within the range of [150-200] and/or [201-250] and/or [251-300] and/or [301-350] and/or [351-400] and/or [401-450] and/or [451-500] and/or [501-550] and/or [551-600] and/or [601-650] and/or [651-700] and/or [701 to 750] and/or [751-800] and/or [801-850] and/or [851-900] and/or [901-950] and/or [951-1000] small amounts of nano-fillers, such as from about 1% to about 6% by weight of the layer, can provide an excellent barrier. The thermoplastic nanocomposites after compounding forming pellets used in extrusion thus forming a functional barrier layer; the layer structure used as a monolayer or individual layer within a coextrusion formed via extrusion, extrusion lamination, blown films, and the extrusion coating processes can contain diatomaceous earth particles, preferably in the size range of from about 10 to 100 nanometers in at least one dimension. These particles are dispersed into a thermoplastic matrix and combined with microparticles. The microparticles may be present in the matrix at about 0% to 28% by volume of the composite per ASTM D2815 “Standard Test Method for Oil Absorption of Pigments by Spatula Rub-out” (the D2815 Standard) The D2815 Standard of the ASTM (American Society of Testing and Materials) measures the oil absorption of pigments, which can be related to their surface area and packing behavior. Also, the D2815 Standard is a preferred standard throughout the present disclosure, including examples and the contents of all of the tables herein. The D2815 Standard provides an indirect estimation of filler volume. Additionally, the inclusion of a small volume of nanoparticles has little effect on the density by the Pycnometer Method, ASTM D3878 and ISO 1183 and X-ray Reflectivity (XRR) as processability of mineral containing thermoplastics during extrusion.

Furthermore, for added permeation barrier and/or cosmetics, the thermoplastic nanocomposite itself and the finished packaging coating outer surface may also contain Silicon Dioxide (SiO2), Aluminum Oxide (Al2O3), Titanium Dioxide (TiO2), Ethylene Vinyl Alcohol (EVOH), and Polyvinylidene Chloride (PVDC).

The present disclosure thus refers to the following embodiments, wherein the term “claim” refers to one possible embodiment.

Particle size distribution (PSD) shows the range of particle sizes present in a sample. It helps to characterize materials. Mode size may preferably be the maximum (or highest peak) in a PSD graph. It represents the particle size with the highest frequency. Monomodal distribution refers to a sample with a single peak in its distribution curve. This suggests a single, uniform population of particles. Multimodal distribution refers to a sample that has more than one distinct maximum (plural being maxima). For example, bimodal has two peaks and trimodal has three peaks. Each maximum typically represents a separate population of particles with a different size.

Multimodal particle size distribution includes bimodal, so instances herein referring to multimodal are in fact referring to bimodal and/or multimodal PSD.

Claim 1. Mineral-containing polymer layer comprising mineral particles having a single particle or multimodal particle size distribution.

Claim 2. The mineral-containing polymer layer according to claim 1 wherein the distance between the two maxima of the bimodal distribution or the distance between two (adjacent) maxima of the multimodal distribution is at least 1.4 μms, wherein the particle size distribution is preferably determined by using an instrument of Malvern Instruments, Ltd., Malvern, UK, a Mastersizer 3000 or analytical methods pertaining to ISO 13320-2020.

Claim 3. The mineral-containing polymer layer according to any preceding claim wherein one maximum of the bimodal distribution or of the multimodal distribution lies in the range of 1.5 to 30 μms and one maximum lies in the range of 5-100 nm, wherein the particle size distribution is preferably determined by using an instrument of Malvern Instruments, Ltd., Malvern, UK, preferably a Mastersizer 3000 or analytical methods pertaining to ISO 13320-2020.

Claim 4. The mineral-containing polymer layer according to any preceding claim wherein the bimodal or multimodal distribution results from the presence of at least two different types of mineral particles, wherein the two different types of mineral particles have a different maximum of the particle size distribution, wherein a first type of mineral particles are coated (e.g. with stearic acid) or non-coated micro particles having a mean particle size from 1.5 μm-30 μm, preferably 3.0 μm-6.5 μm or 7 μm-10 μm (preferably the particle size is determined like specified for the second type of particles), and a second type of particles are nanoparticles having a mean particle size from 5-50 nm, preferably 5-75 nm and or 5-100 nm as determined by using a volumetric dynamic laser light scattering method, preferably by using an instrument of Malvern Instruments, Ltd., Malvern, UK, preferably a Mastersizer 3000 or analytical methods described in ISO 13320-2020 and Transmission Electron Microscopy (TEM) the mineral particles of the first and second type of particles differ from each other by one or more properties selected from the group consisting of chemical composition, preferably the types of particles are selected from the group consisting of nanoclay OMT AND MMT and/and calcium carbonate, preferably calcium carbonate having a specific heat of 0.200 to 0.214 calories required to heat 1 gram 1 degree C. and nanoclay OMT AND MMT and/having a specific heat in the range: 0.75-1.1 Joules per gram per degree Celsius (J/g° C.) as determined by ASTM standard E1269” Standard Test Method for Determining Specific Heat Capacity by Differential Scanning Calorimetry.

Claim 5. The mineral-containing polymer layer according to any preceding claim, wherein the bimodal or multimodal distribution results from the presence of at least two different types of particles, wherein the two different types of particles have a different maximum of the particle size distribution, wherein a first particle type having mean particle size distributions from 100 nanometers or less in at least one dimension and the second micro CaCO3 particle from 1.5 to 10 μm determined by using Transmission Electron Microscopy (TEM).

Claim 6. The mineral-containing polymer layer according to any preceding claim, wherein the particles dispersed within the polymer matrix having a specific surface area cation exchange capacity falling for example within a broader range of 150 to 350 meq/100 g as calculated by Cobalt hexammine trichloride (CoHex)-ICP-MS: and with densities between 1.2 g/cm3 to 2.9 g/cm3 and also from as determined by ISO 1183 and dispersed with particles having a functionally neutral or negative charge or negative and a density of 2.71 g/cm3 (+−) 10% as calculated as above.

Claim 7. The mineral-containing polymer layer according to any preceding claim, wherein the mineral particles comprise nanoclay OMT AND MMT in an amount of 2.5% to 12% by volume of the composite/the mineral-containing polymer layer dispersed with micro particles of CaCO3 comprising from 1% to 28% by volume of the composite, and/or the polymer matrix thermoplastic composition can be comprised from 80% to 95% polyethylene and copolymers of polyethylene including LDPE, HDPE, PP, and LLPDE having average molecular weights in the range of 50,000 to 300,000 g/mol with density ranges falling within the range 0.915 g/cm3 to 0.985 g/cm3 (+−2%) as determined by TAPPI T535, Density of Plastic Pellets by the Gradient Technique and Gel Permeation Chromatography (GPC).

Claim 8. The mineral-containing polymer layer according to any preceding claim, comprising; 66-89% by volume of thermoplastic polymers; 1-28% by volume of mineral microparticles of the first type; 2.5-10% by volume of mineral nanoparticles of the second type; wherein the total amount of thermoplastic and minerals is in a range of 67% to 100%, and bimodal particles comprising 1% to 10% by volume of the composite are dispersed with particles comprising from 1% to 28% by volume of the composite.

Claim 9. The mineral-containing polymer layer according to any preceding claim, wherein the first type of mineral particles is present in an amount 1%-28% by volume based on the total volume of the mineral-containing (polymer) layer and the second type of mineral particles is present in an amount of 1% to 10% by volume based on the total volume of the mineral-containing (polymer) layer.

Claim 10. The mineral-containing polymer layer according to any preceding claim, wherein the bimodal particles are dispersed within a polymer matrix having nucleation densities within a range of 10\hat{ }6-10\hat{ }8 and ranges from 10\hat{ }9-10\hat{ }12 and as determined by Polarized Optical Microscopy (POM) ASTM D3324, “Standard Test Method for Flow Orientation in Thermoplastic Films by Spherulitic Crystallization”.

Claim 11. The mineral-containing polymer layer according to any preceding claim, wherein the polymer contains polymers having a crystallinity in a range from about 60% to 80% and between 40% to 55% determined by X-ray Diffraction (XRD) and Differential Scanning Calorimetry (DSC) containing dispersed particles having a thermal conductivity of 0.20 W/MK to about 0.45 W/mK per ASTM C177 “Standard Test Method for Steady-State Thermal Transmission Properties by Means of the Guarded-Hot-Plate Apparatus”.

Claim 12. The mineral-containing polymer layer according to any preceding claim, wherein the first type of mineral particles are coated (with one or more selected from stearic acid, polyethylene glycol (PEG), polyoxymethylene sorbitan monolaurate, sodium lauryl sulfate, sodium dodecyl sulfate, fluor-surfactants, and cetyltrimethylammonium bromide) or uncoated calcium carbonate or talc or diatomaceous earth; and/or the second type of mineral particles are OMMT AND MMT or OMT AND MMT particles.

Claim 13. The mineral-containing polymer layer according to any preceding claim, having a charge density from about −1.0 to −4.5 (+−5%) calculated using electrophoretic mobility and potentiometric titration methodology.

Claim 14. The mineral-containing polymer layer according to any preceding claim, comprising micro particle properties having a specific heat of 0.200 to 0.214 calories required to heat 1 gram 1 degree C. determined by ASTM standard E1269 “Standard Test Method for Determining Specific Heat Capacity by Differential Scanning Calorimetry” and ASTM standard D2766 “Standard Test Method for Specific Heat of Liquids and Solids by Differential Scanning Calorimetry.

Claim 15. The mineral-containing polymer layer according to any preceding claim wherein the bimodal or multimodal distribution results from the presence of at least two different types of mineral particles, wherein the two different types of mineral particles have a different maximum of the particle size distribution, wherein a first type of mineral particles are micro particles having a mean particle size from 1.5 μm-30 μm, preferably 3.0 μm-6.5 μm or 7 μm-10 μm wherein said particle size distribution is determined by using Transmission Electron Microscopy (TEM), and a second type of particles are nanoparticles having a particle size in at least two dimensions of the particles from nm wherein said particle size distribution is preferably determined by using an instrument of Malvern Instruments, Ltd., Malvern, UK, preferably a Mastersizer 3000, and/or analytical methods described in ISO 13320-2020, and/or wherein the mineral particles of the first type of particles are comprised of calcium carbonate and the second type of particles are comprised of nanoclay OMT AND MMT wherein the calcium carbonate preferably has a specific heat of 0.200 to 0.214 calories required to heat 1 gram 1 degree C. and the nanoclay OMT AND MMT has a specific heat in the range: 0.75-1.1 Joules per gram per degree Celsius (J/g° C.) determined by ASTM standard E1269 “Standard Test Method for Determining Specific Heat Capacity by Differential Scanning Calorimetry”.

Claim 16. The mineral-containing polymer layer according to any preceding claim wherein the first type of mineral particles is selected from diatomaceous earth micro particles of calcium carbonate; and the second type of particles is selected from nanoclays (Montmorillonites (OMT AND MMT) and/or (OMMT AND MMT) and nano-silica (N-silica).

Claim 17. The mineral-containing polymer layer according to any preceding claim with bimodal distribution results from the presence of at least two different types of mineral particles, wherein the two different types of mineral particles have a different maximum of the particle size distribution, wherein a first type of mineral particles are coated micro particles having a mean particle size from 1.5 μm-30 μm, preferably 3.0 μm-6.5 μm or 7 μm-10 μm (preferably the particle size is determined like specified for the second type of particles), and a second type of particles are nanoparticles having a mean particle size from 5-50 nm, preferably 5-75 nm or 5-100 nm as determined by using a volumetric dynamic laser light scattering method, preferably by using an instrument of Malvern Instruments, Ltd., Malvern, UK, preferably a Mastersizer 3000 or analytical methods described in ISO 13320-2020 and Transmission Electron Microscopy (TEM) the mineral particles of the first and second type of particles differ from each other by one or more properties selected from the group consisting of chemical composition, preferably the types of particles are selected from the group consisting of nanoclay OMT AND MMT and/or OMMT AND MMT and calcium carbonate, preferably calcium carbonate having a specific heat of 0.200 to 0.214 calories required to heat 1 gram 1 degree C. and nanoclay OMT AND MMT and/or OMMT AND MMT having a specific heat in the range: 0.75-1.1 Joules per gram per degree Celsius (J/g° C.) as determined by ASTM standard E1269 “Standard Test Method for Determining Specific Heat Capacity by Differential Scanning Calorimetry.

Claim 18. The 25 g/cm2 mineral containing polymer layer according to any preceding claim having a moisture vapor transmission rate (MVTR) in a ranges from 0.49-0.99 @50% RH, 23 C per Tappi T464 stated in g/m2/24 hours and oxygen barrier in the range of 15-650 @90% RH 23 C per oxygen barrier standard ASTM F2622, @760 mmHg gas pressure, test gas is 100% oxygen per Mocon QMS 702-002, measured at cc(m2/day) and in the range of 0.85-75 @90% RH, 23 C per Tappi T464 stated in g/m2/24 hours and oxygen barrier in the range of 20-312 @90% RH 23 C per oxygen barrier standard ASTM F2622, @760 mmHg gas pressure, test gas is 100% oxygen per Mocon QMS 702-002, measured at cc(m2/day).

Claim 19. A thermoplastic barrier layer having dispersed montmorillonite (OMT, OMMT AND MMT) particles into a polymer matrix, the particles having a +−10% a nanoparticle density between 1.2 g/cm3 to about 1.9 g/cm3 (+−10%) as characterized by the Pycnometer Method, ASTM D3878 and ISO 1183 and X-ray Reflectivity (XRR) and/or wherein the thermoplastic nanocomposite thermoplastic ingredients comprise from 1% to 99% by volume and having a premixture melt flow index “MI” in the range of about 1.2 g/10 min (190 C/2.16 kg) to an MFI of 14.0 gm/10 min (190 C/2.16 kg) per ASTM 1238, the layer applied to one or more fiber layers having weights from 40 g/m2 to about 600 g/m2 per TAPPI T 410 for coated papers and ISO 4592 standard specifying methods for determining the mass per unit area of plastic films.

Claim 20. A thermoplastic barrier layer according to claim 19, comprising an octahedral sheet of aluminum or magnesium hydroxide; and/or wherein the OMMT AND MMT and/or OMT AND MMT nanoclay has isomorphous substitution “IS” in ranges has isomorphous substitution “IS” in ranges about [0.25-0.50] and/or [0.51-1.0] and/or [1.01-1.50] and/or [1.51-2.0] and/or [2.01-2.5] and/or [2.6-3.5] and/or [3.6-4.0] units per formula unit as characterized by calculating the charge deficit: The IS rate is the net negative charge that results from substitution. For example, the replacement of Al3+ with Mg2+ creates a charge deficit of −1 at that site as characterized by ASTM D3124 “Standard Test Method for Infrared Radiation Spectroscopic Analysis of High-Purity Elemental Boron” (although focused on boron, D3124 outlines IR spectroscopy procedures adaptable to other materials and can be used in conjunction with Tappi T 527 “Infrared Spectroscopy of Paper and Paperboard” which describes the use of infrared (IR) spectroscopy to identify functional groups and chemical bonds).

Claim 21. A thermoplastic barrier layer, according to any of claims 19-20, the OMMT AND MMT and/or OMT AND MMT nano-clay dispersed within the thermoplastic composite belonging to the family of barrier structured phyllosilicates and thus comprising a barrier structured silicate (the structure of its crystal consists of multi-dimensional barrier structures obtained by combining tetrahedral silica laminates with a central octahedral sheet of alumina or magnesium).

Claim 22. A thermoplastic barrier layer, according to any of claims 19-21, the barrier structure comprising an unmodified silicate/nano-clay consisting of several barrier layers stacked together, with each inter-layer barrier spacing measured using Small-Angle X-ray Scattering (SAXS) and Transmission Electron Microscopy (TEM) techniques (these layers are stacked together by Van der Walls forces in between them (called gallery or inter-barrier structure), the total of a single barrier structure thickness and the gallery/inter-barrier structure or basal spacing or d-spacing after nano composite formation in nanometers representing the repeating unit of barrier structured silicate as measured by Transmission Electron Microscopy (TEM) which provides direct visualization of the material at the atomic or nanoscale level; High-resolution TEM images can reveal the gallery/inter-barrier structure and directly measure basal spacing).

Claim 23. A thermoplastic barrier layer, according to any of claims 19-22, a mineral containing thermoplastic nanocomposite comprising from 1% to 10% by volume of the composite with aluminum (Al3+) substituting for silicon (Si4+) in the tetrahedral sheets thus creating a net negative charge, with a substitution of about 15%-25% of Si4+ replacing Al3+.

Claim 24. A thermoplastic barrier layer according to any of claims 19-23, having mineral content, comprising a thermoplastic nanocomposite having a negative charge attracting cations to the interlayer spaces, contributing to an OMMT AND MMT and/or OMT AND MMT cation exchange capacity (CEC) of from about 200 to 300 meq/100 g (+−5%), as calculated by Brunauer-Emmett-Teller (BET) method, X-ray diffraction (XRD) and alternatively X-ray Fluorescence (XRF).

Claim 25. A thermoplastic barrier layer according to claim 19-24, with a range of tetrahedral substitution of about 0.20 to 0.50 atoms per unit cell “apfu” with common values of 0.30 to 0.50 apfu, apfu calculated using techniques such as spectroscopic methods, x-ray fluorescence (XRF), and X-ray Diffraction (XRD).

Claim 26. A thermoplastic barrier layer according to any of claims 19-25, having a preferred MG2+ for Al3 substitution in the range of 15%-35%, also with aluminum (Al3+) substituting for silicon (Si4+) in the tetrahedral sheets thus creating a net negative charge, with a substitution of about 15%-25% of Si4+ replacing Al3+ as calculated by Brunauer-Emmett-Teller (BET) method, X-ray diffraction (XRD) and alternatively X-ray Fluorescence (XRF).

Claim 27. A thermoplastic barrier layer according to any of claims 19-26, the thermoplastic nanocomposite which includes one or more selections of thermoplastic content having nucleation densities found in the thermoplastic nanocomposite can include, but not limited to within the ranges of within the ranges of 10\hat{ }6-10\hat{ }8, 10\hat{ }9-10\hat{ }12 and 10\hat{ }13-10\hat{ }15 nuclei/cm³ as determined by Polarized Optical Microscopy (POM) ASTM D3324, “Standard Test Method for Flow Orientation in Thermoplastic Films by Spherulitic Crystallization”.

Claim 28. A thermoplastic nanocomposite used to form a packaging barrier layer including one or more selections of thermoplastic content that are blended into mixtures to be extruded into finished pellets including optional EVOH content, which are then used to form barrier layers having an average density in the range of from 0.915 g/cm3 to 0.985 g/cm3; and/or wherein the thermoplastic ingredients are comprised by 1% to 99% by volume and have a premixture melt flow index “MI” in the range of about 1.2 g/10 min (190 C/2.16 kg) to an MFI of 14.0 gm/10 min (190 C/2.16 kg) per ASTM 1238, the selected thermoplastic ingredient(s) having a density in the range of from about 0.915 g/cm3 to about 0.985 g/cm3 comprising polyethylene and copolymers of polyethylene having average molecular weights in the range of 50,000 to 300,000 g/mol; and/or wherein EVOH can be added to the blend up from 1% to 20% by volume having an MFI from 0.8-22 g/10 min/216 kg, a density of 1.12 to 1.19 g/cm3 determined by Gel Permeation Chromatography (GPC) or Size Exclusion Chromatography (SEC); and/or wherein the EVOH has an Mn from 10,000 to 125,000 g/mol and Mw from 20,000 to 300,000 g/mol; and/or wherein the thermoplastic nanocomposite also comprises mineral particle dispersions into the thermoplastic matrix comprising nanoclay OMMT, MMT, and/or OMT AND MMT having a +−10% a nano particle density between 1.2 g/cm3 to about 1.9 g/cm3 per the Pycnometer Method, ASTM D3878 and ISO 1183 and X-ray Reflectivity (XRR); and/or wherein the OMMT AND MMT and/or OMT AND MMT particles have a pH in the range of about 6.0 to 8.0 and mean sizes of from 5-50 nm, preferably 5-75 nm or 5-100 nm, the nanoclay OMMT AND MMT and/or OMT AND MMT particle having layers comprised of silica tetrahedral sheets around an aluminum octahedral sheet, the nano-clays, OMMT AND MMT and/or OMT AND MMT, nano-silica (N-silica); and/or wherein the OMT AND MMT and/or OMMT AND MMT having clay structure having an octahedral sheet of aluminum (OMT AND MMT and/or OMMT AND MMT having nano-clay belong to the family of structured phyllosilicates and thus provide a barrier structured silicate, the structure of its crystal consists of multi-dimensional barrier structures, obtained by combining tetrahedral silica laminate with the central octahedral sheet of alumina, with a pH from 5 to 9 (these barrier structures are stacked together by Van der Walls forces in between them (called gallery or inter-barrier structure and the gallery/inter-barrier structure or basal spacing or d-spacing representing the repeating unit of barrier structured silicate as measured by Transmission Electron Microscopy (TEM) which provides direct visualization of the material at the atomic or nanoscale level, high-resolution and TEM images revealing the gallery/inter-barrier structure and basal spacing).

Claim 29. A thermoplastic nanocomposite used to form packaging barrier layer(s) according to claim 28 having 1-10% by volume nano-clay per a preferred 0% RH @37.8 C oxygen barrier standard ASTM F2622, per Mocon QMS 702-002, measured at cc(m2/day), with layer weights in the range of 25 g/cm3 having oxygen barriers in the ranges 25-245, 0.15 to 1.30, 5.9-20, 0.12-11.2, 7.7-55, 0.22-61.5, 6.1-78.4, 0.12-1.1, 4.5-66, 0.76-312 and with a layer thickness of 15-30 microns having an oxygen barrier in the range 0.86-125.

Claim 30. A thermoplastic nanocomposite used to form packaging barrier layer(s) with blown films according to any of claims 28-29, having 1-10% by volume nano-clay, with layer weights in the range of 15-25 g/cm3 having moisture vapor transmission rates (MVTR) 90% RH per ISO 4592 standard specifying methods for determining the mass per unit area of plastic films, in the ranges 1.61-7.9, 1.6-6.60, 0.96-4.55, 1.49-8.81, 0.75-2.66, 1.26-4.88, and with a layer thickness of 6 to 10 microns in the ranges of 8.9-12.4.

Claim 31. A thermoplastic nanocomposite used to form packaging barrier layer(s) according to any of claims 28-30, with 1-5% by volume nano-clay having 90% RH @37.8 C moisture vapor transmission rates (MVTR) per Tappi T464 stated in g/m2/24 hours and in the range of 4.2-7.5 and 7.3-8.87. Claim 32. The composite material or structure according to any of claims 1-31 which is a container which is partly or completely made of the layered material wherein the container is either a flexible or rigid packaging structure.

Claim 33. A composite packaging structure including a fiber-containing layer, preferably cellulose fiber/paper, and a mineral-containing polymer layer as defined in any of claims 1-32.

Claim 34. The composite packaging structure of claim 33, wherein the mineral-containing polymer layer comprises from 20% to 70 wt. % mineral content by weight based on the weight of the mineral-containing polymer layer.

Claim 35. The composite packaging structure of claim 33 or 34, wherein the mineral-containing polymer layer is a single homogeneous layer having a uniform mineral density throughout the layer, or two or more mineral-containing polymer layers are coextruded to form a stack of (distinguishable) mineral-containing polymer layers, or the structure comprises two single mineral-containing polymer layers each in the form of a homogeneous layer having a uniform mineral density throughout the layer, wherein the mineral-containing polymer layers are on opposite sides of the fiber-containing layer, or the structure comprises two stacks of mineral-containing polymer layers according to option b), wherein the stacks are on opposite sides of the fiber-containing layer, wherein optionally in options a)-d) there is one or more polymer layers without mineral content between the fiber-containing layer and the mineral-containing polymer layers or the stack of mineral-containing polymer layers, or there is no polymer layer without mineral content between the fiber-containing layer and the mineral containing layers or the stack of mineral-containing polymer layers.

Claim 36. The composite packaging structure of any of claims 33-35, which comprises no layers in addition to the fiber-containing layer and the mineral-containing polymer layer(s) or stacks of mineral-containing polymer layer(s).

Claim 37. The composite packaging structure of any of claims 33-36, wherein the fiber-containing layer is a single homogeneous layer or the fiber-containing layer consists of two fiber-containing layers which are sandwiched to each other by an intermediate polymer layer which contains no mineral content or by an intermediate layer which is a mineral-containing polymer layer as defined in any of claims 1-36.

Claim 38. The composite packaging structure of any of claims 33-37, wherein the mineral-containing polymer layer comprises montmorillonite (OMT AND MMT) and/or organically modified montmorillonite (OMMT AND MMT) particles in the polymer matrix; and/or the mineral-containing polymer layer comprises montmorillonite (OMT AND MMT) and/or organically modified montmorillonite (OMMT AND MMT) particles in the polymer matrix having a +−10% density between 1.2 g/cm3 to about 2.7 g/cm3 as characterized by one or more of the Pycnometer Method, ASTM D3878 and ISO 1183 and X-ray Reflectivity (XRR), preferably ASTM D3878; and/or the mineral-containing polymer layer comprises an amount of 1-28% by volume of the mineral microparticles of the first type and 1%-10% by volume of mineral nanoparticles of the second type (OMMT AND MMT/OMT AND MMT); and/or the mineral-containing polymer layer comprises montmorillonite (OMT AND MMT) and/or organically modified montmorillonite (OMMT AND MMT) particles in the polymer matrix in an amount of 1-28% by weight based on the weight of the mineral-containing polymer layer; and/or the mineral-containing polymer layer comprises montmorillonite (OMT AND MMT) and/or organically modified montmorillonite (OMMT AND MMT) particles in the polymer matrix, wherein the OMT AND MMT and OMMT AND MMT have an organic interlayer d-spacing from between 0.9 nm to 3.0 nm and/or partially or fully intercalated d-layer spacing from 2.0-10 nm; and/or the mineral-containing polymer layer comprises montmorillonite (OMT AND MMT) and/or organically modified montmorillonite (OMMT AND MMT) particles, wherein montmorillonite has the formula (Na,Ca)0,3(Al,Mg)2Si4O10(OH)2·nH2O, wherein n can be between 1 and 10, which preferably is a 2:1 clay, with a central octahedral sheet of alumina and/or magnesium hydroxide sandwiched by two tetrahedral sheets of silica and wherein OMMT AND MMT particles are based on OMT AND MMT with organic molecules being intercalated, preferably said organic molecules are cationic organic molecules, further preferred organic cations of quaternary ammonium salts, preferably obtained by cation-exchange reaction between the interlayer sodium ions of OMT AND MMT and said cationic molecules; and/or the mineral-containing polymer layer comprises montmorillonite (OMT AND MMT) and/or organically modified montmorillonite (OMMT AND MMT) particles in the polymer matrix, wherein the OMT AND MMT and OMMT AND MMT particles are at least partially, preferably partially to predominantly, exfoliated particles in the d-spacing range of above 9 nm to an obscure to invisible XRD peak as measured by Transmission Electron Microscopy (TEM) which provides direct visualization of the material at the atomic or nanoscale level, high-resolution and TEM images revealing the gallery/inter-barrier structure and directly measures basal spacing per it is expressed as: nλ=2d sin θ, where: n is an integer representing the order of diffraction, λ is the wavelength of the X-rays, d is the spacing between the crystal planes, θ is the angle of incidence of the X-rays; and/or the mineral-containing polymer layer has a thermoplastic crystallinity in a range from about 60% to 80% and/or between 40% to 55% determined by X-ray Diffraction (XRD) and Differential Scanning Calorimetry (DSC); and/or the mineral-containing polymer layer has an average density in the range of from 0.915 g/cm3 to 0.985 g/cm3; and/or the mineral-containing polymer layer comprising polyethylene, EVOH and/or copolymers of polyethylene, preferably having average molecular weights in the range of 50,000 to 300,000 g/mol such as by determined Gel Permeation Chromatography; and/or the mineral-containing polymer layer applied to a fiber layer in the range of about 40 g/m2 to about 600 g/m2 per TAPPI T 410 for coated papers and/or ISO 4592 standard specifying methods for determining the mass per unit area of plastic films; and/or the mineral-containing polymer layer comprises montmorillonite (OMT AND MMT) and/or organically modified montmorillonite (OMMT AND MMT) particles in the polymer matrix comprising from 1% to 10% by volume or 1.5% to 15% by weight of the composite with aluminum (Al3+) substituting for silicon (Si4+) in the tetrahedral sheets thus creating a net negative charge, with a substitution of about 15%-25% of Si4+ replacing Al3+; and/or the mineral-containing polymer layer comprises montmorillonite (OMT AND MMT) and/or organically modified montmorillonite (OMMT AND MMT) particles in the polymer matrix having a cation exchange capacity (CEC) of from 200 to 300 (+−5%) meq/100 g as calculated by Brunauer-Emmett-Teller (BET) method, X-ray diffraction (XRD) and alternatively X-ray Fluorescence (XRF).

Claim 39. The composite packaging structure of any of claims 33-38, wherein the first type of mineral particles, preferably as defined in claim 4, are coated (with one or more selected from stearic acid, polyethylene glycol (PEG), polyoxymethylene sorbitan monolaurate, sodium lauryl sulfate, sodium dodecyl sulfate, fluor-surfactants, and cetyltrimethylammonium bromide) or uncoated calcium carbonate or talc or diatomaceous earth; and the second type of mineral particles as defined in claim 4 are OMMT AND MMT or OMT AND MMT particles as defined in any of claims 15-37, wherein the OMMT AND MMT and OMT AND MMT particles are preferably as defined in claim 38vi).

Claim 40. The composite packaging structure forming a rigid or flexible package having oxygen and moisture barrier, wherein; the mineral-containing polymer layer(s) containing nanoparticle content having a net negative charged hydrophobic particles that can be contained within the thermoplastic nanocomposite with the chemical formula of Al2,H2,O12,Si4 can include OMMT (organically modified) and/or OMT and/or MMT montmorillonite clay structure comprising an octahedral sheet of aluminum or magnesium hydroxide having a cation exchange capacity (CEC) of 250 meq/100 g (+−5%). The OMMT and/or OMMT and/or MMT with a purity of 99.99 (+−2%). Further, the particles comprising the compound or composite layer can be found within sizes in the range 80-100 nm+−5%, the crystalline nanoclay phase identity of 2.1 smectite/montmorillonite particles and comprise plate like structures consisting of two silica tetrahedral sheets having a central alumina octahedral sheet, forming a 2:1 layer structure. These free-flowing particle structures after intercalation and exfoliation having aspect ratios within the range of 300-700 (+−5%) as determined by Transmission Electron Microscopy (TEM). These particles can also employ surface modifications to include dimethyldialkyl (C16-C18) ammonium chloride. The particles having very high cation exchange capacity (CEC) of 250 meq/100 g (+−5%) measured by atomic absorption spectroscopy (AAS) or inductively coupled plasma (ICP) spectroscopy, with PH of 7.5 (+−5%) measured indirectly by creating a suspension of the particles in a liquid (usually deionized water) and then measuring the pH of that liquid. A standard pH meter with a glass electrode is used for this measurement and particle specific surface area (SSA) in the range of 220-270 m2/g (+−5%) measured using the Brunauer-Emmett-Teller (BET) method with a particle size of 80-100 nm average particle size measured using dynamic light scattering (DLS) and plate size length of 600-700 nm (+−5%), the lateral dimensions (length and width) of nanoclay platelets are measured using Transmission Electron Microscopy (TEM) or Atomic Force Microscopy (AFM) with a thickness in the range of 1-2 nm (+−5%) measured using X-ray diffraction (XRD). The particles when compounded in polyethylene. and then forming a 50-micron barrier layer having a moisture barrier transmission rate (MVTR) at 38 C and 90% relative humidity (RH) in the range of 0.37 to 0.51 g/m2/1AT/day per ASTM 1249. The particles when compounded into a thermoplastic and then forming a 50 micron barrier layer having an (OTR) in the range of 0.28 to 0.36 (GCC/M2/Day) @23 C and 0% RH per ISO 15105-1 and when forming a 25 g/m2 fiber coating layer having a moisture barrier “MVTR” from about 7.1-9.0 @90% RH per ISO 4592 standard specifying methods for determining the mass per unit area of plastic films and oxygen barrier “OTR” per ISO 4592 standard specifying methods for determining the mass per unit area of plastic films and when forming a 25 g/cm2 film layer having an oxygen barrier of 0.18 to 17 per 0% RH @37.8 C oxygen barrier standard ASTM F2622, per Mocon QMS 702-002, measured at cc(m2/day).

Claim 41. A packaging structure, preferably in the form of a rigid or flexible package which is made from the composite packaging structure of any of claims 33-40.

Claim 42. A thermoplastic oxygen and moisture barrier layer, preferably contained within the form of a rigid or flexible package as a monolayer or individual layer in a coextrusion, the structure containing OMMT (organically modified) and/or OMT and/or MMT montmorillonite particles; wherein the particles cation exchange capacity (CEC) is in the range of 200 to 300 meq/100 g (+−5%) measured by atomic absorption spectroscopy (AAS) or inductively coupled plasma (ICP) spectroscopy; wherein the 25 micron barrier structure having and MVTR in the ranges of [1.5-2.9], and/or [3.4-4.9], and/or [1.0-2.9], and/or [6.0-8.2], and/or [0.9-3.2], and/or [0.77-3.8] at 90% RH @37.8 C per Tappi T464 stated in g/m2/24 hours and oxygen barrier ranges [1.5-19], and/or [7.3-47], and/or [1.1-320], and/or [8.6-15], and/or [0.18-1.2], and/or [0.59-9] at 0% RH @23 C. having standard ASTM F2622, @760 mmHg gas pressure, test gas is 100% oxygen per Mocon QMS 702-002, measured at cc(m2/day); wherein the 25 micron barrier having an MVTR in the ranges of [1.5-2.9], and/or [3.4-4.9], and/or [1.0-2.9], and/or [6.0-8.2], and/or [0.9-3.2], and/or [0.77-3.8] at 90% RH @37.8 C per Tappi T464 stated in g/m2/24 hours and oxygen barrier ranges [1.5-19], and/or [7.3-47], and/or [1.1-320], and/or [8.6-15], and/or [0.18-1.2], and/or [0.59-9.0] at 0% RH @23 C. having standard ASTM F2622, @760 mmHg gas pressure, test gas is 100% oxygen per Mocon QMS 702-002, measured at cc(m2/day); wherein the 25 micron barrier having and MVTR in the ranges of [1.3-2.4] and/or [7.1-9.0] and/or [1.0-2.9] and/or [6.4-8.8] and/or [1.4-2.2] and/or [7.7-8.9] at 90% RH @37.8 C per Tappi T464 stated in g/m2/24 hours and oxygen barrier in the ranges of [3-19] and/or [18-47] and/or [9-32] and/or [15-155] and/or [0.18-17] and/or [15-36] at 0% RH @23 C. having standard ASTM F2622, @760 mmHg gas pressure, test gas is 100% oxygen per Mocon QMS 702-002, measured at cc(m2/day); wherein the 25 micron barrier having and MVTR in the ranges of [6.4-8.8] and/or [5.3-7.5] and/or [7.8-9.8] and/or [7.3-8.3] at 90% RH @37.8 C per Tappi T464 stated in g/m2/24 hours and oxygen barrier in the ranges of [20-45] and/or [15-32] and/or [10-45] and/or [15-64] at 0% RH @23 C having standard ASTM F2622, @760 mmHg gas pressure, test gas is 100% oxygen per Mocon QMS 702-002, measured at cc(m2/day).

Claim 43. the composite packaging structure according to Claim 42, wherein the particle PH in the range of 6-8 measured indirectly by creating a suspension of the particles in a liquid (usually deionized water) and then measuring the pH of that liquid. A standard pH meter with a glass electrode is used for this measurement and particle specific surface area.

Claim 44. The composite packaging structure according to Claim 42, wherein the particle specific surface area (SSA) in the range of 200-290 m2/g measured using the Brunauer-Emmett-Teller (BET).

Claim 45. The composite packaging structure according to Claim 44, wherein Having nanoparticle content with a net negative charged hydrophobic particle(s) that can be contained within the thermoplastic nanocomposite which can include OMMT (organically modified) and/or OMT and/or MMT montmorillonite clay structure comprising an octahedral sheet of aluminum or magnesium hydroxide. The OMMT and/or OMT and/or MMT nanoclay having isomorphous substitution (IS) in ranges in ranges up to from and/or [0.25-0.50] and/or [0.51-1.0] and/or [1.01-1.50] and/or [1.51-2.0] and/or [2.01-2.5] and/or [2.6-3.5] and/or [3.6-4.0] units per formula unit as characterized by calculating the charge deficit: The IS rate is the net negative charge that results from substitution. For example, the replacement of Al3+ with Mg2+ creates a charge deficit of −1 at that site. Tabulating all of these charge deficits across the entire formula unit gives the total negative charge, which is the IS rate.

Claim 46. The composite packaging structure according to claim 42, wherein; having nanoparticle content with particle sizes within sizes in at least one dimension in the range 65-100 nm in at least one dimension, the crystalline nanoclay phase identity of 2.1 smectite/montmorillonite particles and comprise plate like structures consisting of two silica tetrahedral sheets having a central alumina octahedral sheet, forming a 2:1 layer structure. These free-flowing particle structures after intercalation and exfoliation having aspect ratios within the range of 200-900 with particles having a density in the range of 1.2 g/cm to 2.7 g/cm3. The particles can be from 1.5% to about 15% by weight of the compound or composite barrier layer. These particles can also employ surface modifications to include dimethyldialkyl (C16-C18) ammonium chloride and other surface modifications found described within this specification, sizes determined by using an instrument of Malvern Instruments, Ltd., Malvern, UK, preferably a Mastersizer 3000 or analytical methods pertaining to ISO 13320-2020.

Claim 47. The composite packaging structure according to claim 42, wherein; having 70-100 nm average particle size measured using dynamic light scattering (DLS) and plate size length of 500-800 nm, the lateral dimensions (length and width) of nanoclay platelets are measured using Transmission Electron Microscopy (TEM) or Atomic Force Microscopy (AFM) with a thickness in the range of 1-3 nm measured using X-ray diffraction (XRD).

Claim 48. The composite packaging structure according to claim 42, wherein; the composite having content with nucleation densities within a first range of 10\hat{ }6-10\hat{ }8 and within a second range of 10\hat{ }9-10\hat{ }12, as determined by Polarized Optical Microscopy (POM) ASTM D3324, “Standard Test Method for Flow Orientation in Thermoplastic Films by Spherulitic Crystallization”.

Claim 49. The composite packaging structure according to claim 42, wherein; nanoparticles comprising from 2.5-6% by volume of the thermoplastic packaging layer. The mineral-containing polymer layer may further comprise a polymer matrix; the plurality of mineral particles may be bimodal particles, which may be dispersed within the polymer matrix; the bimodal particles may have nucleation densities within a first range of 10\hat{ }6-10\hat{ }8 and within a second range of 10\hat{ }9-10\hat{ }12, as determined by Polarized Optical Microscopy (POM) ASTM D3324, “Standard Test Method for Flow Orientation in Thermoplastic Films by Spherulitic Crystallization”.

Claim 50. The composite packaging structure according to claim 42, wherein; having montmorillonite particles comprising plate like structures consisting of two silica tetrahedral sheets having a central alumina octahedral sheet, forming a 2:1 layer structure. These free-flowing particle structures having aspect ratios within the range of 300-700 (+−5%) as determined by Transmission Electron Microscopy (TEM). These particles can also employ surface modifications to include dimethyldialkyl (C16-C18) ammonium chloride.

Claim 51. The composite packaging structure according to claim 42, wherein; pre-intercalation particle size distributions in the range of 35-175 nm (D90=92 nm+−20%) particle size distribution (PSD) the particle size distribution is preferably determined by using an instrument of Malvern Instruments, Ltd., Malvern, UK, preferably a Mastersizer 3000 or analytical methods pertaining to ISO 13320-2020.

Claim 52. The composite packaging structure according to claim 42, wherein; mineral particles mean particles sizes within the composite may in the ranges of 5-75 nm or 5-100 nm. The mean particle size may be determined by using a volumetric dynamic laser light scattering method. The mean particle size may be determined by using a particle size analyzer selected from the group of particle size analyzers consisting of: a Malvern® particle size analyzer; a Mastersizer® 3000 particle size analyzer; a particle size analyzer using analytical methods pertaining to ISO 13320-2020; a Transmission Electron Microscopy (TEM); and combinations thereof.

Claim 53. The composite packaging structure according to claim 42, wherein; the particles having a density between 1.2 g/cm3 to 2.7 g/cm3 (plus or minus 10%) as characterized by the Pycnometer Method, ASTM D3878 and ISO 1183 and X-ray Reflectivity (XRR).

Claim 54. The composite packaging structure according to claim 42, wherein; particles having pre intercalation organic interlayer d-spacing from between 0.9 nm to 3.0 nm and/or partially or fully intercalated d-layer spacing from 2.0-10 nm and partially to predominantly exfoliated particles in the d-spacing range of above 10 nm to an obscure to invisible XRD peak as measured by Transmission Electron Microscopy (TEM) which provides direct visualization of the material at the atomic or nanoscale level, high-resolution and TEM images revealing the gallery/inter-barrier structure and directly measures basal spacing.

Claim 55. The composite packaging structure according to claim 42, wherein; containing particles such that particle size distributions (PSD) on having a plate size length of 500-800 nm, al dimensions (length and width) of nanoclay platelets are measured using Transmission Electron Microscopy (TEM) or Atomic Force Microscopy (AFM) with a thickness in the range of 1-3 nm measured using X-ray diffraction (XRD).

One embodiment may be a mineral-containing polymer layer of a composite comprising: a plurality of mineral particles may have a bimodal or multimodal particle size distribution. The bimodal distance between two maxima of a bimodal distribution or a multimodal distance between two adjacent maxima of a multimodal distribution may be at least 1.4 μms; a particle size distribution may be determined by using a particle size analyzer selected from the group of particle size analyzers consisting of: a Malvern® particle size analyzer; a Mastersizer® 3000 particle size analyzer; a particle size analyzer using analytical methods pertaining to ISO 13320-2020; and combinations thereof. A first maximum of the bimodal or multimodal particle size distribution may be within a range of 1.5 to 30 μms; and a second maximum of the bimodal or multimodal particle size distribution may be within a range of 5-75 nm; and a particle size distribution may be determined by using a particle size analyzer selected from the group of particle size analyzers consisting of: a Malvern® particle size analyzer; a Mastersizer® 3000 particle size analyzer; a particle size analyzer using analytical methods pertaining to ISO 13320-2020; and combinations thereof. The bimodal or multimodal particle size distribution of the plurality of mineral particles results from the presence of at least two different types of mineral particles, a first type mineral particles and a second type of mineral particles, wherein the two different types of mineral particles have a different maximum of a particle size distribution; the first type of mineral particles may be, coated or non-coated, micro particles may have a mean particle size from 1.5 μm-30 μm; and the second type of mineral particles are nanoparticles may have a mean particle size from 5-50 nm. The mean particle size of the first type of mineral particles may be from 3.0 μm-6.5 μm or from 7 μm-10 μm; and the mean particle size of the second type of mineral particles may be 5-75 nm or 5-100 nm. The mean particle size may be determined by using a volumetric dynamic laser light scattering method. The mean particle size may be determined by using a particle size analyzer selected from the group of particle size analyzers consisting of: a Malvern® particle size analyzer; a Mastersizer® 3000 particle size analyzer; a particle size analyzer using analytical methods pertaining to ISO 13320-2020; a Transmission Electron Microscopy (TEM); and combinations thereof. The mineral particles of the first and second type of mineral particles differ from each other by chemical composition, which may be selected from the group of chemical compositions consisting of a nanoclay and a calcium carbonate. The nanoclay may be one or more of an organically modified montmorillonite (OMMT) nanoclay, a montmorillonite (MMT) nanoclay, or an organo-montmorillonite (OMT) nanoclay. The calcium carbonate may have a specific heat of 0.200 to 0.214 calories required to heat 1 gram 1 degree C.; and the nanoclay may have a specific heat in the range of 0.75-1.1 Joules per gram per degree Celsius (J/g° C.); and specific heat may be determined by ASTM standard E1269, titled Standard Test Method for Determining Specific Heat Capacity by Differential Scanning Calorimetry. The bimodal or multimodal particle size distribution of the plurality of mineral particles results from the presence of at least two different types of mineral particles, a plurality of nanoclay particles may have a mean particle size distribution from 100 nanometers or less in two (2) dimensions and a plurality of calcium carbonate particles may have a mean particle size distribution from 1.5 to 10 μm, both may be determined by using a Transmission Electron Microscopy (TEM). The mineral-containing polymer layer may further comprise a polymer matrix and a plurality of particles may have a functionally neutral charge; the plurality of mineral particles dispersed within the polymer matrix may have a specific surface area cation exchange capacity falling within a range of 250-300 meq/100 g, as calculated by Cobalt hexammine trichloride (CoHex)-ICP-MS, and may have densities between 2.3 g/cm3 to 2.5 g/cm3, as determined by ISO 1183; and the particles may have a functionally neutral charge have densities in the range of 2.71 g/cm3, as determined by ISO 1183. The mineral-containing polymer layer may further comprise a polymer matrix and the plurality of mineral particles comprise a nanoclay and a calcium carbonate; the nanoclay may be 2.5% to 6% by volume of the mineral-containing polymer layer; the calcium carbonate may be 1% to 28% by volume of the mineral-containing polymer layer; the polymer matrix may be 80% to 95% polyethylene and copolymers of polyethylene including one or more of low density polyethylene (LDPE), high density polyethylene (HDPE), polypropylene (PP), and linear low density polyethylene (LLDPE), may have average molecular weights in the range of 50,000 to 200,000 g/mol and with density ranges of 0.915 g/cm3 to 0.965 g/cm and/or 0.915 g/cm3 to 0.97 g/cm3 and/or 0.915 g/cm3 to 0.985 gm/cm3 as determined by TAPPI T535, Density of Plastic Pellets by the Gradient Technique and Gel Permeation Chromatography (GPC). The nanoclay having a density from about 1.2 to 1.9 g/cm3 (+−10%) may be one or more of an organically modified montmorillonite (OMMT) nanoclay, an organo-montmorillonite (OMT) nanoclay, and montmorillonite (MMT) nanoclay. The mineral-containing polymer layer may further comprise a polymer matrix; the polymer matrix may be 66-89% by volume of the mineral-containing polymer layer; the plurality of mineral particles comprises (1) microparticles, which may be 1-28% by volume of the mineral containing layer, and (2) nanoparticles, which may be 1-6% by volume of the mineral-containing layer; the polymer matrix, the microparticles and the nanoparticles may be 68-100% by volume of the mineral-containing polymer layer. The mineral-containing polymer layer according to claim 1, further comprising a polymer matrix; the polymer matrix may be 66-89% by volume of the mineral-containing polymer layer; the plurality of mineral particles comprises (1) microparticles, which may be 1-28% by volume of the mineral containing layer, and (2) nanoparticles, which may be 2.5-6% by volume of the mineral-containing layer; the polymer matrix, the microparticles and the nanoparticles may be 69.5-100% by volume of the mineral-containing polymer layer. The plurality of mineral particles comprises (1) a first type of mineral particles, which may be 1-28% by volume of the mineral containing layer, and (2) a second type of mineral particles, which may be 2.5-6% by volume of the mineral-containing layer. The mineral-containing polymer layer may further comprise a polymer matrix; the plurality of mineral particles may be bimodal particles, which may be dispersed within the polymer matrix; the bimodal particles may have nucleation densities within a first range of 10\hat{ }6-10\hat{ }8 and within a second range of 10\hat{ }9-10\hat{ }12, as determined by Polarized Optical Microscopy (POM) ASTM D3324, “Standard Test Method for Flow Orientation in Thermoplastic Films by Spherulitic Crystallization”. The mineral-containing polymer layer may further comprise a polymer matrix, wherein the polymer matrix comprises polymers may have a crystallinity in a first range of 60% to 80% and in a second range of 40% to 55%, as determined by X-ray Diffraction (XRD) and Differential Scanning Calorimetry (DSC); the plurality of mineral particles may be dispersed within the polymer matrix and have a thermal conductivity of 0.20 W/MK to 0.45 W/mK, as determined by ASTM C177 “Standard Test Method for Steady-State Thermal Transmission Properties by Means of the Guarded-Hot-Plate Apparatus”. The mineral-containing polymer layer may have a charge density in the range of −1.0 to −4.5, as calculated using electrophoretic mobility and potentiometric titration methodology. The plurality of mineral particles comprises a plurality of micro particles may have a specific heat of 0.200 to 0.214 calories required to heat 1 gram 1 degree C., as determined by ASTM standard E1269 “Standard Test Method for Determining Specific Heat Capacity by Differential Scanning Calorimetry”, and ASTM standard D2766 “Standard Test Method for Specific Heat of Liquids and Solids by Differential Scanning Calorimetry”. The bimodal or multimodal particle size distribution results from the presence of at least two different types of mineral particles, a nanoclay and a calcium carbonate, wherein the two different types of mineral particles have a different maximum of particle size distribution; calcium carbonate may be micro particles may have a mean particle size from 1.5 μm-30 μm, as determined by using Transmission Electron Microscopy (TEM); the nanoclay may be nano particles may have a mean particle size in two (2) dimensions from 5-50 nm, as determined by using a particle size analyzer selected from the group of particle size analyzers consisting of: a Malvern® particle size analyzer; a Mastersizer® 3000 particle size analyzer; a particle size analyzer using analytical methods pertaining to ISO 13320-2020; and combinations thereof, the calcium carbonate has a specific heat of 0.200 to 0.214 calories required to heat 1 gram 1 degree C. and the nanoclay has a specific heat in the range: 0.75-1.1 Joules per gram per degree Celsius (J/g° C.), as determined by ASTM standard E1269 “Standard Test Method for Determining Specific Heat Capacity by Differential Scanning Calorimetry” The mean particle size of the calcium carbonate may be from 3.0 μm-6.5 μm or from 7 μm-10 μm; and the mean particle size of the nanoclay may be 5-75 nm or 5-100 nm. The nanoclay may be one or more of an organically modified montmorillonite (OMMT) nanoclay, an organo-montmorillonite (OMT) nanoclay, and montmorillonite (MMT) nanoclay. The plurality of mineral particles comprises (1) diatomaceous earth micro particles of calcium carbonate and (2) nanoclays selected from the nanoclays consisting of: organically modified montmorillonite (OMMT) nanoclay; organo-montmorillonite (OMT) nanoclay; montmorillonites (MMT); nano-silica (N-silica); and combinations thereof the bimodal or multimodal particle size distribution results from the presence of at least two different types of mineral particles, a first type of mineral particle and a second type of mineral particle, wherein the two different types of mineral particles have a different maximum of a particle size distribution; the first type of mineral particles may be coated micro particles may have a mean particle size from 3.0 μm-6.5 μm or 7 μm-10 μm; the second type of particles may be nanoparticles may have a mean particle size from 5-75 nm or 5-100 nm; the mean particle sizes may be determined by using a volumetric dynamic laser light scattering method, using a particle size analyzer selected from the group of particle size analyzers consisting of: a Malvern® particle size analyzer; a Mastersizer® 3000 particle size analyzer; a particle size analyzer using analytical methods pertaining to ISO 13320-2020; a Transmission Electron Microscopy (TEM); and combinations thereof, first type of mineral particles may be calcium carbonate particles may have a specific heat of 0.200 to 0.214 calories required to heat 1 gram 1 degree C.; second type of mineral particles may be nanoclays selected from the group of nanoclays consisting of: organically modified montmorillonite (OMMT) nanoclay; organo-montmorillonite (OMT) nanoclay; montmorillonite (MMT) nanoclay; and combinations thereof, may have a specific heat in the range of 0.75-1.1 Joules per gram per degree Celsius (J/g° C.), as determined by ASTM standard E1269 “Standard Test Method for Determining Specific Heat Capacity by Differential Scanning Calorimetry”. The mineral-containing layer may have a moisture vapor transmission rate (MVTR) from 0.49-0.99 @50% RH, 23 C per Tappi T464 stated in g/m2/24 hours, and an oxygen barrier in the range of 190-411 @50% RH 23 C per oxygen barrier standard ASTM F2622, @760 mmHg gas pressure, test gas may be 100% oxygen per Mocon QMS 702-002, measured at cc(m2/day) and in the range of 1.70-4.11@50% RH, 23 C per Tappi T464 stated in g/m2/24 hours and oxygen barrier in the range of 266-497 @50% RH 23 C per oxygen barrier standard ASTM F2622, @760 mmHg gas pressure, test gas may be 100% oxygen per Mocon QMS 702-002, measured at cc(m2/day). The mineral-containing polymer layer may be used to manufacture a container; and wherein the container may be either a flexible or rigid packaging structure.

Another embodiment may be a thermoplastic barrier layer comprising: a plurality of nanoclay particles; and a polymer matrix; wherein the nanoclay particles may be dispersed in the polymer matrix and may have a nanoparticle density between about 1.2 g/cm3 to 1.9 g/cm3 and micro particle density from about 2.7 g·cm3, as characterized by the Pycnometer Method, ASTM D3878 and ISO 1183 and X-ray Reflectivity (XRR) and may have an organic interlayer d-spacing from between 0.9 nm to 2.0 nm or may have partially or fully intercalated d-layer spacing from 2.0-10 nm and at least partially exfoliated particles in the d-spacing range of above 10 nm to an obscure to invisible XRD peak as measured by Transmission Electron Microscopy (TEM), which provides direct visualization of the material at the atomic or nanoscale level, high-resolution and TEM images revealing a gallery/inter-barrier structure and directly measures basal spacing. The polymer matrix has a thermoplastic crystallinity in a range from 60% to 80% or from 40% to 55%, as determined by X-ray Diffraction (XRD) and Differential Scanning Calorimetry (DSC); the thermoplastic barrier layer may be blended into mixtures to be extruded into finished pellets, which may be used to form barrier layers may have an average density in the range of 0.915 g/cm3 to 0.985 g/cm3. The nanoclay particles and the polymer matrix comprise from 1% to 99% by volume of the thermoplastic barrier layer and may have a premixture melt flow index (MFI) in the range of 1.2 g/10 min (190 C/2.16 kg) to 14.0 gm/10 min (190 C/2.16 kg) per ASTM 1238; the polymer matrix has a density in the range of 0.915 g/cm3 to 0.985 g/cm3 comprising polyethylene and copolymers of polyethylene may have average molecular weights in the range of 50,000 to 250,000 g/mol; the thermoplastic barrier layer has a layer weight of 6 g/m2 to 500 g/m2 per TAPPI T 410 for coated papers and ISO 4592 standard specifying methods for determining the mass per unit area of plastic films. The thermoplastic barrier layer may further comprise: an octahedral sheet of aluminum or magnesium hydroxide; the plurality of nanoclay particles may have isomorphous substitution (IS) in a range of at least 0.8 unit per cell to 1.2 unit per cell, and isomorphous substitution (IS) in ranges up to from and/or [0.25-0.50] and/or [0.51-1.0] and/or [1.01-1.50] and/or [1.51-2.0] and/or [2.01-2.5] and/or [2.6-3.5] and/or [3.6-4.0] units per formula unit as characterized by ASTM D3124 “Standard Test Method for Infrared Radiation Spectroscopic Analysis of High-Purity Elemental Boron”, and Tappi T 527 “Infrared Spectroscopy of Paper and Paperboard”. The plurality of nanoclay particles belonging to a family of barrier structured phyllosilicates and comprising a barrier structured silicate, and with a crystalline structure comprising of a plurality of multi-dimensional barrier structures obtained by combining tetrahedral silica laminates with a central octahedral sheet of alumina or magnesium. The barrier structured silicate comprising an unmodified silicate or nanoclay comprising several barrier layers stacked together creating one or more interlayers, with a spacing between each of the one or more interlayers measured using Small-Angle X-ray Scattering (SAXS) and Transmission Electron Microscopy (TEM) techniques; the several barrier layers may be stacked together by Van der Walls forces in between them to form the gallery/inter-barrier structure; a total thickness of a single barrier structure of the plurality of multi-dimensional barrier structures and the gallery/inter-barrier structure or basal spacing or d-spacing after nano composite formation in nanometers representing a repeating unit of the barrier structured silicate as measured by Transmission Electron Microscopy (TEM), which provides direct visualization of the material at the atomic or nanoscale level. The thermoplastic barrier layer comprises substituting from 1 to 6% by volume of the thermoplastic barrier layer of silicon (Si4+) for aluminum (Al3+) in the tetrahedral silica laminates creating a net negative charge or with substituting form 15%-25% by volume of the thermoplastic barrier layer with of aluminum (Al3+) for silicon (Si4) creating the net negative charge. The thermoplastic barrier layer may have the net negative charge attracts cations to the spacing between each of the one or more interlayers, contributing to a nanoclay cation exchange capacity a (CEC) in the range of [100-150] and/or [151-200] and/or [200-250] and/or [250-300] and/or [300-350] and/or [350-400] meq/100 g s calculated by one or more of Brunauer-Emmett-Teller (BET) method, X-ray diffraction (XRD), and X-ray Fluorescence (XRF). The layer may have a range of tetrahedral substitution of 0.20 to 0.50 atoms per unit cell (apfu) and with common values of 0.30 to 0.50 apfu, with apfu calculated using one or more of spectroscopic methods, x-ray fluorescence (XRF), and X-ray Diffraction (XRD). The layer may have a magnesium (MG2+) for aluminum (Al3+) substitution in the range of 15%-35%, and may have a silicon (Si4+) for aluminum (Al3+) substitution in the range of 15%-25%, in the tetrahedral silica laminates creating a net negative charge. The polymer matrix has one or more selections of thermoplastic content may have nucleation densities within the ranges of one or more of 10\hat{ }6-10\hat{ }8 nuclei/cm³, 10\hat{ }9-10\hat{ }12 nuclei/cm³, and 10\hat{ }13-10\hat{ }15 nuclei/cm³, as determined by Polarized Optical Microscopy (POM) ASTM D3324, “Standard Test Method for Flow Orientation in Thermoplastic Films by Spherulitic Crystallization”. The thermoplastic barrier layer may be used in a container; and the container may be either a flexible or rigid packaging structure.

Net negative charged hydrophobic particles contained within the thermoplastic nanocomposite can include OMMT (organically modified) and/or OMT and/or MMT montmorillonite clay structure comprising an octahedral sheet of aluminum or magnesium hydroxide. The OMMT and/or OMT and/or MMT nano clay having isomorphous substitution (IS) in ranges up to from and/or [0.25-0.50] and/or [0.51-1.0] and/or [1.01-1.50] and/or [1.51-2.0] and/or [2.01-2.5] and/or [2.6-3.5] and/or [3.6-4.0] units per formula unit as characterized by calculating the charge deficit: The IS rate is the net negative charge that results from substitution. For example, the replacement of Al3+ with Mg2+ creates a charge deficit of −1 at that site. Tabulating these charge deficits across the entire formula unit gives the total negative charge, which is the IS rate. The crystalline nano clay phase identity of 2.1 smectite/montmorillonite particles and comprise plate like structures consisting of two silica tetrahedral sheets having a central alumina octahedral sheet, forming a 2:1 layer structure. These free-flowing particle structures after intercalation and exfoliation having aspect ratios within the range of [150-200] and/or [201-250] and/or [251-300] and/or [301-350] and/or [351-400] and/or [401-450] and/or [451-500] and/or [501-550] and/or [551-600] and/or [601-650] and/or [651-700] and/or [701 to 750] and/or [751-800] and/or [801-850] and/or [851-900] and/or [901-950] and/or [951-1000] as determined by Transmission Electron Microscopy (TEM). The most common methods are dynamic light scattering (DLS) for sub-micron particles These particles can also employ surface modifications to include dimethylallyl (C16-C18) ammonium chloride and other surface modifications found described within this specification. The particles having very high cation exchange capacity (CEC) in the range of [100-150] and/or [151-200] and/or [200-250] and/or [250-300] and/or [300-350] and/or [350-400] meq/100 g measured by atomic absorption spectroscopy (AAS) or inductively coupled plasma (ICP) spectroscopy, with PH in the range of 6-8 measured indirectly by creating a suspension of the particles in a liquid (usually deionized water) and then measuring the pH of that liquid. A standard pH meter with a glass electrode is used for this measurement and particle specific surface area (SSA) in the range of [150-200] and/or [201-250] and or [251-300] and/or [301-350] and/or [351-400] and/or [401-450]m2/g measured using the Brunauer-Emmett-Teller (BET) method with a these free-flowing particle structures after intercalation and exfoliation having pre-intercalation particle size distributions in the range particle size distribution (PSD) average particle size measured using dynamic light scattering (DLS) and plate size length of [300-400] and/or [401-450] and/or [451-500] and/or [501-550] and/or [551-600] and/or [610-650] and/or 651-700 and/or [701-750] and or [751-800] and/or [801-850] nm, the lateral dimensions (length and width) of nanoclay platelets are measured using Transmission Electron Microscopy (TEM) or Atomic Force Microscopy (AFM) with a thickness in the range of 1-3 nm measured using X-ray diffraction (XRD). These described particles can be contained and used in Processing blocks 1-7 and Thermoplastic blocks 1-8.

Additionally, net negative charged hydrophobic particles contained within the nanocomposite can include Laponite synthetic clay and other synthetic clays structures comprising a 1 magnesium octahedral sheet sandwiched between two silicon tetrahedral sheets. In this structure Mg2+ is substituted with Li+, creating a negative charge. The particles having diameters from about 15 to 40 nm and thickness in the range of 0.5 to 1.5 nanometers. The particles having a cation exchange capacity “CEC” from of [100-150] and/or [151-200] and/or [200-250] and/or [250-300] and/or [300-350] and/or [350-400] meq/100 g measured by atomic absorption spectroscopy (AAS) or inductively coupled plasma (ICP) spectroscopy. The particles also having aspect ratios within the range of [150-200] and/or [201-250] and/or [251-300] and/or [301-350] and/or [351-400] and/or [401-450] and/or [451-500] and/or [501-550] and/or [551-600] and/or [601-650] and/or [651-700] and/or [701 to 750] and/or [751-800] and/or [801-850] and/or [851-900] and/or [901-950] and/or [951-1000] as determined by Transmission Electron Microscopy (TEM) with isomorphous substitution (IS) in ranges up to from and/or [0.25-0.50] and/or [0.51-1.0] and/or [1.01-1.50] and/or [1.51-2.0] and/or [2.01-2.5] and/or [2.6-3.5] and/or [3.6-4.0] units per formula unit as characterized by calculating the charge deficit: The IS rate is the net negative charge that results from substitution and the particle specific surface area (SSA) in the range of [150-200] and/or [201-250] and or [251-300] and/or [301-350] and/or [351-400] and/or [401-450]m2/g measured using the Brunauer-Emmett-Teller (BET) method. The particles with PH in the ranges of [6-7] and/or [7.1-8] and/or [8.1-9] measured indirectly by creating a suspension of the particles in a liquid (usually deionized water) and then measuring the pH of that liquid. A standard pH meter with a glass electrode is used for this measurement. The lateral dimensions (length and width) of the synthetic clay platelets are measured using Transmission Electron Microscopy (TEM) or Atomic Force Microscopy (AFM) with a thickness in the range of 1-3 nm measured using X-ray diffraction (XRD). The particles can be contained and used in Processing blocks 1-7 and Thermoplastic blocks 1-8 and employ surface modifications to include dimethyldialkyl (C16-C18) ammonium chloride or and maleic anhydride grafted polymer one example being (PP-g-MA) and other surface modifications found with this specification.

Another embodiment may be a thermoplastic nanocomposite used to form a packaging barrier layer comprising: one or more selections of thermoplastic content that may be blended into mixtures to be extruded into a plurality of finished pellets; wherein the plurality of finished pellets may be used to form a packaging barrier layer may have an average density in the range of 0.915 g/cm3 to 0.985 g/cm3 and the one or more selections of thermoplastic content form a thermoplastic matrix. The one or more selections of thermoplastic content may be from 1% to 99% by volume of said thermoplastic nanocomposite; the one or more selections of thermoplastic content may have a premixture melt flow index (MI) in the range of 1.2 g/10 min (190 C/2.16 kg) to 14.0 gm/10 min (190 C/2.16 kg), per ASTM 1238; the one or more selections of thermoplastic content may have a density in the range of 0.915 g/cm3 to about 0.985 g/cm3 and comprising polyethylene and copolymers of polyethylene may have average molecular weights in the range of 50,000 to 250,000 g/mol. The one or more selections of thermoplastic content comprises ethylene vinyl alcohol (EVOH). The ethylene vinyl alcohol (EVOH) may be from 1% to 20% by volume of the one or more selections of thermoplastic content; the EVOH has an MFI from 0.8-22 g/10 min/216 kg, a density of 1.12 to 1.19 g/cm3 determined by Gel Permeation Chromatography (GPC) or Size Exclusion Chromatography (SEC), a Mn from 10,000 to 125,000 g/mol, and Mw from 20,000 to 250,000 g/mol. The thermoplastic nanocomposite used to form a packaging barrier layer may further comprise a plurality of mineral particles that may be dispersed into the thermoplastic matrix; the plurality of mineral particles comprises one or more nanoclays may have a density between about 1.2 to g/cm3 to about 2.7 g/cm3, per the Pycnometer Method, ASTM D3878 and ISO 1183, and X-ray Reflectivity (XRR); the one or more nanoclays have a PH in the range of 6.0 to 8.0 and mean sizes from 5-100 nm; the one or more nanoclays have a plurality of layers comprised of silica tetrahedral sheets around an aluminum octahedral sheet; the one or more nanoclays may have belonging to a family structured phyllosilicates, such that they form a barrier structured silicate. The barrier structured silicate has a crystal structure that comprises a plurality of multi-dimensional barrier structures, which may be obtained when the silica tetrahedral sheets may be combined with the aluminum octahedral sheet; The plurality of multi-dimensional barrier structures may have a PH from 5 to 9; the plurality of multi-dimensional barrier structures may be stacked together by Van der Walls forces and have a gallery/inter-barrier structure space in between; the gallery/inter-barrier structure space may be a repeating unit of the barrier structured silicate, as measured by Transmission Electron Microscopy (TEM), which provides direct visualization of the material at the atomic or nanoscale level, high-resolution and TEM images revealing the gallery/inter-barrier structure spaces. The one or more nanoclays may be selected from the group of nanoclays consisting of: organically modified montmorillonite (OMMT) nanoclay; organo-montmorillonite (OMT) nanoclay; montmorillonites (MMT); nano-silica (N-silica); and combinations thereof. The one or more nanoclays may be 1-5% by volume of the thermoplastic nanocomposite per a preferred 0% relative humidity (RH) @37.8 C oxygen barrier standard ASTM F2622, per Mocon QMS 702-002, measured at cc(m2/day), with layer weights in the range of 15-25 g/cm3, may have oxygen barriers in one or more of the ranges 35-245, 0.15 to 1.30, 5.9-20, 0.12-11.2, 7.7-55, 0.22-61.5, 6.1-78.4, 0.12-1.11, and with a layer thickness of 15-30 microns may have an oxygen barrier in the range 10.6-83, and may have a layer thickness of 6 to 10 microns in the range of 1.7-150 and 42-155. The one or more thermoplastic nanoclay composite may have moisture vapor transmission rates (MVTR) of 90% RH per ISO 4592, which determines the mass per unit area of plastic films, in the ranges of one or more of 1.61-3.88, 1.6-6.60, 0.96-2.55, 1.49-2.81, 0.75-2.66, and 1.26-4.88, and with a layer thickness of 6 to 10 microns in the ranges of 6.9-11.4. The one or more thermoplastic composite with nanoclays may have 90% RH @37.8 C moisture vapor transmission rates (MVTR) per Tappi T464 stated in g/m2/24 hours and in the range of 4.2-7.5.39-8.87 and with a layer thickness in the range of 15-30 microns 10.6-83, and may have a layer thickness of 6 to 10 microns in the ranges of 0.38-2.56. The packaging barrier layer may be used to manufacture a container; and the container may be either a flexible or rigid packaging structure.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a cross-sectional view of one embodiment of a thermoplastic nanocomposite layer that can be used alone or coextruded with other thermoplastic layers according to the present disclosure which contain from about 0-10% by volume or 1.5-15% by weight of the composite layer.

FIG. 2 is a is an illustration of a cross-sectional view of one embodiment of a thermoplastic packaging multi-modal thermoplastic nanocomposite layer that can be used alone or coextruded with other thermoplastic layers.

FIG. 3 is an illustration of a cross-sectional view of one embodiment of a monomodal packaging thermoplastic thermoplastic nanocomposite layer that can be used alone or coextruded with other thermoplastic layers.

FIG. 4 is a is an illustration of a cross-sectional view of one embodiment of a thermoplastic monomodal packaging layer comprising a thermoplastic nanocomposite.

FIG. 5 is an illustration of a side cross-sectional view of one embodiment of a thermoplastic monomodal extrusion pellet comprising nanoparticles, which may be used to extrude a thermoplastic nanocomposite film layer, or which may be used to extrusion coat or extrusion laminate a paper or fiber in a weight in the range of 40 gsm to 600 gsm.

FIG. 6 is a is an illustration of a side cross-sectional view of one embodiment of a multimodal extrusion pellet, which includes nanoparticles, micro particles, and colloidal particles, which may be used to extrude a thermoplastic nanocomposite layer for a film layer or may be used for extrusion coating or extrusion laminate layer onto paper.

### DETAILED DESCRIPTION

The following is a detailed description of the various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a”, “an” and “the” include plural referents unless the context clearly dictates otherwise. Ranges may be expressed herein as from “about” one particular value, and/or to “about” another particular value. When such a range is expressed, another embodiment includes from one particular value and/or to the other particular value. Similarly, when values are expressed as approximations, by use of the antecedent “about”, it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises”, means “including but not limited to”, and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers. Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain. The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

This disclosure incorporates single and multiple combinations of mineral particles dispersed into thermoplastic matrices with micro and/or colloidal particles of minerals that are optionally dispersed with clay nanoparticles. One example (not all inclusive) may comprise organically modified montmorillonite (OMMT) and/or organo-montmorillonite (OMT) nanoclay and/or montmorillonite (MMT) having a structured silicate family wherein multiple combinations of mineral particles having particle distribution and dispersion within the thermoplastic matrix in the amounts of from about 1-10% by volume and/or from about 1.2% to 15 by weight of the compound or layer; thus forming dispersed particle containing particle thermoplastic nanocomposite. Also, nano calcium carbonate and nano talc can be included in a monomodal and multi modal dispersions into a thermoplastic matrix and can be considered participant particle(s) within processing blocks 1-10, and thermoplastics blocks 1-7, found within this specification. The calcium carbonate up to 10 microns mean particle size, determined possible coatings for these particles include polyethylene glycol (PEG), polyoxymethylene sorbitan monolaurate, sodium lauryl sulfate, sodium dodecyl sulfate, fluor-surfactants, and cetyltrimethylammonium bromide.

Net negative charged hydrophobic particles that can be contained within the thermoplastic thermoplastic nanocomposite can include OMMT (organically modified) and/or OMT and/or MMT montmorillonite clay structure comprising an octahedral sheet of aluminum or magnesium hydroxide. The OMMT and/or OMT and/or MMT nanoclay having isomorphous substitution (IS) in ranges up to from 0.75 to 2.0 units per formula unit and isomorphous substitution (IS) in ranges up to from and/or [0.25-0.50] and/or [0.51-1.0] and/or [1.01-1.50] and/or [1.51-2.0] and/or [2.01-2.5] and/or [2.6-3.5] and/or [3.6-4.0] units per formula unit as characterized by calculating the charge deficit: The IS rate is the net negative charge that results from substitution. For example, the replacement of Al3+ with Mg2+ creates a charge deficit of −1 at that site. Tabulating all of these charge deficits across the entire formula unit gives the total negative charge, which is the IS rate. Further, the particles can be found within sizes in the range 65-100 nm, the crystalline nanoclay phase identity of 2.1 smectite/montmorillonite particles and comprise plate like structures consisting of two silica tetrahedral sheets having a central alumina octahedral sheet, forming a 2:1 layer structure. These free-flowing particle structures after intercalation and exfoliation having aspect ratios within the range of 200-900 and pre-intercalation particle size distributions in the range of 35-175 nm (D90=92 nm+−20%) particle size distribution (PSD) with particles having a density in the range of 1.2 g/cm to 2.7 g/cm3. The particles can be from 1.5% to about 15% by weight of the compound or composite barrier layer. These particles can also employ surface modifications to include dimethyldialkyl (C16-C18) ammonium chloride and other surface modifications found described within this specification. The particles having very high wherein the particle size distribution is preferably determined by using an instrument of Malvern Instruments, Ltd., Malvern, UK, preferably a Mastersizer 3000 or analytical methods pertaining to ISO 13320-2020. The particles cation exchange capacity (CEC) in the range of [100-150] and/or [151-200] and/or [200-250] and/or [250-300] and/or [300-350] and/or [350-400] meq/100 g measured by atomic absorption spectroscopy (AAS) or inductively coupled plasma (ICP) spectroscopy, with PH in the range of 6-8 measured indirectly by creating a suspension of the particles in a liquid (usually deionized water) and then measuring the pH of that liquid. A standard pH meter with a glass electrode is used for this measurement and particle specific surface area (SSA) in the range of 200-290 m2/g measured using the Brunauer-Emmett-Teller (BET) method with a particle size of 70-100 nm average particle size measured using dynamic light scattering (DLS) and plate size length of 500-800 nm, the lateral dimensions (length and width) of nanoclay platelets are measured using Transmission Electron Microscopy (TEM) or Atomic Force Microscopy (AFM) with a thickness in the range of 1-3 nm measured using X-ray diffraction (XRD). The particles can be contained and used in Processing blocks 1-7 and Thermoplastic blocks 1-8.

Net negative charged hydrophobic particles that can be contained within the thermoplastic nanocomposite with the chemical formula of Al2,H2,O12,Si4 can include OMMT (organically modified) and/or OMT and/or MMT montmorillonite clay structure comprising an octahedral sheet of aluminum or magnesium hydroxide having a cation exchange and/or (CEC) in the range of [100-150] and/or [151-200] and/or [200-250] and/or [250-300] and/or [300-350] and/or [350-400] meq/100 g. The OMMT and/or OMT and/or MMT with a purity of 99.99% (+−2%) having isomorphous substitution (IS) in ranges up to from 0.75 to 2.0+−5% units per formula unit and isomorphous substitution (IS) in ranges up to from and/or [0.25-0.50] and/or [0.51-1.0] and/or [1.01-1.50] and/or [1.51-2.0] and/or [2.01-2.5] and/or [2.6-3.5] and/or [3.6-4.0] units per formula unit as characterized by calculating the charge deficit: The IS rate is the net negative charge that results from substitution. For example, the replacement of Al3+ with Mg2+ creates a charge deficit of −1 at that site. Tabulating all these charge deficits across the entire formula unit gives the total negative charge, which is the IS rate. Further, the particles comprising from about 1.2% to about 15% by weight of the compound or composite layer can be found within sizes in the range 80-100 nm +−5%, the crystalline nanoclay phase identity of 2.1 smectite/montmorillonite particles and comprise plate like structures consisting of two silica tetrahedral sheets having a central alumina octahedral sheet, forming a 2:1 layer structure. These free-flowing particle structures after intercalation and exfoliation having aspect ratios within the range of 300-700 (+−5%) and particle size distributions in the range of 80-100 nm (D90=92 nm+−5%) wherein the particle size distribution is preferably determined by using an instrument of Malvern Instruments, Ltd., Malvern, UK, preferably a Mastersizer 3000 or analytical methods pertaining to ISO 13320-2020. These particles can also employ surface modifications to include dimethyldialkyl (C16-C18) ammonium chloride and other surface modifications found described within this specification. The particles having very high cation exchange capacity in the range of [100-150] and/or [151-200] and/or [200-250] and/or [250-300] and/or [300-350] and/or [350-400] meq/100 g measured by atomic absorption spectroscopy (AAS) or inductively coupled plasma (ICP) spectroscopy, with PH of 7.5 (+−5%) measured indirectly by creating a suspension of the particles in a liquid (usually deionized water) and then measuring the pH of that liquid. A standard pH meter with a glass electrode is used for this measurement and particle specific surface area (SSA) in the range of 220-270 m2/g (+−5%) measured using the Brunauer-Emmett-Teller (BET) method with a particle size of 80-100 nm average particle size measured using dynamic light scattering (DLS) and plate size length of 600-700 nm (+−5%), the lateral dimensions (length and width) of nanoclay platelets are measured using Transmission Electron Microscopy (TEM) or Atomic Force Microscopy (AFM) with a thickness in the range of 1-2 nm (+−5%) measured using X-ray diffraction (XRD). The particles can be contained and used in Processing blocks 1-7 and Thermoplastic blocks 1-8. The particles when compounded in polyethylene and then forming a 50 micron barrier layer having a moisture barrier transmission rate (MVTR) at 90% RH @37.8 C moisture vapor transmission rates per Tappi T464 stated in g/m2/24 hours in the range of 0.37 to 0.51 g/m2/1AT/day per ASTM 1249. The particles when compounded into polyethylene and then forming a 50 micron barrier layer having a moisture barrier transmission rate (OTR) in the range of 0.28 to 0.36 (GCC/M2/Day) @23 C and 0% RH per ISO 15105-1.

The OMMT and/or OMT and/or MMT montmorillonite clay structure comprising an octahedral sheet of aluminum or magnesium hydroxide. MMT or MT stands for montmorillonite.

The OMMT and/or OMT and/or MMT nanoclay having isomorphous substitution (IS) in ranges from a low of <0.8 per cell to >1.2 per unit cell with a preference of at least >0.8 per unit cell, and isomorphous substitution (IS) in ranges up to from and/or [0.25-0.50] and/or [0.51-1.0] and/or [1.01-1.50] and/or [1.51-2.0] and/or [2.01-2.5] and/or [2.6-3.5] and/or [3.6-4.0] units per formula unit as characterized by ASTM D3124 “Standard Test Method for Infrared Radiation Spectroscopic Analysis of High-Purity Elemental Boron”, which is a preferred testing standard found within this specification including the Examples and all tables herein. Although focused on boron, D3124 outlines infrared (IR) spectroscopy procedures adaptable to other materials and can be used in conjunction with Tappi T 527 “Infrared Spectroscopy of Paper and Paperboard”, which describes the use of IR spectroscopy to identify functional groups and chemical bonds.

The OMMT and/or OMT and/or MMT nanoclay dispersed within the composite belong to the family of barrier structured phyllosilicates, and thus comprising a barrier structured silicate. The structure of its crystal consists of multi-dimensional barrier structures obtained by combining tetrahedral silica laminates with a central octahedral sheet of alumina or magnesium. The barrier structure of unmodified silicate/nanoclay may consist of several barrier layers stacked together, with each inter layer barrier spacing measured using Small-Angle X-ray Scattering (SAXS) and Transmission Electron Microscopy (TEM) techniques. These layers are stacked together by Van der Walls forces in between them (called gallery or inter-barrier structure). The total of a single barrier structure thickness and the gallery/inter-barrier structure, basal spacing, or d-spacing (d001), after nano composite formation in nanometers representing the repeating unit of barrier structured silicate as measured by TEM, which provides direct visualization of the material at the atomic or nanoscale level. High-resolution TEM images can reveal the gallery/inter-barrier structure and directly measure basal spacing.

The mineral-containing polymer barrier layer is preferably present in basis weights from about 40 g/m2 to about 600 g/cm2 per TAPPI T 410 for coated paper and per ISO 4592 standard specifying methods for determining the mass per unit area of plastic films.

To contribute to this effect, during compounding and processing, the average shear stress applied may be in the range of about 0.08 to 0.26 MPa and with a localized area or “single point” shear rate maximum of 5000 S(−1), and average shear rates during mixing of from the range of about 40-1200 s1 per ASTM D3835 (this standard may be applicable throughout this present disclosure). The finalized thermoplastic nanocomposite may have individual clay barrier layers pulled apart and dispersed within the thermoplastic matrix as individual platelets, the platelets may be sized from 0.65 to 1.25 nanometer wide (plus or minus 10%) and geometric surface areas of 1400 to 2700 (plus or minus 10%). Also, the polymer non-exfoliated OMMT and/or OMT and/or MMT may have initial interlayer d-spacing from between about 0.9 nm to about 2.0 nm and partially and/or fully intercalated d-spacing layer from about 2.0 nm to about 10 nm and predominantly exfoliated having unclear to not visible X-ray diffraction (XRD) peak. The dimensions as measured by XRD. XRD measures the diffraction pattern of X-rays by the ordered layers of OMMT and/or OMT platelets within the material and the d-spacing, obtained from the Bragg equation, corresponds to the distance between adjacent layers, providing an estimate of the gallery spacing and also measured by Transmission Electron Microscopy (TEM) which provides direct visualization of the material at the atomic or nanoscale level. High resolution TEM images can reveal the gallery/inter-barrier structure and directly measure basal spacing. Also measured by It is expressed as: nλ=2d sin θ where: n is an integer representing the order of diffraction, λ is the wavelength of the X-rays, d is the spacing between the crystal planes, θ is the angle of incidence of the X-rays.

The mineral-containing polymer layer bimodal or multimodal distribution results from the presence of at least one, and up to two, different types of particles, wherein the two different types of particles have a different maximum of the particle size distribution, wherein a first particle type having free-flowing particle structures after intercalation and exfoliation having aspect ratios within the range of 200-900 and pre-intercalation particle size distributions in the range of 35-175 nm (D90=92 nm+−20%) particle size distribution (PSD). and the second micro calcium carbonate (CaCO3) particle from about 1.2 to 10 microns determined by using TEM and/or by using a particle size analyzer, such as an advanced system for particle size and size distribution by laser diffraction instrument produced by Malvern Instruments, Ltd., Malvern, UK (Malvern®), preferably a Mastersizer® 3000 (which may include the 3000+ Ultra, the 3000+ Lab, and/or the 3000+ Pro). The mineral-containing polymer layer having particles dispersed within the polymer matrix having a specific surface area cation exchange capacity falling within a range of about 250 to 300 meq/100 g (+−5%) as calculated by Cobalt hexammine trichloride (CoHex)-ICP-MS: and with densities between about 1.2 g/cm3 to 2.7 g/cm3 and between about 2.3 g/cm3 and 2.5 g/cm3 as determined by ISO 1183 and dispersed with particles having a functionally neutral charge and a density of about 2.71 g/cm3 calculated as herein.

The herein mentioned single and multiple combinations of mineral particles dispersion leads to a homogeneous distribution of the nanoclay platelets within the thermoplastic. The nanoclay OMMT and/or OMT and/or MMT particle can either be uncoated or coated with one or more compatibilizers such as oxidized polyethylene, thermoplastics of ethylene and both acrylic and methacrylic acids, ethylene and vinyl acetate, maleic anhydride-grafted polyethylene and ionomers based on poly(ethylene-co-methacrylic acid) and HDPE-g-MA. High density polyethylene (HDPE). Additionally, when mixing ethylene vinyl alcohol (EVOH) into the polymer matrix, MAH-g-PE (polyethylene), MAH-g-PP (polypropylene), and Maleic Anhydride Grafted Polyolefins (MAH-g-PO) can be used. Further block copolymers such as LOTADER® (SK Functional Polymer) or similar can be used. Further, ionic groups that can interact with both EVOH and polyolefin. This example can be used as an ingredient in thermoplastic blocks 1-7 found within this specification and used in examples 1-4 and per tables 1-44.

The pre-processed OMMT and/or OMT and/or MMT nanoclay having a surface area of 200 to 290 m2/g (plus or minus 10%) as calculated using TEM. TEM provides direct visualization of nanoclay particles and their size distribution. By analyzing particle dimensions, the total surface area can be calculated. The nanoparticles in the thermoplastic matrix having equal to or less than 50-125 nm in at least one dimension, combined with mineral micro and/or colloidal particles having mean particles size from about 0.50 microns to about 5 microns. The dispersed minerals may have an influence on the crystallization behavior of the thermoplastic matrix and crystallization temperature ranges from about 105 C to about 125 C as determined by Differential Scanning Calorimetry (DSC). Further, during processing into pellets or extruding the pellets, heating the OMMT and/or OMT and/or MMT from about 200 C-300 C can drive out water molecules, further increasing performance. The minerals and nanoclay OMMT and/or OMT and/or MMT particle(s) may act as nucleating agents, promoting the formation of smaller and more uniform crystalline regions. As nanoparticles disperse, they can create interfacial barrier structures or regions between themselves and the thermoplastic. These barrier structures can exhibit different properties from the bulk thermoplastic or the nanoparticles themselves. Interfacial barrier structures might influence aspects such as mechanical properties influencing gas barrier permeability. Further, the thermoplastic nanocomposite containing single and multiple combinations on mineral particles particle distribution comprising first of montmorillonite (OMMT and/or OMT) nanoclay having lateral dimensions equal to or less than in a range of about 50-125 nanometers (nm) in at least 1 dimension and geometric surface areas from 1800 to 2700 (plus or minus 10%) the dimensions as measured by XRD. XRD measures the diffraction pattern of X-rays by the ordered layers of MMT platelets within the material and the d-spacing, obtained from the Bragg equation, corresponds to the distance between adjacent layers, providing an estimate of the gallery spacing and also measured by TEM, which provides direct visualization of the material at the atomic or nanoscale level. High resolution TEM images revealing the gallery/inter-barrier structure and directly measure basal spacing.

The thermoplastic nanocomposite also comprising from about 1% to 10% by volume or 1.5% to 15% by weight of the composite with aluminum (Al3+) substituting for silicon (Si4+) in the tetrahedral sheets thus creating a net negative charge, with a substitution of about 15%-25% of Si4+ replacing Al3+. The result is a negative charge attracting cations to the interlayer spaces, contributing to high OMMT and/or OMT cation exchange capacity (CEC) in the range of [100-150] and/or [151-200] and/or [200-250] and/or [250-300] and/or [300-350] and/or [350-400] meq/100 g as calculated by Brunauer-Emmett-Teller (BET) method, XRD, and/or, X-ray Fluorescence (XRF). The benefits of higher CEC levels include EVOH interaction providing, higher levels of improved barrier performance provided by polar hydroxyl groups of EVOH. CEC levels can be measured by ASTM C837 standard (Methylene Blue Index). Higher levels of electrostatic repulsion between the clay layers may improve barrier performance. The OMMT and/or OMT layer(s) having charge density from about −1.0 to −4.5 calculations via electrophoretic mobility and potentiometric titration methodology. The montmorillonite (OMMT and/or OMT and/or MMT) nanoclay used in both monomodal and multiple combinations of mineral particles in the nano composite can be found full or in part the Examples 1-4 and in some Tables 1-44. The OMMT and/or OMT and/or MMT nanoclay may have lateral dimensions in the range of at least 50-100 nanometers in at least one direction and/or having a range of tetrahedral substitution of about 0.10 to 0.70 atoms per unit cell “apfu” with common values of about 0.20 to 0.70 apfu, calculated using techniques such as spectroscopic methods, XRF, and XRD, and having a density of about from about 1.2 to 2.7 g/cm3 as characterized by the Pycnometer Method, ASTM D3878 and ISO 1183, and X-ray Reflectivity (XRR). The OMMT and/or OMT having isomorphous substitution (IS) ranges has isomorphous substitution “IS” in ranges from a low of <0.8 per cell to >4.0 per unit cell with a preference of at least >1.0 per unit cell, and isomorphous substitution (IS) in ranges up to from and/or [0.25-0.50] and/or [0.51-1.0] and/or [1.01-1.50] and/or [1.51-2.0] and/or [2.01-2.5] and/or [2.6-3.5] and/or [3.6-4.0] units per formula unit described as the average between 1.0 and 3.0 atoms in the octahedral layer of each OMMT and/or OMT and/or MMT having unit cell has been replaced by a lower charge cation. Generally, an Mg²⁺ for Al³⁺ substitution in the range of about 15-35% is a preferred embodiment. Also, the particles pre-intercalation particle size distributions in the range of 35-175 nm (D90=92 nm+−20%) particle size distribution (PSD).

The mineral particles dispersed with nanoparticles within the polymer composite comprising from about 0% to 28% by volume micro particles having a mean particle size from about 1.0 to 5.0 microns, and colloidal particles having a mean particle size at least 0.5 microns. The mineral particles can be coated to enhance dispersion using, as one example, stearic acid in thicknesses found within the range of about 5 to 65 nanometers and may be selected such that they provide adequate dispersion for particle packing, thus increasing the tortuous path. Also, the micro particles size and hardness contribute to shear stress, better enabling nucleation, nanoclay intercalation, and exfoliation. Further, it is preferred that the micro particles possess mechanical attributes, specific heat, and heat conductivity maximizing the benefits of introducing heat, pressure, shear, and quenching effects on thermoplastic nucleation, crystallization, and nano particle intercalation and exfoliation. Therefore, the single and multiple combinations on mineral and/or colloidal particles within the thermoplastic composite whose sizes have been described within the present disclosure can contain properties having about 0.200 to 0.214 calories required to heat 1 gram 1 degree C. characterized by OMMT and/or OMT and/or MMT having a specific heat in the range of about 0.55-1.1 Joules and about 0.75-1.1 Joules per gram per degree Celsius (J/g° C.) using ASTM standard E1269 “Standard Test Method for Determining Specific Heat Capacity by Differential Scanning Calorimetry” and ASTM standard D2766 “Standard Test Method for Specific Heat of Liquids and Solids by Differential Scanning Calorimetry”, and micro and/or colloidal particles having heat conductivity from about 0.0022 g to 0.0071 g-cal/sec-cm2 @1 cm thick, and 20 C, characterized using ISO Standard 8302 “Thermal Conductivity, measurement of thermal conductivity coefficients steady-state methods”, equivalent to ASTM C177, international standard and ASTM Standards C177 “Standard Test Method for Steady-State Thermal Conductivity of Solid Materials by the Guarded-Hot-Plate Apparatus” and ISO 11419 “Plastics—Differential Scanning Calorimetry (DSC)”, which provides general guidelines for DSC measurements, including those relevant to determining crystallinity of polymers. Additionally, composite thermoplastic content providing more elevated barrier performance can include polyamide content blended into a final form as pellets used to form a barrier structures such that during compound mixing the composition includes one or more selections of thermoplastic ingredients comprising from 90% to 99% by volume of the finished compound with the polyamide thermoplastic selections having a density in the range of from 1.02 to 1.20 g/cm3 as measured by ISO 1183-2, a water absorption percentage of 1.2 to 1.9 as measured by ASTM D570, glass transition temperature of about 184 F to 260 F as measured by Differential Scanning Calorimetry (DSC), a shore hardness of about 71 to 85 as measured by Shore D durometer, polarizability of about 38.2+−0.5 10 (−24) cm3 as measured by ASTM D1531, melting point of about 210 to 220 C and about 260 to 265 C as measured by Differential Scanning Calorimetry (DSC) and tensile strength of about 40 to 80 MPa as measured by ASTM D638. Finished pellets used to form a layer having surface lamination preferably contact one or two sides of a layered structure.

The micro and/or colloidal particles having a mean particle size from about 0.5 to 6.0 microns and having a Mohs hardness in the range from 3.0 to 4.5. Further, the presence of neutrally charged (before coating) mineral micro particles can enhance the crystallization kinetics of polymer during the extrusion process. By providing heterogenous and homogeneous nucleation sites, the minerals can accelerate the nucleation and growth of crystalline structures, leading to shorter crystallization times and increased crystallinity in the thermoplastic nanocomposite. The mineral-containing polymer layer containing polymers having a crystallinity in a range from about 60% to 80% and between about 40% to 55% determined by X-ray Diffraction (XRD) and Differential Scanning Calorimetry (DSC) containing dispersed particles having a thermal conductivity of about 0.20 W/MK to about 0.45 W/mK per ASTM C177 “Standard Test Method for Steady-State Thermal Transmission Properties by Means of the Guarded-Hot-Plate Apparatus”.

The neutrally charged mineral particles are often used as a nucleating agent in thermoplastic processing to enhance crystallization. Micro and/or colloidal particle minerals combined with OMMT and MMT thermoplastic nanocomposite nucleation densities found in the thermoplastic nanocomposite thermoplastics can include, but are not limited to, within the ranges of about 10\hat{ }6-10\hat{ }8, about 10\hat{ }9-10\hat{ }12, and about 10\hat{ }13-10\hat{ }5 nuclei/cm³ as determined by Polarized Optical Microscopy (POM) ASTM D3324, “Standard Test Method for Flow Orientation in Thermoplastic Films by Spherulitic Crystallization”. The presence of mineral particles in the thermoplastic polymer matrix promotes heterogeneous nucleation, facilitating the formation of smaller and more uniform crystalline structures. The nucleating effect of micro minerals can also influence the thermal conductivity of the thermoplastic polymer matrix, making it more effective in dissipating heat. This can be advantageous for accelerating nanoclay intercalation and exfoliation via nucleation and crystallization. Nucleation can lead to a reduction in the amorphous regions within the thermoplastic matrix, thereby lowering the overall permeability to gases and moisture. The presence of a higher proportion of crystalline regions restricts the diffusion of molecules through the material, resulting in improved barrier performance against external elements. This optimization can create an environment where nucleation is promoted across a range of conditions, enhancing overall nucleation efficiency. Nanoclays may also serve as nucleating agents, promoting the formation of smaller and more uniform crystalline regions.

Combining them with other fillers can help control the crystal growth process, preventing uncontrolled crystal growth and achieving a more desirable crystalline morphology. By combining different fillers creating single and multiple combinations on mineral particles thermoplastic nanocomposites, thus tailoring of crystal properties throughout the thermoplastic polymer matrix. This includes influencing crystal size, polymorphism, crystal orientation, and overall crystalline structure. Such control can lead to materials with optimized mechanical, thermal, and barrier properties. When different fillers are combined, they can interact to improve dispersion within the thermoplastic polymer matrix. Proper dispersion of fillers is essential for effective nucleation, as well-dispersed fillers provide a greater number of nucleation sites. Many fillers have multifunctional properties beyond nucleation enhancement. By combining fillers with different functionalities, a composite material with enhanced barrier properties and lower permeation (via improved nucleation and resulting in tortuous path improvement and reduced permeation levels) can be achieved.

For optimum barrier performance, heat, pressure, and shear is preferably applied to the thermoplastic nanocomposite during particle dispersion and mixing, thus resulting in intercalation and exfoliation before, during, and after thermoplastic phase changes. The particle intercalation and exfoliating process can be extended for longer durations during terminal extrusion when forming a film or coating barrier structure, these effects are enhanced during extrudate exit from the die, extrusion die and die exit conditions create cooling and quenching effects better aligning the particles within the thermoplastic polymer matrix. Therefore, the nanoclay and micro particles are exposed to multiple steps of applied heat, pressure, shear, and cooling described fully or in part by this specification including examples 1-4 and tables 1-44, as well as the listed processing and thermoplastic blocks. The first step (phase I treatment) combines the particles by melt compounding into a thermoplastic having defined viscosities and melt flows with the nanoclay (OMMT and/or OMT) particles in concentrations from about 1% by to about 12% by volume and about 1.2% to 18% by weight of the compound dispersed with micro and/or colloidal particles of functionally neutrally charged minerals comprising of about 0% to 28% of the thermoplastic nanocomposite volume and determined by using a volumetric dynamic laser light scattering method, preferably by using an instrument or system produced by Malvern®, which may preferably be a Mastersizer® 3000. By using a combination of nanoparticles with different functionalities, the thermal activation process enhances the dispersion and interaction of both types of particles within the thermoplastic polymer matrix. This results in a thermoplastic nanocomposite material with synergistically improved properties for a variety of applications. The micro and/or colloidal filler particles create shear effects in certain materials during processing and they can influence the flow behavior of the composite mixture under shear forces, creating viscosity shifts supporting nucleation and crystallization within the thermoplastic matrix. In this case, shear refers to the deformation of a material caused by parallel forces acting in opposite directions. These effects can be when materials flow or change shape, such as during mixing, molding, extrusion, and/or processes involving fluid-like behavior. Depending upon the interactions between the filler particles and the matrix material, the composite may exhibit shear-thinning or shear-thickening behavior. Shear-thinning materials become less viscous under shear, flowing more easily, in contrast, shear-thickening materials become more viscous under shear, resisting flow. Micro filler particles can align themselves along the direction of shear flow, leading to anisotropic properties. This alignment can affect mechanical properties, conductivity, and other characteristics. The addition of filler particles can change the overall viscosity of the composite material. This can impact its flow behavior and processing characteristics. Depending on the size, shape, and concentration of filler particles, they can enhance or hinder the flow of the material. Aggregates or agglomerates of fillers might impede flow, while individual particles could help lubricate or separate thermoplastic chains, promoting flow. The shear effects caused by filler particles depend on various factors, including the type of filler, its concentration, and the properties of the thermoplastic polymer matrix material. To achieve the desired barrier results provided by novel thermoplastic nanocomposite barrier structures, specific particle, polymer, and process conditions are required to fall within certain parameters. Particle rheology of the single and multiple combinations on mineral particles thermoplastic nanocomposite compositions and process conditions are specified below as “Particle Blocks” 1-6, “Thermoplastic Blocks” 1-7, and finally “Processing Blocks” 1-10. These blocks are directly interrelated to Tables 1-44.

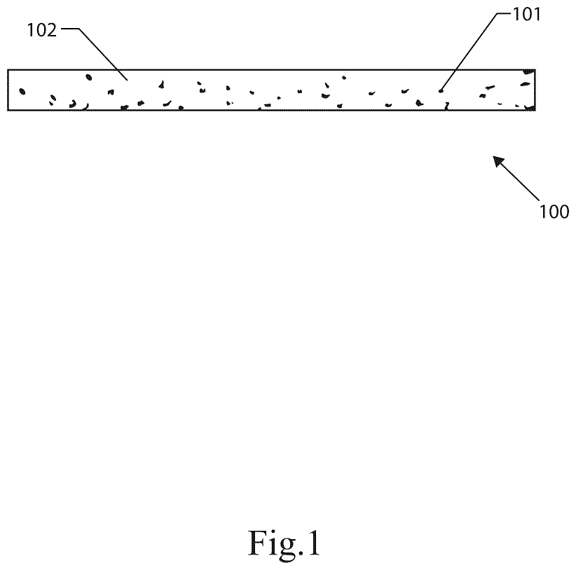

FIG. 1 is an illustration of a cross-sectional view of one embodiment of a thermoplastic nanocomposite layer that can be used alone or coextruded with other thermoplastic layers according to the present disclosure, the barrier mineral containing layer have density in the range of 1.2 g/cm3 to 2.7 g/cm3 and optionally in the range of 1.9 g/cm3 to 2.7 gm/cm3. As shown in FIG. 1 the thermoplastic nanocomposite layer 100 may comprise nanoparticles 101 dispersed withing a polymer matrix 102.

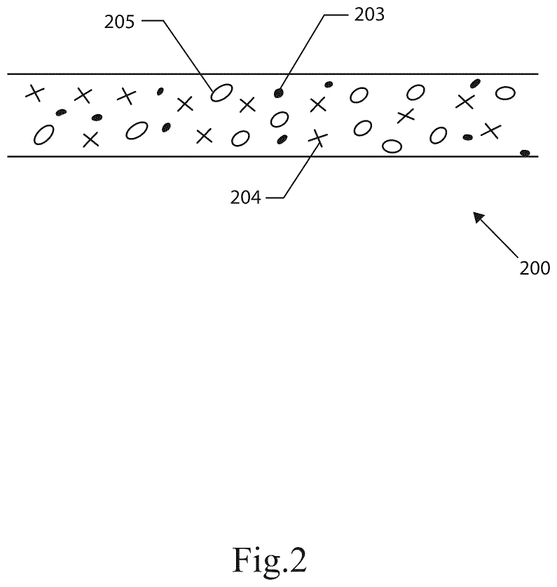

FIG. 2 is a is an illustration of a cross-sectional view of one embodiment of a thermoplastic packaging multi-modal thermoplastic nanocomposite layer that can be used alone or coextruded with other thermoplastic layers. As shown in FIG. 2, the thermoplastic packaging multi-modal thermoplastic nanocomposite layer 200 may comprise nanoparticles 203, micro particles 204, and colloid particles 205.

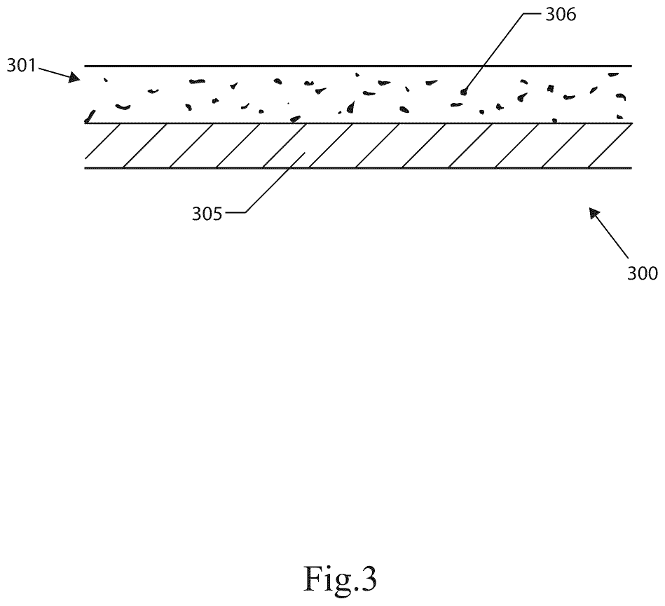

FIG. 3 is an illustration of a cross-sectional view of one embodiment of a monomodal packaging thermoplastic thermoplastic nanocomposite layer has nanoparticles that can be used alone or coextruded with other thermoplastic layers. As shown in FIG. 3, the packaging material 300 may have a monomodal thermoplastic thermoplastic nanocomposite layer 301 may have nano particles 306 and may be extrusion coated or extrusion laminated onto a fiber or paper layer in weight in the range of 40 gsm to 600 gsm 305.

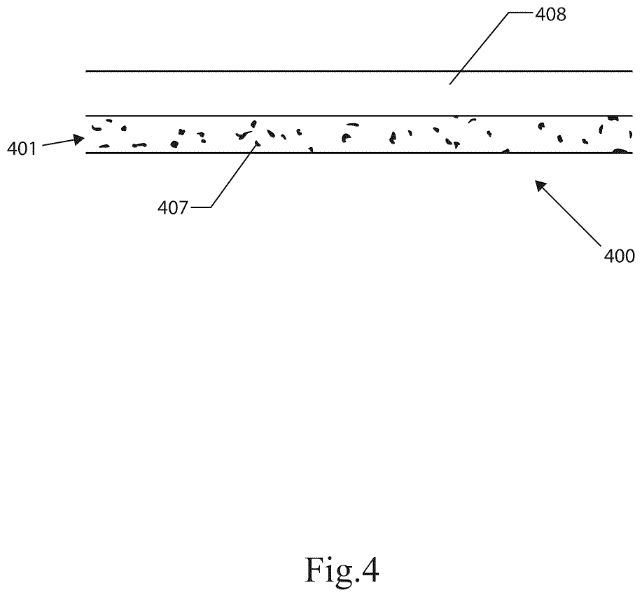

FIG. 4 is a is an illustration of a cross-sectional view of one embodiment of a thermoplastic monomodal packaging layer comprising a thermoplastic nanocomposite. As shown in FIG. 4, the packaging material 400 may comprise a thermoplastic monomodal packaging layer 401 comprising nanoparticles 407 and a coextruded thermoplastic nanocomposite thermoplastic layer 408.

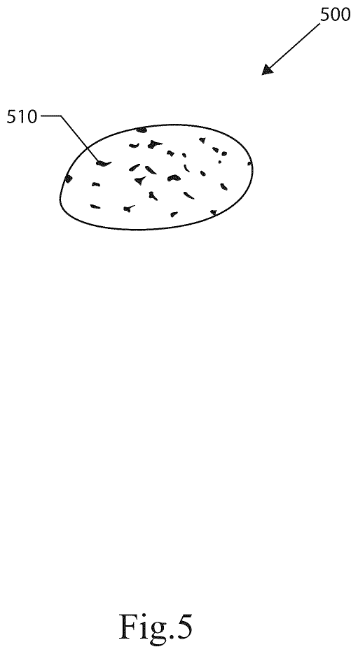

FIG. 5 is a is an illustration of a side cross-sectional view of one embodiment of a thermoplastic monomodal extrusion pellet comprising nanoparticles, which may be used to extrude a thermoplastic nanocomposite film layer or which may be used to extrusion coat or extrusion laminate a paper or fiber in weight in the range of 40 gsm to 600 gsm. As shown in FIG. 5, a thermoplastic monomodal extrusion pellet 500 may have nanoparticles 510, may be used to extrude a thermoplastic nanocomposite film layer or be used to extrusion coat or extrusion laminate a paper or fiber.

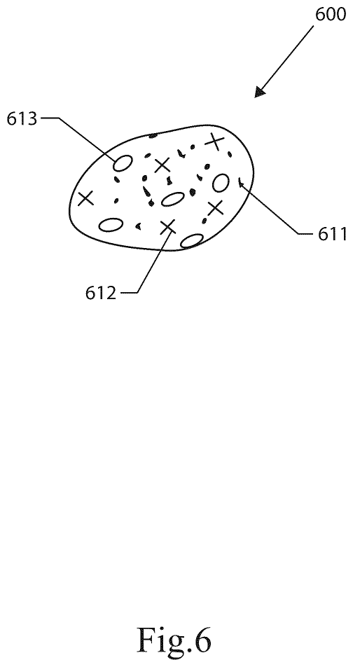

FIG. 6 is a is an illustration of a side cross-sectional view of one embodiment of a multimodal extrusion pellet, which includes nanoparticles, micro particles, and colloidal particles, which may be used to extrude a thermoplastic nanocomposite layer for a film layer or may be used for extrusion coating or for applying an extrusion laminate layer onto paper. As shown in FIG. 6, a is a multimodal extrusion pellet 600 may comprise nanoparticles 611, micro particles 612, and colloidal particles 613, may be used to extrude a thermoplastic nanocomposite layer for a film layer or for extrusion coating or for applying an extrusion laminate layer onto paper.

### NON-LIMITING EXAMPLES

### Example 1

### Flexible Package

A flexible package was formed and sealed using one layer of an 80 gsm paper fiber that was extrusion coated with layer thicknesses from about 15-30 and/or 6-10 microns and printed in up to 4 colors. The coating containing thermoplastic content was used to form a barrier layer when coated on to the paper such that one or more selections of thermoplastic ingredients comprising a total volume of the layer in the range of about 79% to 89%. The thermoplastic content may have a melt flow index (MFI) in the range of about 1.2 g/10 min (190 C/2.16 kg) to about 14.0 gm/12 min (190 C/2.16 kg), the selected thermoplastic content(s) having a density in the range of from about 0.915 g/cm3 to 0.97 g/cm and having a stiffness modulus MPa of about 700-1275, and from about 70% to 95% polyethylene and copolymers of polyethylene having average molecular weights in the range of about 50,000 to 200,000 g/mol. The thermoplastic polymer matrix containing dispersed micro particles volume in the range of about 9%-23% of the layer providing single and multiple combinations of mineral particles. The particle dispersions forming a barrier structure compound, used in the form of pellets, comprised of mineral micro particles with a stearic acid coating falling within the range of about 5 to 70 nanometers, having a mean particle size from about 1.0 to about 6.0 microns with a density range of 1.2 to 2.7 g/cm3 (plus or minus 10%) and having a specific heat of 0.200 to 0.214 calories (plus or minus 5%) required to heat 1 gram 1 degree C., and with heat conductivity (plus or minus 5%) from about 0.0022 g to 0.0071 g-cal/sec-cm2 at 1 cm thick measure at 20 C. The micro- and/or colloidal particles comprising a Moh hardness of 3.5 (plus or minus 10%). The single and multiple combinations on mineral particles dispersion further comprised of uncoated nanoclay OMMT and/or OMT found in the weight range from about 1%-6%. The nanoclay OMMT and/or OMT providing isomorphous substitution and cation exchange capacity found within a range from about 75 to 275 meq. (+−5%). The OMMT and/or OMT with nanoclay OMMT and/or OMT particles having layers comprised of silica tetrahedral sheets around an aluminum octahedral sheet. The particles having a density between 1.2 g/cm3 to 2.7 g/cm3 (plus or minus 10%). These free-flowing particle structures after intercalation and exfoliation having aspect ratios within the range of 200-900 and pre-intercalation particle size distributions in the range of 35-175 nm (D90=92 nm+−20%). This thermoplastic nanocomposite used to form packaging barrier layer(s) having 1-10% by weight nano-clay per a preferred 0% RH @37.8 C conditions resulting in an oxygen barrier results per standard ASTM F2622, per Mocon QMS 702-002, measured at cc(m2/day), with layer weights in the range of 12-25 g/cm3 having oxygen barriers in the ranges 35-245, 0.15 to 1.30, 5.9-20, 0.12-11.2, 7.7-55, 0.22-61.5, 6.1-78.4, 0.12-1.1, 4.5-66, 12.76-312 and with a layer thickness of 15-30 microns having an oxygen barrier in the range 0.86-125.

For example, nanoclays (OMMT and/or OMT) or OMMT, nano-silica (N-silica). The OMMT and/or OMT optionally having a clay structure with an octahedral sheet of aluminum. The OMMT and/or OMT nanoclay belonging to the family of 2:1 barrier structured phyllosilicates and thus a barrier structured silicate. The structure of its crystal consists of two-dimensional barrier structures, obtained by combining two tetrahedral silica laminate with the central octahedral sheet of alumina. The barrier structured silicate/nanoclay consists of several layers stacked together, with each layer thickness approximately 0.65 nm to about 2.0 nanometers (+−5%) and with a total surface area in the range of about 220-270 m2/g and with a PH from about 5 to 9. These barrier structures are stacked together by Van der Walls forces in between them (called gallery or inter-barrier structure). The total of an average single nanoparticle mean particle size from about 5-100 nm, 5-50 nm, 5-30 nm, 5-25 nm. Also, nanoparticles having particle sizes of about 50 nm to about 1.25 nm (in at least one dimension) determined by using a volumetric dynamic laser light scattering method, preferably by using an instrument produced by Malvern®, which is preferably a Mastersizer® 3000, and the gallery/inter-barrier structure or basal spacing or d-spacing (d001), representing the repeating unit of barrier structured silicate. The identified single and multiple combinations on mineral particles particle pellets were mixed and formed into a barrier layer structure via extrusion, extrusion lamination, and/or extrusion coating. The pressure during mixing between about 3480 to 13,780 Kpa, with one or more extruder screws turning at about 20 to 450 RPM, temperatures settings on the equipment during mixing may range from about 170 C-310 C, mixing equipment screw L/D ratios from within the range of about 26 to 40, and average shear rates during mixing in the range of about 40-1200 s1 per ASTM D3835. The functional barrier performance of the coating later in the finished 2-layer flexible package had an “MVTR” in the range of 1.33 to 4.70 per Tappi T448, g/24 hr/m2, 37.8 C @90% RH (relative humidity), and oxygen barrier of from 20 to 300 testing per ASTM F2622, and per Mocon QMS 702-002, measured at cc(m2/day), @0% RH (relative humidity), 37.8 C and a Tappi T441, 24-hour, and a Cobb water absorption in the range of about 0.95 to 2.87 measured in g/m2.

### Example 2

### 3-Layer Flexible Package

A flexible package was formed and heat sealed having 3 layers. The two outer layers comprising paper with thermoplastic and a particle-containing inner coating layer. The flexible package may be printed in four (4) colors. The coating containing thermoplastic derived from pellets that were used in the coating process to form a barrier layer when coated on to paper such that during compound mixing, the finished pellets containing one or more selections of a thermoplastic material wherein the selected thermoplastic content(s) having a density in the range of from about 0.915 g/cm3 to about 0.93 g/cm3 and comprises from about 80% to 95% polyethylene and copolymers of polyethylene having average molecular weights in the range of about 50,000 to 200,000 g/mol. The pellets are used for extrusion coating or extrusion laminating on to the paper surfaces. The coating layer(s) on or more sides of the paper layer or structure to an adjoining thermoplastic or fiber lay in weight in the range of 40 gsm to 600 gsms. Two particles were dispersed within the thermoplastic layer(s) matrix, the first particle comprising about 1% to 6% by weight and being uncoated nanoclay OMMT and/or OMT providing isomorphous substitution and charge and cation exchange capacity with a minimum particle size in the range of 50 to 100 nanometers (plus or minus 10%) (in at least one dimension), the particles having barrier structures, each barrier structure consisting of silica tetrahedral sheets around an aluminum octahedral sheet. The particles having a nanoparticle density between 1.2 g/cm3 to 1.9 g/cm3 and microparticle density 2.7 g·cm3 (plus or minus 10%). Other particles in the matrix comprising micro particles and optional colloidal particles dispersed into the barrier layer such that the thermoplastic center layer is applied via extrusion coating. The other particles having a density of 2.7 to 4.5 g/cm3 (plus or minus 10%) and having a specific heat of 0.200 to 0.214 calories (plus or minus 5%) required to heat 1 gram 1 degree C., and particle heat conductivity from about 0.0022 g to 0.0071 g-cal/sec-cm2 at 1 cm thick (plus or minus 5%), which is measured at a temperature of 20 C. The micro and/or colloidal mean particle size or from about 0.5 to 6.0 microns, 1.5 microns to 30 microns, 3.0 microns to 6.5 microns, and 7 microns to 10 microns and having Moh hardness of 3.5-4.0 (plus or minus 10%). The micro particles coated in thicknesses falling within a range of about 5 nanometers to about 95 nanometers. The functional barrier performance of the coating layer in the finished 3-layer flexible package had an “MVTR” in the range of 3.22 to 7.15 per Tappi T448, g/24 hr/m2, 37.8 C @90% RH (relative humidity), and oxygen barrier in the range of about 20 to 350 testing per ASTM F2622, and per Mocon QMS 702-002, measured at cc(m2/day), @0% RH (relative humidity), 37.8 C and a Tappi T441, 24-hour, and a Cobb water absorption in the range of about 0.80 to 2.87 measured in g/m2 of paper or synthetics.

### Example 3

Projected Barrier Performance Having OMMT and/or OMT Content in Polymer Pellets

A functional barrier layer pellet was melt-mixed in a one or two-step process using twin screw compounding, the ingredients optionally dried before beginning, the finished pellets used for extrusion having and/or co-polymer or homopolymer thermoplastic content from 30% to 97% by volume and containing OMMT and/or OMT particle(s). The varying oxygen barrier contributions depending upon mass of the coating (9, 18, 36, 48 gsm) having and oxygen barrier range from approximately 71.22 to 0.57 @0% RH and an MVTR in the range of 2.0 to 7.5 g/m²/day in tropical conditions, 90% RH @37.8 C moisture vapor transmission rates (MVTR) per Tappi T464 stated in g/m2/24 hours, the MVTR range remained the same (plus or minus 25%) based upon the varying conditions shown on Table 1, Example 3, below. The mixture also contained up to 20% by volume of EVOH EVAL™ FP101B (Kuraray), with potential for comparison with other EVAL™ F-type or E-type resins and EVOH provided or by other manufacturers for further optimization. The mixture forming extrusion pellets having content including about 2.5-5% by weight OMMT and/or OMT with at least at least a 25:1 to 50:1 premixing aspect ratio and a completed exfoliation range of at least 60-85% in the blend, per measuring standard ASTM E1290 standard Practice for Obtaining Transmission Electron Images of Nanoparticles in a Liquid Matrix, this standard also applies to processing block 8. The functional barrier layer having a mass within the range of about 9 to 48 gsm (grams per square meter), see Table A, below. Expanded barrier performance can be estimated based upon increasing or decreasing coat weights and calculating that percentage against the stated barrier performance ranges.

The functional barrier layer was extruded through a die to form the desired film, extrusion coating, or sheet structure. When the layer was used for extrusion coating, the extrudates quenching begins upon exit from the die to rapidly cool it and stop minimize EVOH degradation as measured by ASTM D1238, this is a primary test indicating increase in MFR over time or processing cycles indicative of molecular weight reduction, a key sign of degradation in ethyl vinyl alcohol “EVOH” see tables A-F.

TABLE A
Example 3, O2 barriers based upon temperature,
EVOH content, and EVOH degradation.

| | | | +−200% Total | +−30% |
|---|---|---|---|---|
| EVOH | Max | Layer weight | O2 Barrier | EVOH |
| Content (%) | Temp (° F.) | grams/m2 | (cc/m²/day/g) | Degradation |
| 5 | 450 | 48 | 14.96 | <5 |
| 5 | 475 | 48 | 12.01 | <5 |
| 5 | 500 | 48 | 16.69 | 5-10 |
| 5 | 525 | 48 | 18.12 | 10-15 |
| 5 | 550 | 48 | 21.21 | 15-20 |
| 5 | 450 | 36 | 13.33 | <5 |
| 5 | 475 | 36 | 12.73 | <5 |
| 5 | 500 | 36 | 14.55 | 5-10 |
| 5 | 525 | 36 | 14.85 | 10-15 |
| 5 | 550 | 36 | 19.55 | 15-20 |
| 5 | 450 | 18 | 15.88 | <5 |
| 5 | 475 | 18 | 15.88 | <5 |
| 5 | 500 | 18 | 27.35 | 5-10 |
| 5 | 525 | 18 | 28.65 | 10-15 |
| 5 | 550 | 18 | 39.55 | 15-20 |
| 5 | 450 | 9 | 49.28 | <5 |
| 5 | 475 | 9 | 48.38 | <5 |
| 5 | 500 | 9 | 53.95 | 5-10 |
| 5 | 525 | 9 | 66.87 | 10-15 |
| 5 | 550 | 9 | 71.22 | 15-20 |
| 10 | 450 | 48 | 3.43 | <5 |
| 10 | 475 | 48 | 2.49 | <5 |
| 10 | 500 | 48 | 5.11 | 5-10 |
| 10 | 525 | 48 | 7.95 | 10-15 |
| 10 | 550 | 48 | 8.88 | 15-20 |
| 10 | 450 | 36 | 6.13 | <5 |
| 10 | 475 | 36 | 5.22 | <5 |
| 10 | 500 | 36 | 11.3 | 5-10 |
| 10 | 525 | 36 | 12.3 | 10-15 |
| 10 | 550 | 36 | 13.2 | 15-20 |
| 10 | 450 | 18 | 6.90 | <5 |
| 10 | 475 | 18 | 6.01 | <5 |
| 10 | 500 | 18 | 12.40 | 5-10 |
| 10 | 525 | 18 | 13.11 | 10-15 |
| 10 | 550 | 18 | 19.2 | 15-20 |
| 10 | 450 | 9 | 18.93 | <5 |
| 10 | 475 | 9 | 18.93 | <5 |
| 10 | 500 | 9 | 20.5 | 5-10 |
| 10 | 525 | 9 | 21.9 | 10-15 |
| 10 | 550 | 9 | 23.1 | 15-20 |
| 20 | 450 | 48 | 4.42 | <5 |
| 20 | 475 | 48 | 1.01 | <5 |
| 20 | 500 | 48 | 3.45 | 5-10 |
| 20 | 525 | 48 | 8.98 | 10-15 |
| 20 | 550 | 48 | 10.11 | 15-20 |
| 20 | 450 | 48 | 1.65 | <5 |
| 20 | 475 | 48 | .57 | <5 |
| 20 | 500 | 36 | 9.96 | 5-10 |

### Example 4, Projected Barrier Performance Having OMMT and/or OMT Content

A functional barrier layer pellet was melt-mixed using twin screw compounding, ingredients dried, the pellets used for extrusion that can contained either OMMT and the mixture also containing varying amounts of EVOH EVAL™ FP101B (Kuraray), with potential for comparison with other EVAL™ F-type or E-type resins or other similar EVOH resins from other manufacturers for further optimization. The mixture in the extrusion pellets having content including about 2.0%-4% OMMT and/or OMT by weight within a premixing range of at least 25:1 to 50:1 aspect ratio and the finished pellet within a range of about 60-85% particle exfoliation in the pellet, per measuring standard ASTM E1290 standard Practice for Obtaining Transmission Electron Images of Nanoparticles in a Liquid Matrix. The functional barrier layer formed from the pellet in the range of about 25 to 50 gsm was extruded through a die to form the desired film, extrusion coating, or sheet structure. Barrier performance can be estimated for other coat weights using a linear calculation as percentage of the increasing or decreasing coat weight. When the layer was used for extrusion coating, the extrudates quenching begins upon exit from the die to rapidly cool it and stop or at least minimize EVOH degradation, the EVOH degradation as measured by ASTM D1238, this is a primary test indicating increase in MFR over time or processing cycles indicative of molecular weight reduction, a key sign of degradation in EVOH.

Additionally, it is possible to include ultrasonication applied during melt blending with an intensity in the range of 10-100 W/cm² and a duration in the range of 1-10 minutes (continuous or pulsed) to enhance OMMT and/or OMT dispersion thus improving the barrier performance from 15% to 35% above. See Examples 1-4 and Tables A-F.

TABLE B
Example 4: O2 barrier results at varying EVOH
Degradation, 25 to 50 gsm, BUR 2.5-4.0

| EVOH | Max | Oxygen barrier 90% RH | EVOH |
|---|---|---|---|
| Content (%) | Temp (° F.) | Range +− 300% | Degradation (%) |
| 5 | 450 | 0.35 | <5 |
| 5 | 475 | 0.35 | <5 |
| 5 | 500 | 0.385 | 5-10 |
| 5 | 525 | 0.42 | 10-15 |
| 5 | 550 | 0.455 | 10-20 |
| 10 | 450 | 0.315 | <5 |
| 10 | 475 | 0.315 | <5 |
| 10 | 500 | 0.35 | 5-10 |
| 10 | 525 | 0.385 | 10-15 |
| 10 | 550 | 0.42 | 10-20 |
| 20 | 450 | 0.28 | <5 |
| 20 | 475 | 0.28 | <5 |
| 20 | 500 | 0.315 | 5-10 |
| 20 | 525 | 0.35 | 10-15 |
| 20 | 550 | 0.385 | 10-20 |

TABLE C
O2 barrier results at varying EVOH Degradation with a
blown film “BUR” ranges of 2.0 to 3.5, 25 to
50 gsm layer weight, per process block 8.

| | Max | Total O2 Barrier | | |
|---|---|---|---|---|
| EVOH | Temp | (cc/m²/day/g) | Projected EVOH | |
| Content (%) | (° F.) | Range +− 500% | Degradation (%) | |
| 5 | 400 | 0.24 | <5 | (2-6% by weight |
| 5 | 425 | 0.31 | <5 | nano particles) |
| 5 | 450 | 0.38 | <5 | |
| 5 | 475 | 0.39 | <5 | |
| 5 | 500 | 0.28 | 5-10 | |
| 5 | 525 | 0.31 | 10-15 | |
| 5 | 550 | 0.34 | 10-20 | |
| 10 | 400 | 0.20 | <5 | |
| 10 | 425 | 0.20 | <5 | |
| 10 | 450 | 0.21 | <5 | |
| 10 | 475 | 0.21 | <5 | |
| 10 | 500 | 0.24 | 5-10 | |
| 10 | 525 | 0.27 | 10-15 | |
| 10 | 550 | 0.30 | 10-20 | |
| 20 | 400 | 0.17 | <5 | |
| 20 | 425 | 0.17 | <5 | |
| 20 | 450 | 0.18 | <5 | |
| 20 | 475 | 0.18 | <5 | |
| 20 | 500 | 0.21 | 5-10 | |
| 20 | 525 | 0.24 | 10-15 | |
| 20 | 550 | 0.27 | 10-20 | |

TABLE D
Example 4, O2 barrier results at varying EVOH degradation
25 to 50 gsm, BUR ranges of 2.5 to 3. 5, including sonification,
2%-6% nanoparticles, per process block 8.

| EVOH | | Total O2 | Projected | |
|---|---|---|---|---|
| Content | Max Temp | Barrier cc/m²/ | EVOH | Ultra- |
| (%) | (° F.) | day/g) +− 300% | Degradation (%) | sonication |
| 5 | 400 | 0.18 | <5 | 10-20% |
| 5 | 425 | 0.25 | <5 | 10-20% |
| 5 | 450 | 0.21 | <5 | 10-20% |
| 5 | 475 | 0.29 | <5 | 10-20% |
| 5 | 500 | 0.55 | 5-10 | 10-20% |
| 5 | 525 | 0.51 | 10-15 | 10-20% |
| 5 | 550 | 0.66 | 15-20 | 10-20% |
| 10 | 400 | 0.17 | <5 | 10-20% |
| 10 | 425 | 0.17 | <5 | 10-20% |
| 10 | 450 | 0.18 | <5 | 10-20% |
| 10 | 475 | 0.18 | <5 | 10-20% |
| 10 | 500 | 0.20 | 5-10 | 10-20% |
| 10 | 525 | 0.44 | 10-15 | 10-20% |
| 10 | 550 | 0.40 | 10-20 | 10-20% |
| 20 | 400 | 0.14 | <5 | 10-20% |
| 20 | 425 | 0.14 | <5 | 10-20% |
| 20 | 450 | 0.15 | <5 | 10-20% |
| 20 | 475 | 0.15 | <5 | 10-20% |
| 20 | 500 | 0.17 | 5-10 | 10-20% |
| 20 | 525 | 0.39 | 10-15 | 10-20% |
| 20 | 550 | 0.44 | 10-20 | 10-20% |

TABLE E
Example 4, Blown Film with Projected EVOH Degradation with layer
orientation, BUR 2.25-3.5, 25 gsm to 50 gsm layer weight.

| EVOH | Max | Total O2 Barrier | Projected | Estimated |
|---|---|---|---|---|
| Content | Temp | (cc/m²/day/ | EVOH | Improvement due |
| (%) | (° F.) | g) +− 300% | Degradation (%) | if orientated |
| 5 | 450 | 0.25 | <5 | 20% |
| 5 | 475 | 0.25 | <5 | 20% |
| 5 | 500 | 0.28 | 5-10 | 15% |
| 5 | 525 | 0.31 | 10-15 | 10% |
| 5 | 550 | 0.34 | 10-20 | 5% |
| 10 | 450 | 0.21 | <5 | 25% |
| 10 | 475 | 0.21 | <5 | 25% |
| 10 | 500 | 0.24 | 5-10 | 20% |
| 10 | 525 | 0.27 | 10-15 | 15% |
| 10 | 550 | 0.30 | 10-20 | 10% |
| 20 | 450 | 0.18 | <5 | 30% |
| 20 | 475 | 0.18 | <5 | 30% |
| 20 | 500 | 0.21 | 5-10 | 25% |
| 20 | 525 | 0.24 | 10-15 | 20% |

TABLE F
Example 5, Blown Film with estimated EVOH degradation
and medium to high frost line with a 2.5 to
4 BUR range, layer from 25 gsm to 50 gsm.

| | | TO2 Barrier | Projected | Estimated |
|---|---|---|---|---|
| EVOH | Max | range | EVOH | improvement if 30- |
| Content | Temp | (cc/m²/day/ | Degradation | .80 orientation |
| (%) | (° F.) | g) +− 400% | (%) | added (XRD method) |
| 5 | 450 | 0.22 | <5 | 25% |
| 5 | 475 | 0.22 | <5 | 25% |
| 5 | 500 | 0.25 | 5-10 | 20% |
| 5 | 525 | 0.28 | 10-15 | 15% |
| 5 | 550 | 0.31 | 10-20 | 10% |
| 10 | 450 | 0.18 | <5 | 30% |
| 10 | 475 | 0.18 | <5 | 30% |
| 10 | 500 | 0.21 | 5-10 | 25% |
| 10 | 525 | 0.24 | 10-15 | 20% |
| 10 | 550 | 0.27 | 10-20 | 15% |
| 20 | 450 | 0.15 | <5 | 35% |
| 20 | 475 | 0.15 | <5 | 35% |
| 20 | 500 | 0.18 | 5-10 | 30% |
| 20 | 525 | 0.21 | 10-15 | 25% |

Below are listed particles, processes, and thermoplastic parameter disclosures. Testing standards for measurement values as stated hereinabove.

Particle Block 1: Mineral particles dispersed into a barrier layer formulation. The particles having a nanoparticle density in the range of 1.2 to 1.9 g/cm3 and optional microparticles having a density of 2.7 g/cm3 (plus or minus 10%) and having a specific heat of 0.200 to 0.214 calories (plus or minus 5%) required to heat 1 gram 1 degree C., and particle heat conductivity from about 0.0022 g to 0.0071 g-cal/sec-cm2 at 1 cm thick (plus or minus 5%), that is measured at a temperature of 20 C. The optional micro and/or colloidal mean particle size or from about 0.5 to 6.0 microns and having Moh hardness of 3.5-4.0 (plus or minus 10%). The micro particles coated with stearic acid in thicknesses falling within a range of about 5 microns to about 15 microns and also to include nanoparticles with sizes in the range of 50 to 100 nanometers in at least 1 dimension.

Particle Block 2: containing dispersed particles providing single and multiple combinations of mineral particle dispersions comprised of micro and/or colloidal particles having a mean particle size from about 0.50 to about 6.0 microns with a nanoparticle with having at least a 50-100 size range in at least one dimension and nanoparticle density range of 1.2 to 1.9 g/cm3 and optional microparticle density of 2.7 g/cm3 plus or minus 10% and micro particles having a specific heat of 0.200 to 0.214 calories (plus or minus 5%) required to heat 1 gram 1 degree C., and with heat conductivity (plus or minus 5%) from about 0.0022 g to 0.0071 g-cal/sec-cm2 at 1 cm thick measure at 20 C. The mineral micro and/or colloidal particles having a mean particle with a Moh hardness of 2.7-4.5 (plus or minus 110%).

Particle Block 3: particle content that is dispersed into the barrier structure compound in the form of pellets comprising either uncoated or coated nanoclay OMMT and/or OMT particle(s) providing isomorphous substitution in the range of about 0.55 to 4.0 and cation exchange capacity (CEC) in the range of [100-150] and/or [151-200] and/or [200-250] and/or [250-300] and/or [300-350] and/or [350-400] meq/100 g with a these free-flowing particle structures after intercalation and exfoliation having aspect ratios within the range of 200-900 and pre-intercalation particle size distributions in the range of 35-175 nm (D90=92 nm+−20%) particle size distribution (PSD). 0%) in at least 1 dimension, the particle specification having layered barrier structures, each barrier structure consisting of silica tetrahedral sheets around an optional aluminum octahedral sheet. The particles having a density between 1.2 g/cm3 to 1.9 g/cm3 and block 3 optional micro particle density of 2.71 g/cm3 (plus or minus 10%) as characterized by the Pycnometer Method, ASTM D3878 and ISO 1183 and X-ray Reflectivity (XRR) and pre intercalation organic interlayer d-spacing from between 0.9 nm to 3.0 nm and/or partially or fully intercalated d-layer spacing from 2.0-10 nm and partially to predominantly exfoliated particles in the d-spacing range of above 10 nm to an obscure to invisible XRD peak as measured by Transmission Electron Microscopy (TEM) which provides direct visualization of the material at the atomic or nanoscale level, high-resolution and TEM images revealing the gallery/inter-barrier structure and directly measures basal spacing. The thermoplastic nanocomposite comprising a barrier structure with a thermoplastic crystallinity in a range from about 60% to 80% and/or between 40% to 55% determined by X-ray Diffraction (XRD) and Differential Scanning Calorimetry (DSC) that are blended into mixtures to be extruded into finished pellets.

Particle Block 4: comprises nanoclay OMMT and/or OMT that is dispersed into the barrier structure compound used in the form of pellets. The OMT nanoparticles having 2:1 structure consisting of two silica tetrahedral sheets around an aluminum octahedral sheet having a CEC from about 200 to 300 meq/100 g (+−5%) Also, the OMMT and/or OMT layer may have a charge density by the Pycnometer Method, ASTM D3878 and ISO 1183 and X-ray Reflectivity (XRR) is from about −1.0 to −4.5, and an isomorphous substitution in the range of about 0.55 to 2.75. The particles having a density between 1.2 g/cm3 to about 1.9 g·cm3 (plus or minus 10%). Furthermore, the OMMT and/or OMT particle having a surface area of 200 to 290 m2/g (plus or minus 10%) and a Ph in the range of about 6 to 8.

Particle Block 5: includes particles dispersed into the polyolefin matrix having 1 or more attributes such as a cation exchange capacity “CEC” from 200-300 g/meq, particle charge density of −1.0 to 4.5, an isomorphous substitution in ranges up to from and/or [0.25-0.50] and/or [0.51-1.0] and/or [1.01-1.50] and/or [1.51-2.0] and/or [2.01-2.5] and/or [2.6-3.5] and/or [3.6-4.0] units per formula unit and having a nanoparticle density of about 1.2 to about 1.9 g/cm3 by the Pycnometer Method, ASTM D3878 and ISO 1183 and X-ray Reflectivity (XRR) and an original state (pre-processing) d-spacing from between 0.9 nm to 1.8 nm and partially and/or fully intercalated d-layer spacing from 2.0-10 nm and predominantly exfoliated having unclear to not visible XRD peak and a preferred MG2+ for Al3 substitution in the range of 15%-35%, also with aluminum (Al3+) substituting for silicon (Si4+) in the tetrahedral sheets thus creating a net negative charge, with a substitution of about 15%-25% of Si4+ replacing Al3+.

Particle Block 6: MMT or OMMT having a plus or minus 10% density between about 1.2 g/cm3 to about 1.9 g/cm3 per the Pycnometer Method, ASTM D3878 and ISO 1183 and X-ray Reflectivity (XRR). Having a cation exchange capacity “CEC” from 200-300 100 g/meq. Furthermore, the MMT particles having a PH in the range of about 6-8 and mean sizes of from 5-50 nm, preferably 5-75 nm or 5-100 nm, the nanoclay MMT particles comprised of silica tetrahedral sheets around an aluminum octahedral sheet, the nanoclay nano-silica (N-silica). an original state (pre-processing) d-spacing from between 0.5 nm to 3.0 nm and partially and/or fully intercalated d-layer spacing from 3.0-10 nm and predominantly exfoliated having d-spacing greater than 10 nm to an unclear to not visible XRD peak. The particle gallery/inter-barrier structure or basal spacing or d-spacing (d001), representing the repeating unit of barrier structured silicate as measured by Transmission Electron Microscopy (TEM) which provides direct visualization of the material at the atomic or nanoscale level, high-resolution and TEM images revealing the gallery/inter-barrier structure and per Braggs Law, directly measures basal spacing and per nλ=2d sin θ where: n is an integer representing the order of diffraction, λ is the wavelength of the X-rays, d is the spacing between the crystal planes, θ is the angle of incidence of the X-rays.

Particle Block 7: Net negative charged hydrophobic particles contained within the thermoplastic nanocomposite can include OMMT (organically modified) and/or OMT and/or MMT montmorillonite clay structure comprising an octahedral sheet of aluminum or magnesium hydroxide. The OMMT and/or OMT and/or MMT nanoclay having isomorphous substitution (IS) in ranges up to from and/or [25-0.50] and/or [0.51-1.0] and/or [1.01-1.50] and/or [1.51-2.0] and/or [2.01-2.5] and/or [2.6-3.5] and/or [3.6-4.0] units per formula unit s characterized by calculating the charge deficit: The IS rate is the net negative charge that results from substitution. For example, the replacement of Al3+ with Mg2+ creates a charge deficit of −1 at that site. Tabulating all of these charge deficits across the entire formula unit gives the total negative charge, which is the IS rate. The crystalline nanoclay phase identity of 2.1 smectite/montmorillonite particles and comprise plate like structures consisting of two silica tetrahedral sheets having a central alumina octahedral sheet, forming a 2:1 layer structure. These free-flowing particle structures after intercalation and exfoliation having aspect ratios within the range of 200-900 and and/or having aspect ratios within the range of [150-200] and/or [201-250] and/or [251-300] and/or [301-350] and/or [351-400] and/or [401-450] and/or [451-500] and/or [501-550] and/or [551-600] and/or [601-650] and/or [651-700] and/or [701 to 750] and/or [751-800] and/or [801-850] and/or [851-900] and/or [901-950] and/or [951-1000] as determined by Transmission Electron Microscopy (TEM). The most common methods are dynamic light scattering (DLS) for sub-micron particles These particles can also employ surface modifications to include dimethyldialkyl (C16-C18) ammonium chloride and other surface modifications found described within this specification. The particles having very high cation exchange capacity (CEC) in the range of 200 to 300 meq/100 g and/or (CEC) in the range of [100-150] and/or [151-200] and/or [200-250] and/or [250-300] and/or [300-350] and/or [350-400] meq/100 g as measured by atomic absorption spectroscopy (AAS) or inductively coupled plasma (ICP) spectroscopy, with PH in the range of 6-8 measured indirectly by creating a suspension of the particles in a liquid (usually deionized water) and then measuring the pH of that liquid. A standard pH meter with a glass electrode is used for this measurement and particle specific surface area (SSA) in the range of 200-290 m2/g measured using the Brunauer-Emmett-Teller (BET) method with a these free-flowing particle structures after intercalation and exfoliation having pre-intercalation particle size distributions in the range particle size distribution (PSD) average particle size measured using dynamic light scattering (DLS) and plate size length of 500-800 nm, the lateral dimensions (length and width) of nanoclay platelets are measured using Transmission Electron Microscopy (TEM) or Atomic Force Microscopy (AFM) with a thickness in the range of 1-3 nm measured using X-ray diffraction (XRD). The particles can be contained and used in Processing blocks 1-7 and Thermoplastic blocks 1-8.

Particle Block 8: Net negative charged hydrophobic particles contained within the nanocomposite with the chemical formula of Al2,H2,O12,Si4 can include OMMT (organically modified) and/or OMT and/or MMT montmorillonite clay structure comprising an octahedral sheet of aluminum or magnesium hydroxide having a cation exchange capacity (CEC) in the range of 250 meq/100 g (+−5%). The OMMT and/or OMT and/or MMT with a purity of 99.99% (+−2%) having a particle size distribution range of from 50-150 nm (D90 92 nm. Further, the particles can be found within sizes in the range 80-100 nm+−5% in at least one dimension a crystalline nanoclay phase identity of 2.1 smectite/montmorillonite particles and comprise plate like structures consisting of two silica tetrahedral sheets having a central alumina octahedral sheet, forming a 2:1 layer structure. These free-flowing particle structures after intercalation and exfoliation having aspect ratios within the range of 300-700 (+−5%) as determined by Transmission Electron Microscopy (TEM). These particles can also employ surface modifications to include dimethyldialkyl (C16-C18) ammonium chloride. The particles having very high cation exchange capacity (CEC) of 250 meq/100 g (+−5%) measured by atomic absorption spectroscopy (AAS) or inductively coupled plasma (ICP) spectroscopy, with PH of 7.5 (+−5%) measured indirectly by creating a suspension of the particles in a liquid (usually deionized water) and then measuring the pH of that liquid. A standard pH meter with a glass electrode is used for this measurement and particle specific surface area (SSA) in the range of 220-270 m2/g (+−5%) measured using the Brunauer-Emmett-Teller (BET) method with a particle size of 80-100 nm average particle size measured using dynamic light scattering (DLS) and plate size length of 600-700 nm (+−5%), the lateral dimensions (length and width) of nanoclay platelets are measured using Transmission Electron Microscopy (TEM) or Atomic Force Microscopy (AFM) with a thickness in the range of 1-2 nm (+−5%) measured using X-ray diffraction (XRD).

Particle block 9: Net negative charged hydrophobic particles contained within the nanocomposite can include OMMT (organically modified) and/or OMT and/or MMT montmorillonite clay structure comprising an octahedral sheet of aluminum or magnesium hydroxide. The OMMT and/or OMT and/or MMT nano clay having isomorphous substitution (IS) in ranges up to from and/or [25-0.50] and/or [0.51-1.0] and/or [1.01-1.50] and/or [1.51-2.0] and/or [2.01-2.5] and/or [2.6-3.5] and/or [3.6-4.0] units per formula unit as characterized by calculating the charge deficit: The IS rate is the net negative charge that results from substitution. For example, the replacement of Al3+ with Mg2+ creates a charge deficit of −1 at that site. Tabulating these charge deficits across the entire formula unit gives the total negative charge, which is the IS rate. The crystalline nano clay phase identity of 2.1 smectite/montmorillonite particles and comprise plate like structures consisting of two silica tetrahedral sheets having a central alumina octahedral sheet, forming a 2:1 layer structure. These free-flowing particle structures after intercalation and exfoliation having aspect ratios within the range of [150-200] and/or [201-250] and/or [251-300] and/or [301-350] and/or [351-400] and/or [401-450] and/or [451-500] and/or [501-550] and/or [551-600] and/or [601-650] and/or [651-700] and/or [701 to 750] and/or [751-800] and/or [801-850] and/or [851-900] and/or [901-950] and/or [951-1000] as determined by Transmission Electron Microscopy (TEM). The most common methods are dynamic light scattering (DLS) for sub-micron particles These particles can also employ surface modifications to include dimethylallyl (C16-C18) ammonium chloride and other surface modifications found described within this specification.

The particles having very high cation exchange capacity (CEC) in the range of 200-300 and/or [100-150] and/or [151-200] and/or [200-250] and/or [250-300] and/or [300-350] and/or [350-400] meq/100 g measured by atomic absorption spectroscopy (AAS) or inductively coupled plasma (ICP) spectroscopy, with PH in the range of 6-8 measured indirectly by creating a suspension of the particles in a liquid (usually deionized water) and then measuring the pH of that liquid. A standard pH meter with a glass electrode is used for this measurement and particle specific surface area (SSA) in the range of [150-200] and/or [201-250] and or [251-300] and/or [301-350] and/or [351-400] and/or [401-450]m2/g measured using the Brunauer-Emmett-Teller (BET) method with a these free-flowing particle structures after intercalation and exfoliation having pre-intercalation particle size distributions in the range particle size distribution (PSD) average particle size measured using dynamic light scattering (DLS) and plate size length of [300-400] and/or [401-450] and/or [451-500] and/or [501-550] and/or [551-600] and/or [610-650] and/or 651-700 and/or [701-750] and or [751-800] and/or [801-850] nm, the lateral dimensions (length and width) of nanoclay platelets are measured using Transmission Electron Microscopy (TEM) or Atomic Force Microscopy (AFM) with a thickness in the range of 1-3 nm measured using X-ray diffraction (XRD). The particles can be contained and used in Processing blocks 1-7 and Thermoplastic blocks 1-8.

Particle Block 10 Net negative charged hydrophobic particles contained within the nanocomposite can include Laponite synthetic clay and other synthetic clays structures comprising a 1 magnesium octahedral sheet sandwiched between two silicon tetrahedral sheets. In this structure Mg2+ is substituted with Li+, creating a negative charge. The particles having diameters from about 15 to 40 nm and thickness in the range of 0.5 to 1.5 nanometers. The particles having a cation exchange capacity “CEC” from of [100-150] and/or [151-200] and/or [200-250] and/or [250-300] and/or [300-350] and/or [350-400] meq/100 g measured by atomic absorption spectroscopy (AAS) or inductively coupled plasma (ICP) spectroscopy. The particles also having aspect ratios within the range of [150-200] and/or [201-250] and/or [251-300] and/or [301-350] and/or [351-400] and/or [401-450] and/or [451-500] and/or [501-550] and/or [551-600] and/or [601-650] and/or [651-700] and/or [701 to 750] and/or [751-800] and/or [801-850] and/or [851-900] and/or [901-950] and/or [951-1000] as determined by Transmission Electron Microscopy (TEM) with isomorphous substitution (IS) in ranges up to from and/or [25-0.50] and/or [0.51-1.0] and/or [1.01-1.50] and/or [1.51-2.0] and/or [2.01-2.5] and/or [2.6-3.5] and/or [3.6-4.0] units per formula unit as characterized by calculating the charge deficit: The IS rate is the net negative charge that results from substitution and the particle specific surface area (SSA) in the range of [150-200] and/or [201-250] and or [251-300] and/or [301-350] and/or [351-400] and/or [401-450]m2/g measured using the Brunauer-Emmett-Teller (BET) method. The particles with PH in the ranges of [6-7] and/or [7.1-8] and/or [8.1-9] measured indirectly by creating a suspension of the particles in a liquid (usually deionized water) and then measuring the pH of that liquid. A standard pH meter with a glass electrode is used for this measurement. The lateral dimensions (length and width) of the synthetic clay platelets are measured using Transmission Electron Microscopy (TEM) or Atomic Force Microscopy (AFM) with a thickness in the range of 1-3 nm measured using X-ray diffraction (XRD). The particles can be contained and used in Processing blocks 1-7 and Thermoplastic blocks 1-8 and employ surface modifications to include dimethyldialkyl (C16-C18) ammonium chloride or and maleic anhydride grafted polymer one example being (PP-g-MA) and other surface modifications found with this specification.

Thermoplastic Block 1: Thermoplastic content wherein the selected thermoplastic individual ingredients(s) having a density in the range of from about 0.915 g/cm3 to about 0.939 g/cm3 by the Pycnometer Method, ASTM D3878 and ISO 1183 and X-ray Reflectivity (XRR) and of from about 1% to up to 99% polyethylene and copolymers of polyethylene in the range of about 50,000 to 200,000 g/mol. EVOH can optionally be added to the blend having an MFI from about 0.8-22 g/10 min/216 kg, a density of about 1.12 to 1.19 g/cm3 as determined by Gel Permeation Chromatography (GPC) or Size Exclusion Chromatography (SEC). The EVOH having an Mn from about 10,000 to 125,000 g/mol and a Mw from about 20,000 to 300,000 g/mol. EVOH can be added from about 1 to 25% by volume of the mixture.

Thermoplastic Block 2: Thermoplastic content wherein the mixture containing one or more selections of thermoplastic ingredients, wherein the thermoplastic selections having a density in the range of from about 0.919 g/cm3 to 0.985 g/cm3 (+−5%) and having a layer flexural modulus 2% secant of from about 950-1125 MPa per ASTM D7908 of comprising from 1% and up to 99% by volume polyethylene and copolymers of polyethylene having average molecular weights in the range of 50,000 to 200,000 g/mol. From about 1% to 25% EVOH can optionally be added to the blend having an MFI from 0.8-22 g/10 min/216 kg, a density of about 1.12 to 1.19 g/cm3, as determined by Gel Permeation Chromatography (GPC) or Size Exclusion Chromatography (SEC). EVOH having an Mn from about 10,000 to 125,000 g/mol and a Mw from about 20,000 to 300,000 g/mol. EVOH can be added from about 1% to 20% the volume of the mixture.

Thermoplastic Block 3: thermoplastic content used to form a barrier structure which includes one or more selections of thermoplastic content that are blended and/or compounded into mixtures to be extruded into finished pellets which are then used to form a barrier layer. Thermoplastic ingredients comprising from 94% to 99% by volume of the barrier structure and individual ingredients having a premixture melt flow index (MFI) in the range of about 1.2 g/10 min (190 C/2.16 kg) to a MFI of about 12.0 gm/10 min (190 C/2.16 kg) per ASTM 1238, the selected thermoplastic ingredient(s) having a density in the range of from about 0.915 g/cm3 to about 0.985 g/cm3 comprising polyethylene.

Thermoplastic Block 4: thermoplastic ingredients containing thermoplastic content having a melt flow index (MFI) in the range of about 1.2 g/10 min (190 C/2.16 kg) to an MFI of about 14.0 gm/12 min (190 C/2.16 kg), the selected thermoplastic content(s) having a density in the range of from about 0.915 g/cm3 to about 0.97 g/cm and comprising from 1% to 99% by volume polyethylene and copolymers of polyethylene having average molecular weights in the range of 50,000 to 300,000 g/mol. EVOH can optionally be added to the blend as an ingredient having an MFI from about 0.8-22 g/10 min/216 kg, a density of about 1.12 to 1.19 g/cm3, as determined by Gel Permeation Chromatography (GPC) or Size Exclusion Chromatography (SEC). EVOH having a Mn from about 10,000 to 125,000 g/mol and a Mw from about 20,000 to 300,000 g/mol. The EVOH can be added from about 1% to 25% by volume of the mixture.

Thermoplastic Block 5: thermoplastic polyamide content is blended into a final form as pellets used to form a barrier structure such that during compound mixing the composition includes one or more selections of thermoplastic ingredients comprising from up to 99% by volume of the finished compound with the thermoplastic selections having a density in the range of from about 1.02 to 1.20 g/cm3, a water absorption percentage of about 1.2 to 1.9, glass transition temperature of about 184 F to 260 F, a shore hardness of about 71 to 85, polarizability of 38.2 (plus or minus 0.5), 10 (−24) cm3, a melting point of about 210 to 220 C and/or of about 260 to 265 C, and tensile strength of about 40 to 80 MPa. Finished pellets used to form a layer having surface lamination contact on one or two sides of a layered structure.

Thermoplastic Block 6: ingredients containing predominantly 10% to 99% homopolymer content and co-polymers of polyethylene having a melt flow index (MFI) in the range of about 0.5 g/10 min (190 C/2.16 kg) to an MFI of about 9.5 gm/12 min (190 C/2.16 kg), and also present in the mixture, selected polyethylene and copolymers of polyethylene thermoplastic content(s) having an estimated density in the range of from about 0.929 g/cm3 to about 0.975 g/cm, having average molecular weights in the approximate range of about 50,000 to 300,000 g/mol. EVOH can be added to the blend having an MFI from about 0.8-22 g/10 min/2.16 kg, a density of about 1.12 to 1.19 g/cm3, as determined by Gel Permeation Chromatography (GPC) or Size Exclusion Chromatography (SEC). EVOH having a Mn from about 10,000 to 125,000 g/mol and a Mw from about 20,000 to 300,000 g/mol. The EVOH can be added from about 1% to 20% by volume of the mixture.

Thermoplastic Block 7: One or more selections of thermoplastic ingredients containing thermoplastic content having a melt flow index (MFI) in the range of about 1.2 g/10 min (190 C/2.16 kg) to a MFI of about 14.0 gm/12 min (190 C/2.16 kg), the selected thermoplastic content(s) having a density in the range of from about 0.915 g/cm3 to about 0.985 g/cm and comprising from about 30% to 99% by volume polyethylene and copolymers of polyethylene having average molecular weights in the range of about 50,000 to 300,000 g/mol. Additionally, using compatibilizers, polyethylene naphthalate (PEN) can be optionally be added from about 1-20% with a MFI range: about 5-25 g/10 min (ASTM D1238), density in the ranges of about 1.33-1.38 g/cm³, a molecular weight (Mw) of about 30,000-80,000 g/mol, a melt temperature in the range of about 300-270° C., and a vicat softening point from about 150-180° C. (ASTM D1525), as determined by Gel Permeation Chromatography (GPC) or Size Exclusion Chromatography (SEC). The mixture may optionally use compatibilizers that include MAH-g-PO, e.g., maleic anhydride grafted polyolefins that create chemical links between PEN and the polyolefin.

Processing Block 1: thermoplastics are mixed into finished mixture including mineral particles and extruded or melt blended in one or more steps making pellets blended into final form as pellets in one or more steps, the pellets used for forming a barrier layer such that during compound mixing, the pressure during mixing from about 3480 Kpa to about 13,780 Kpa, with one or more mixing screws, including a lateral screw, turning at about 20 to 450 RPM, temperatures settings on the equipment during mixing set within a range of about 170 C-280 C, the mixing screw L/D ratios from about 20 to 40, and average shear rates (not localized shear rates) during mixing of about 40-1200 s¹ per ASTM D3835.

Processing Block 2: thermoplastics are formulated into a mixture including mineral particles and extruded or melt blended in one or more steps making pellets blended into final form as pellets in one or more steps used for forming a barrier layer such that during compound mixing, the finished pellets containing one or more selections of a thermoplastic material forming a barrier layer structure via various extrusion processes including blown films. The pressure during mixing between about 3480 to about 13,780 Kpa, with one or more extruder screws turning at about 20 to 2200 RPM, and temperature settings during mixing from about 170 C-310 C, mixing equipment screw L/D ratios from within the range of about 24 to 40, and average shear rates during mixing of from the range of about 40-1200 s¹ per ASTM D3835.

Processing Block 3: thermoplastics are mixed and then extruded or mixed including mineral particles and then melt blended in one or more steps making pellets blended in one or more steps used for forming a barrier layer such that during compound mixing, the finished pellets containing one or more selections of a thermoplastic material forming a cast or blown film barrier layer structure, the extrusion pressure ranges from about 5600 Kpa to about 12,100 Kpa, with a melt temperature from about 170 C to about 320 C, die temperatures from within 220 C to about 320 C and screw L/D ratio from about 20 to 42.

Processing Block 4: the thermoplastics are mixed into finished mixture including mineral particles and extruded or melt blended in one or more steps making pellets blended into final form as pellets in one or more steps used for forming a barrier layer such that during compound mixing, the finished pellets containing one or more selections of a thermoplastic material extrusion coating or extrusion laminating the mixed pellets on or more sides of the barrier layer or structure to an adjoining thermoplastic or fiber layer comprised of paper or synthetics.

Processing Block 5: after optionally drying the thermoplastic ingredients, they are formulated into a finished mixture including mineral particles and extruded or melt blended in one or more steps using 1 or more single or multiple screw compounders, such that during compound mixing, the finished pellets containing one or more selections of a thermoplastic material and optionally mixing EVOH with nano particles, such to form premixed pellets to be used as a packaging functional barrier layer. The optional EVOH having a Melt Flow Rate from about 1.2 to 25 g/10 minutes measured at 210 C @2.16 kg. and having a range from about 34 to 46 mol % including retort grades. Die gap from about 0.18 to 0.35 mil. When mixing the EVOH, using temperatures from about 170 to 240 C. The purpose of the finished EVOH particle containing pellets is to form a functional barrier layer used as a monolayer or individual layer within a coextrusion formed via extrusion, extrusion lamination, blown films, and the extrusion coating processes. If paper is a layer in the finished packaging structure, optional paper primers having PVDC, polyurethane, or water based acrylic content can be used. The pressure during extrusion between about 2480 to 23,780 Kpa, with one or more extruder screws turning at about 20 to 450 RPM, mixing equipment screw L/D ratios from within the range of about 200 to 800, and average shear rates during mixing from the range of about 40-12000 s¹ per ASTM D3835.

Processing Block 6: after drying the ingredients, melt mixing using a twin-screw compounder, mixing EVOH with nano particles such to form premixed pellets to be used as a barrier layer or compounding the mixture with a polymer in a first or second step to form pellets. The EVOH having a Melt Flow Rate (MFR) of about 0.5 to 25 g/10 minutes measured at 210 C @2.16 kg. having a range from about 30 to 46 mol %. The particles can be optionally mixed with polymer having a MFI in the range of about 1.2 g/10 min (190 C/2.16 kg) to an MFI of about 14.0 gm/12 min (190 C/2.16 kg), and the selected thermoplastic content(s) having a density in the range of from about 0.915 g/cm3 to 0.985 g/cm and having a stiffness modulus MPa of 700-1275 polyethylene and copolymers and homopolymers of ethylene having average molecular weights in the range of 50,000 to 200,000 g/mol. When optionally mixing EVOH using temperatures from about 170 to 240. The purpose of the optional EVOH-particle containing pellets is to form a primary barrier layer or as component of a multi-layer structure mixture used as functional barrier layer formed via extrusion in general to include blown films. The pressure during extrusion between about 2480 to 14,780 Kpa, with one or more extruder screws turning at about 20 to 450 RPM, mixing equipment screw L/D ratios from within the range of about 22 to 40, and average shear rates during mixing of from the range of about 40-12000 s¹ per ASTM D3835.

Processing Block 7: the first step including mixing mineral particles and then a second mixing step, such as melt mixing with one or more selections of thermoplastic ingredients having a MFI in the range of about 1.2 g/10 min (190 C/2.16 kg) to a MFI of about 14.0 gm/12 min (190 C/2.16 kg), the selected thermoplastic content(s) having a density in the range of from about 0.915 g/cm3 to about 0.975 g/cm and having a stiffness modulus MPa of about 700-1275 with homopolymers and copolymers of ethylene having average molecular weights in the range of about 50,000 to 200,000 g/mol and the pellets to form a primary barrier layer or as component of a polymer mixture used as functional barrier layer formed via extrusion, extrusion lamination, blown films, and the extrusion coating process optionally using paper primers having PVDC, polyurethane, or water based acrylic content. The pressure during extrusion between about 2480 to 14,780 Kpa, with one or more extruder screws turning at 20 to 800 RPM, mixing equipment screw L/D ratios from within the range of about 22 to 40, and average shear rates during mixing of from the range of about 40-12000 s¹ per ASTM D3835.

Processing Block 8: this block includes formulation rheology and processing conditions resulting in specific nano particle d-spacing by particle content in the finished thermoplastic composition forming a barrier layer having stipulated nanoclay content by weight of the thermoplastic nanocomposite. The Processing Block 8 parameters in the table below are plus or minus 30%.

Processing Block 8, process parameters

| | .5% to 2% nanoclay | 2% to 4% nanoclay | 4%-8% nanoclay | Particle |
|---|---|---|---|---|
| Process parameters | by weight | by weight | by weight | Length (minimum) |
| 40-1200 s¹ screw shear rate | layer d-spacing: in the | Layer d-spacing in the | d-layer spacing: | 140-200 am |
| | range of 6.0 nm to 8.5 nm | range of 7.0 nm until no | 3.5 to 8.0 am | |
| | | detected XRD peak: | | |
| Polymer nucleation density | layer d-spacing: in the | Layer d-spacing in the | d-layer spacing: | 140-200 mm |
| range 10\hat{ }10-10\hat{ }14 | range of 6.0 nm to 8.5 nm | range of 7.0 nm until no | 3.5 to 8.0 am | |
| | | detected XRD peak | | |
| Polymer crystallization | layer d-spacing: in the | Layer d-spacing in the | d-layer spacing: | 140-200 mm |
| 65-85 | range of 6.0 nm to 8.5 nm | range of 7.0 nm until no | 3.5 to 8.0 mm | |
| | | detected XRD peak | | |
| Processing range of .08 to .26 | layer d-spacing: in the | Layer d-spacing in the | d-layer spacing: | 140-200 mm |
| MPa shear stress | range of 6.0 nm to 8.5 nm | range of 7.0 nm until no | 3.5 to 8.0 am | |
| | | detected XRD peak | | |
| Polymer weighed average | layer d-spacing: in the | Layer d-spacing in the | d-layer spacing: | 140-200 pm |
| polydispersity index from | range of 6.0 nm to 8.5 nm | range of 7.0 nm until no | 3.5 to 8.0 nm | |
| 3.5 to 8.0 | | detected XRD peak | | |
| Polymer weighted average | layer d-spacing: in the | Layer d-spacing in the | d-layer spacing: | 140-200 mm |
| molecular weight of 80,000 | range of 6.0 nm to 8.5 nm | range of 7.0 nm until no | 3.5 to 8.0 nm | |
| to 140,000 g/mol | | detected XRD peak | | |
| Processing temperatures | layer d-spacing: in the | Layer d-spacing in the | d-layer spacing: | 140-200 mm |
| 170 C.-310 C. | range of 6.0 nm to 8.5 nm | range of78.0 nm until no | 3.5 to 8.0 nm | |
| | | detected XRD peak | | |

Processing Block 9 provides block 9 blown film processing parameters when processing thermoplastic compounds and thermoplastic nanocomposites found in this specification.

Processing Block 9, Blown films

| | | | 2 to 3-layer | | 4 to 6-layer | | 7 to 8-layer | |
|---|---|---|---|---|---|---|---|---|
| | Monolayer | | coextrusion | | coextrusion | | coextrusion | |
| Extrudate melt flow | 1.25-14.0 | | 1.25-12.0 | | 1.25-12.0 | | 1.25-10.0 | |
| Polymer density | .89-.987 | g/cm3 | .89-.987 | g/cm3 | .89-.987 | g/m3 | .89-.987 | g/cm3 |
| Bubble temperature top | 25 C.-70 C. | | 25 C.-70 C. | | 25 C.-70 C. | | 25 C.-70 C. | |
| Internal cooling temp bottom | −20 C. to 10 C. | | −20 C. to 10 C. | | −20 C. to 10 C. | | −20 C. to 10 C. | |
| Layer thickness | 5-125 | micron | 5-125 | micron | 5-125 | micron | 5-125 | micron |
| Extrudate melt strength | 5-35 | cN | 5-40 | cN | 5-50 | cN | 5-50 | cN |

| | | | | |
|---|---|---|---|---|
| Film air ring size (temperature | 100 mm-1000 mm | 100 mm-1000 mm | 100 mm-1000 mm | 100 mm-1000 mm |
| ranges 20 C.-45 C.) | | | | |
| Film blow up ratio (BUR) | 2.0-8.0 | 2.0-8.0 | 2.0-6.0 | 2.0-6.0 |
| BUR = D/d | | | | |
| Film layer internal bubble | −20 C.-10 C. | −20 C.-10 C. | −20 C.-8 C. | −20 C.-8 C. |
| cooling range | | | | |
| Film molecular orientation | .30-.80 | .30-.80 | .30-.80 | .30-.80 |
| (XRD method) | | | | |
| Film layer draw down ratio “DDR” | 10:1-30:1 | 10:1-30:1 | 10:1-30:1 | 10:1-30:1 |
| Finished layer weight | 4 gsm-180 gsm | 6 gsm-180 gsm | 12 gsm-180 gsm | 19 gsm-180 gsm |

Processing Block 10: the table below provides Procession Block 10 extrusion coating and extrusion lamination parameters when processing thermoplastic compounds and thermoplastic nanocomposites stated within the present disclosure.

Processing Block 10, extrusion coating and lamination parameters

| Applies to monolayer and | | Extrusion | | |
|---|---|---|---|---|
| coextrusion from 2-8 layers | | Coating/Lamination | | |
| with at least one paper layer in | | Parameters | | |
| composite | | | | |
| Tables 1-44 barrier results, and | | | | |
| the stated combinations of | | | | |
| particle blocks 1-6, | | | | |
| thermoplastic blocks 1-7, and | | | | |
| process blocks 1-10 apply | | | | |
| within the scope of Table E. | | | | |
| Barrier layer structures | Extruder | See Table F | Total average of | Comments |
| | #1 | | all layers | |
| | Monolayer | | | |
| MELT FLOW-Carrier | .8-22 g/ | 8-22 g/10 min/ | | Interspersed |
| Resin(s) bonding agent | 10 min/ | 2.16 kg | | and non- |
| | 2.16 kg | | | interspersed |
| Thermoplastic density ranges | .915 to .985 | .915 to .985 | .915 to .985 | |
| for non-fiber layers | g/cm³ | g/cm³ | g/cm³ | |
| Micro particle mineral | See Tables 1-44 | See Tables 1-44 | General mineral | Interspersed |
| content by volume of the | | | content 0%-30% | and non- |
| layer on top line, nano | | | by volume of | interspersed |
| particle volume of layer | | | the overall | |
| second line | | | total of non- | |
| | | | fiber layer(s) | |
| MELT TEMPERATURE | 535-620° F. | 535-620 F. | | |
| | (307° C.) | | | |
| DESIRED BARREL PRESS. | 1000-2500 | 1000-2500 psi | 1200-2500 psi | |
| | psi | | | |
| Composite Melt Flow range | 1.2-14 g/10 | 1.2-14 g/10 min | | Interspersed |
| of non-fiber layer(s) | 2.16 kg | 2.16/kg | | and non- |
| | | | | interspersed |
| Air Gap | 1″ 10″ | 1″ to 10″ | 1″-10″ | Only when |
| | | | | adjustable |
| Die Gap | 0.025″- | 0.025″-0.040″ | 0.020″-0.050″ | Only when |
| | 0.030″ | | | adjustable |
| Monolayer and Coextrusion | Initial | Maximum | Settings Die | Maximum |
| or separate downstream | Settings | Adjustment | Zone | Adjustment |
| laminations #1 monolayer | Barrel Zones | Barrel Zones | | Die Zone |
| and 2-6 coex layers | | | | |
| TEMPERATURE | | | | |
| SETTINGS | | | | |
| Melt Temperature | 485-620° F. | | 485-620 F. | |
| BARREL ZONE #1 | 405 F. | −30% + 15% | Die Zone 1 | 485−590 F. −5 + 6% |
| BARREL ZONE #2 | 485-540° F. | −30% + 14% | Die Zones 2-10 | 590° F. −5% + 6% |
| | | | (as applicable | |
| | | | to equipment) | |
| BARREL ZONE #3 | 485-575° F. | −30% + 5% | Die Zone 11 | 590° F. −5% + 6% |
| | | | (as applicable | |
| | | | to equipment) | |
| BARREL ZONE #4 | 485-590° F. | −25% + 5% | | |
| BARREL ZONE #5 | 485-590° F. | −25% + 6% | | |

The following tables 1-44 disclose barrier results for oxygen, moisture, and water when dispersing OMMT and/or OMT nanoparticle(s) into various polymer processes, materials, particles, and formulations. The dispersed thermoplastic nanocomposite minerals having either monomodal or multimodal combinations of mineral particles. In the finished packaging structure, the thermoplastic nanocomposites can be used in singular or multiple packaging layers. Also, one or two sides of the thermoplastic nanocomposite layer can contact and/or coat an opposing fiber or polymer containing layer the thermoplastic containing layer(s) from preferably about a basis weight of from 40 g/m2 to 600 g/m2, the thermoplastic nanocomposites also forming blown and cast films, per TAPPI T 410 for coated paper and ISO 4592 standard specifying methods for determining the mass per unit area of plastic films.

The composite single or multi-layer structures are then used to form an industrial or retail package. Tables 1-44 and Examples 1-4 disclose methods employed when dispersing nanoparticles comprising nanoclay OMMT and/or OMT optionally with micro and/or colloidal particle(s) dispersed together within a thermoplastic polymer matrix, therefore, forming either monomodal and/or multimodal particles including colloidal-microparticle-nanoparticle composite layers in sheets and rolls in weights from 40 g/m2 to 500 g/m2, the composites forming layers of blown and/or cast films.

The following is found in Tables 1-44 are mono and/or multi-modal thermoplastic nanocomposites extrusion laminated or extrusion coated to a paper of fiber layer(s) having from about 40 g/m2 to 600 g/m2. The columns are read horizontally from the left to the right with the resulting thermoplastic nanocomposite coated paper barrier performance (the result of selecting identified block combinations in the single horizontal line direction) shown in the “Transmission Rates” column. For example, column one: “Type Thermoplastic”; the second column: “Thermoplastic Volume”; the third column: “Particle 1” (if used), Volume and Type; the fourth column: “Particle 2” (if used), Volume and Type; the fifth column: “Process 1 and/or process 2” (if used) from the listed Processing Blocks 1-10. The columns to the right of the fifth column are barrier performances. Any MVTR @90% RH @37.8 C moisture vapor transmission rates per Tappi T464 stated in g/m2/24 hours results having no entries and/or blank spaced oxygen barrier are assumed to be 0% relative humidity (RH) at 23 C measured at g/m2/24 hours. Any oxygen barrier results having no entries or blank are assumed to be at 0% RH at between 37.8 C measured in cc(m2/day).

The following Tables 10-25 and some tables 30-42 are barrier layer thermoplastic nanocomposites when 1-side extrusion coated or extrusion laminated paper or fiber(s) from 35 g/m2 to 600 g/m2 The columns are read horizontally from the left to the right with the resulting thermoplastic nanocomposite barrier performance (the result of selecting identified block combinations) are shown in the “Transmission Rates” column. For example, column one: “Type Thermoplastic”; the second column: “Thermoplastic Volume”; the third column: “Particle 1” (if used), Volume and Type; the fourth column: “Particle 2” (if used), Volume and Type; the fifth column: “Process 1 and/or process 2” (if used). The Processing Blocks identified in the fifth column are used independently in the formula, however, yielding the same barrier results. The barrier results are reported in the remaining far right columns for all tables having oxygen barrier standard ASTM F2622, at the designated % relative humidity (RH) @760 mmHg gas pressure, test gas is 100% oxygen per Mocon QMS 702-002, measured at cc(m2/day), and water barrier per Tappi T441, 24-hour, Cobb water absorption measured in g/m2, and moisture barrier transmission (MVTR) rates per Tappi T464 at the table stated RH conditions.

If the MVTR is unstated on any table, it is assumed to be at 90% RH, 23 C per Tappi T464 stated in g/m2/24 hours and if oxygen barrier is unstated on any table it assumed to at 0% RH @23 C. having oxygen barrier standard ASTM F2622, @760 mmHg gas pressure, test gas is 100% oxygen per Mocon QMS 702-002, measured at cc(m2/day).

Some of the following Tables 1-44 include thermoplastic nanocomposite films and sheets not contacting fiber. The columns are read horizontally from the left to the right with the resulting thermoplastic nanocomposite barrier performance (the result of selecting identified block combinations) are shown in the “Transmission Rates” column. For example, column one: “Type Thermoplastic”; the second column: “Thermoplastic Volume”; the third column: “Particle 1” (if used), Volume and Type; the fourth column: “Particle 2” (if used), Volume and Type; the fifth column: “Process 1 and/or process 2” (if used). The Processing Blocks identified in the fifth column are used independently in the formula, however, yielding the same barrier results. Barrier testing standards used for films and sheets for moisture vaper transmission rates (MVTR) per Tappi T557 measured @37.8 C, 90% RH, g/24 hr/m2 and oxygen transmission rates measured per ASTM D 3985, 37.8 C, 0% RH, cc/m2/24 hours.

### Use of Tables 1-44

Example A: identifying combinations of thermoplastics, particles, and processing conditions resulting in specified barrier performance ranges for oxygen, moisture (MVTR), and Cobb water permeation.

Example A, Table 1 selected materials and conditions (left to right block selections)
Column 1 selection: type of thermoplastic, block 1 and/or block 2 apply individually
Column 2 selection: stated thermoplastic volume 68-71% by volume of the layer
Column 3 selection: stated block 1 particle at 28% by volume of the layer
Column 4 selection: comprising block 4 particles comprising 2-4% by volume of the layer
Column 5 selection: individual process block land/or process block 2 apply
Example A, Table 1, resulting barrier performance transmission ranges found in the last 3 columns based upon the identified block selections are as follows: MVTR 1.33-2.88 oxygen 317-598, 24 hour cobb water barrier 0-2.87.

Example B: identifying combinations of thermoplastics, particles, and processing conditions resulting in specified barrier performance ranges for oxygen, moisture (MVTR), and Cobb water permeation.

Example B, Table 11 selected materials and conditions (left to right block selections)
Column 1 selection: thermoplastic type block 6
Column 2 selection: thermoplastic volume 94%-96%
Column 3 selection: no particle 1 volume or type selected, no particle 1 used in layer
Column 4 selection: particle 2 selection is block 1 having a volume range of 2.5% to 6.0%
Column 5 selection: process 1, selected process block 2, process 2 has no block selection
Example B, Table 11 the resulting barrier performance found in the last 3 columns based upon Table 11 example B as follows: MVTR 90% to 100% relative humidity (RH) in the range of 3.4 to 8.8, 0-75% RH oxygen barrier in the range of 15-75, 24-hour Cobb water barrier in the range of 0.41 to 1.60.

Example C: identifying combinations of thermoplastics, particles, and processing conditions resulting in specified barrier performance ranges for oxygen, moisture (MVTR), and Cobb water permeation.
Example C, Table 15 selected materials and conditions (left to right block selections)
Column 1 selection: type of thermoplastic, block 3
Column 2 selection: stated thermoplastic volume 96-88% by volume of the layer
Column 3 selection: 2.5% to 4% particle volume
Column 4 selection: Particle Block 5
Column 5 selection: individual and/or Processing Blocks 5, 6, 7 selected, note each processing block selected is an independent condition as such combined with the other columns
Example C barrier performance transmission ranges based upon the above Table 15 block selections found in the last 2 columns are as follows: 90% RH MVTR 3.5-8.1 and oxygen 0.393-190.

Example D: identifying combinations of thermoplastics, particles, and processing conditions resulting in specified barrier performance ranges for oxygen, moisture (MVTR), and Cobb water permeation.
Example D, Table 17 selected materials and conditions (left to right block selections)
Column 1 selection: thermoplastic block 6
Column 2 selection: thermoplastic volume 95%-98%
Column 3 selection: particle 1 is 2.5% to 5% by volume using particle block 5
Column 4 selection: process 1 is a block 2 and/or process 2 is using block 6
Example D Table 17 resulting barrier performance found in the last 2 columns based upon the Table 17 example as follows: MVTR 2.5 to 4.6, 0% RH oxygen barrier in the range of 0.13 to 49. [

Example E: identifying combinations of thermoplastics, particles, and processing conditions resulting in specified barrier performance ranges for oxygen, moisture (MVTR), and Cobb water permeation.
Table 28 (1), Example E: selected materials and conditions (left to right block selections)
Column 1 selection: thermoplastic block 6
Column 2 selection: thermoplastic volume 95%-98%
Column 3 selection: EVOH content none
Column 4 selection: particle block 5, volume 2-5%
Column 5 initial process 5
Column 6 final process 9
Example E, Table 28 (1) barrier performance found in the last 2 columns based upon Example E, as follows: MVTR in the range of 0.98-2.33 and oxygen barrier the range of 5.7-17.0. Table 28 (2),
Example E: selected materials and conditions (left to right block selections)
Column 1 selection: thermoplastic block 2
Column 2 selection: thermoplastic volume 95%-98%
Column 3 selection: EVOH content none
Column 4 selection: particle block 4, volume 2-5%
Column 5 initial process 5
Column 6 final process 9
Example E, Table 28 (2) resulting barrier performance found in the last 2 columns based upon Table 28.
Example E, as follows: Barrier transmission performance as found in the last two columns MVTR in the range of 0.98-2.33 and oxygen barrier the range of 5.7-17.0.

Tables 43 and 44 have fiber layer characteristics when extrusion coating or extrusion laminating paper and fiber to thermoplastic nanocomposites layers as found within some of the Tables 1-44.

TABLE 1
Method and Composition A
30 to 50 micron thickness

| Type | Thermo- | Particle | | Particle | | | | | | |
|---|---|---|---|---|---|---|---|---|---|---|
| Themro- | plastic | 1 | | 2 | | Process | Process | Transmission Rates | | |
| plastic | Volume | Volume | Type | Volume | Type | #1 | #2 | MVTR | Oxygen | Water |
| Block 1 | 68-71% | 28% | Block 1 | 2-4% | Block 3 | Block 1 | Block 2 | 1.33-2.09 | 479-540 | .95-2.33 |
| Block 2 | 70-75% | 23% | Block 1 | 2-4% | Block 3 | Block 1 | Block 2 | 1.30-2.70 | 449-507 | .59-2.87 |
| | 76-79% | 19% | Block 1 | 2-4% | Block 3 | Block 1 | Block 2 | 1.7-2.11 | 380-598 | .66-2.22 |
| | 82-80% | 16% | Block 1 | 2-4% | Block 3 | Block 1 | Block 2 | 1.28-2.22 | 325-436 | .44-1.45 |
| | 83-85% | 14% | Block 1 | 1.5-3% | Block 3 | Block 1 | Block 2 | 1.30-1.01 | 329-436 | 0-1.77 |
| | 86-88% | 11% | Block 1 | 1.5-3% | Block 3 | Block 1 | Block 2 | 1.22-2.20 | 322-566 | 0-1.44 |
| | 89-90% | 9% | Block 1 | 1-8% | Block 3 | Block 1 | Block 2 | 1.83-2.47 | 319-555 | 0-1.31 |
| | 91-93% | 6% | Block 1 | 1-2% | Block 3 | Block 1 | Block 2 | 1.28-2.86 | 317-583 | .86-1.91 |
| | 92-95% | 4% | Block 1 | 1-2% | Block 3 | Block 1 | Block 2 | 1.11-2.99 | 320-566 | .62-1.84 |
| | 94-97% | 2% | Block 1 | 1-2% | Block 3 | Block 1 | Block 2 | | | |
| | 96-99% | 0% | Block 1 | 1-2% | Block 3 | Block 1 | Block 2 | | | |

TABLE 2
Method and Composition B
30 to 50 micron thickness

| Type | Thermo- | Particle | | Particle | | | | | | |
|---|---|---|---|---|---|---|---|---|---|---|
| Themro- | plastic | 1 | | 2 | | Process | Process | Transmission Rates | | |
| plastic | Volume | Volume | Type | Volume | Type | #1 | #2 | MVTR | Oxygen | Water |
| Block 1 | 68-71% | 28% | Block 2 | 4.5-6% | Block 3 | Block 2 | Block 2 | 1.33-2.09 | 479-540 | .98-2.93 |
| Block 2 | 70-75% | 23% | Block 2 | 4.5-6% | Block 3 | Block 2 | Block 2 | 1.30-2.70 | 449-607 | .59-2.87 |
| | 76-79% | 19% | Block 2 | 4.5-5% | Block 3 | Block 2 | Block 2 | 1.7-2.11 | 380-598 | .66-2.22 |
| | 82-80% | 16% | Block 2 | 3-5% | Block 3 | Block 2 | Block 2 | 1.28-2.22 | 255-430 | .44-1.45 |
| | 83-85% | 14% | Block 2 | 3-5% | Block 3 | Block 2 | Block 2 | 1.80-1.01 | 250-486 | 0-1.77 |
| | 86-88% | 11% | Block 2 | 3-5% | Block 3 | Block 2 | Block 2 | 1.22-2.20 | 254-511 | 0-1.44 |
| | 89-90% | 9% | Block 2 | 2-5% | Block 3 | Block 2 | Block 2 | 1.38-2.47 | 274-577 | 0-1.31 |
| | 91-93% | 6% | Block 2 | 2-5% | Block 3 | Block 2 | Block 2 | 1.28-2.58 | 283-681 | .68-1.91 |
| | 92-95% | 4% | Block 2 | 2-4% | Block 3 | Block 2 | Block 2 | 1.11-2.99 | 274-556 | .62-1.84 |
| | 94-97% | 2% | Block 2 | 2-4% | Block 3 | Block 2 | Block 2 | | | |
| | 96-99% | 0% | Block 2 | 2-4% | Block 3 | Block 2 | Block 2 | | | |

TABLE 3
Method and Composition C
30 to 50 micron thickness

| Type | Thermo- | Particle | | Particle | | | | | | |
|---|---|---|---|---|---|---|---|---|---|---|
| Themro- | plastic | 1 | | 2 | | Process | Process | Transmission Rates | | |
| plastic | Volume | Volume | Type | Volume | Type | #1 | #2 | MVTR | Oxygen | Water |
| Block 1 | 68-66% | 28% | Block1 | 4.5-6% | Block 3 | Block 2 | None | 1.73-4.44 | 587-710 | .92-2.44 |
| | 73-71% | 23% | Block1 | 4.5-6% | Block 3 | Block 2 | | 1.83-3.58 | 490-612 | .69-2.37 |
| | 76-77% | 19% | Block1 | 4.5-5% | Block 3 | Block 2 | | 1.51-4.32 | 545-579 | .66-1.70 |
| | 79-82% | 16% | Block1 | 3-5% | Block 3 | Block 2 | | .81-2.42 | 322-480 | 0-1.35 |
| | 81-85% | 14% | Block1 | 3-5% | Block 3 | Block 2 | | .65-1.28 | 319-404 | 0-1.61 |
| | 84-87% | 11% | Block1 | 3-5% | Block 3 | Block 2 | | .77-1.20 | 325-421 | 0-1.60 |
| | 86-89% | 9% | Block1 | 2-5% | Block 3 | Block 2 | | .91-1.87 | 320-480 | 0-1.71 |
| | 90-93% | 6% | Block1 | 2-5% | Block 3 | Block 2 | | 1.08-1.88 | 332-512 | .94-1.91 |
| | 92-95% | 4% | Block1 | 2-4% | Block 3 | Block 2 | | 1.13-1.90 | 290-576 | 1.20-2.84 |
| | 94-97% | 2% | Block1 | 2-4% | Block 3 | Block 2 | | | | |
| | 96-99% | 0% | Block1 | 2-4% | Block 3 | Block 2 | | | | |

TABLE 4
Method and Composition D
30 to 50 micron thickness

| Type | Thermo- | Particle | | Particle | | | | | | |
|---|---|---|---|---|---|---|---|---|---|---|
| Themro- | plastic | 1 | | 2 | | Process | Process | Transmission Rates | | |
| plastic | Volume | Volume | Type | Volume | Type | #1 | #2 | MVTR | Oxygen | Water |
| Block 1 | 68-66% | 28% | Block 2 | 2-4% | Block 3 | Block 2 | none | 1.73-4.44 | 587-860 | .92-2 44 |
| | 73-71% | 23% | Block 2 | 2-4% | Block 3 | Block 2 | | 1.83-3.58 | 490-612 | .69-2.37 |
| | 76-77% | 19% | Block 2 | 2-4% | Block 3 | Block 2 | | 1.51-4.32 | 300-522 | .66-1.70 |
| | 79-82% | 16% | Block 2 | 2-4% | Block 3 | Block 2 | | .81-2.42 | 319-430 | 0-1.35 |
| | 81-85% | 14% | Block 2 | 1.5-3% | Block 3 | Block 2 | | .65-1.28 | 309-404 | 0-1.61 |
| | 84-87% | 11% | Block 2 | 1.5-3% | Block 3 | Block 2 | | .77-1.20 | 330-421 | 0-1.60 |
| | 86-89% | 9% | Block 2 | 1-2% | Block 3 | Block 2 | | .91-1.87 | 321-616 | 0-1.71 |
| | 90-93% | 6% | Block 2 | 1-2% | Block 3 | Block 2 | | 1.08-1.85 | 322-581 | .94-1.91 |
| | 92-95% | 4% | Block 2 | 1-2% | Block 3 | Block 2 | | 1.13-1.90 | 311-574 | 1.20-2.84 |
| | 94-97% | 2% | Block 2 | 1-2% | Block 3 | Block 2 | | | | |
| | 96-99% | 0% | Block 2 | 1-2% | Block 3 | Block 2 | | | | |

TABLE 5
Method and Composition E
30 to 50 micron thickness

| Type | Thermo- | Particle | | Particle | | | | | | |
|---|---|---|---|---|---|---|---|---|---|---|
| Themro- | plastic | 1 | | 2 | | Process | Process | Transmission Rates | | |
| plastic | Volume | Volume | Type | Volume | Type | #1 | #2 | MVTR | Oxygen | Water |
| Block 4 | 68-71% | 28% | Block 1 | 2-4% | Block 4 | Block 1 | Block 2 | 1.33-4.49 | 379-640 | .98-1.13 |
| | 70-75% | 23% | Block 1 | 2-4% | Block 4 | Block 1 | Block 2 | 1.30-3.70 | 349-607 | .59-1.21 |
| | 76-79% | 19% | Block 1 | 2-4% | Block 4 | Block 1 | Block 2 | 1.7-4.11 | 266-497 | .66-.99 |
| | 82-80% | 16% | Block 1 | 2-4% | Block 4 | Block 1 | Block 2 | .91-2.22 | 175-374 | 0-.90 |
| | 83-85% | 14% | Block 1 | 1.5-3% | Block 4 | Block 1 | Block 2 | .75-1.01 | 168-290 | 0-.79 |
| | 86-88% | 11% | Block 1 | 1.5-3% | Block 4 | Block 1 | Block 2 | .81-1.05 | 151-222 | 0-.79 |
| | 89-90% | 9% | Block 1 | 1-2% | Block 4 | Block 1 | Block 2 | .91-3.87 | 162-201 | 0-.82 |
| | 91-93% | 6% | Block 1 | 1-2% | Block 4 | Block 1 | Block 2 | 1.18-2.88 | 387-681 | 1.1-2.28 |
| | 92-95% | 4% | Block 1 | 1-2% | Block 4 | Block 1 | Block 2 | 1.00-2.99 | 374-566 | 1.2-2.84 |
| | 94-97% | 2% | Block 1 | 1-2% | Block 4 | Block 1 | Block 2 | | | |
| | 96-99% | 0% | Block 1 | 1-2% | Block 4 | Block 1 | Block 2 | | | |

TABLE 6
Method and Composition F
30 to 50 micron thickness

| Type | Thermo- | Particle | | Particle | | | | | | |
|---|---|---|---|---|---|---|---|---|---|---|
| Themro- | plastic | 1 | | 2 | | Process | Process | Transmission Rates | | |
| plastic | Volume | Volume | Type | Volume | Type | #1 | #2 | MVTR | Oxygen | Water |
| Block 4 | 68-66% | 28% | Block 1 | 4-6% | Block 4 | Block 1 | Block 2 | .46-1.21 | 309-555 | .91-1.83 |
| | 73-70% | 23% | Block 1 | 4-6% | Block 4 | Block 1 | Block 2 | .78-1.19 | 349-607 | .69-1.66 |
| | 75-77% | 19% | Block 1 | 4-5% | Block 4 | Block 1 | Block 2 | .79-1.03 | 238-598 | .76-1.47 |
| | 78-82% | 16% | Block 1 | 2-5% | Block 4 | Block 1 | Block 2 | .49-.99 | 190-411 | .46-1.45 |
| | 83-85% | 14% | Block 1 | 2-5% | Block 4 | Block 1 | Block 2 | .51-1.01 | 175-405 | 0.0-1.55 |
| | 84-87% | 11% | Block 1 | 2-5% | Block 4 | Block 1 | Block 2 | .47-.91 | 180-461 | 0.0-1.44 |
| | 86-89% | 9% | Block 1 | 2-5% | Block 4 | Block 1 | Block 2 | .50-.87 | 190-416 | 0.0-1.39 |
| | 90-93% | 6% | Block 1 | 2-5% | Block 4 | Block 1 | Block 2 | 1.08-3.88 | 318-681 | .0-1.91 |
| | 92-95% | 4% | Block 1 | 2-4% | Block 4 | Block 1 | Block 2 | 1.11-2.99 | 274-566 | .32-1.84 |
| | 94-97% | 2% | Block 1 | 2-4% | Block 4 | Block 1 | Block 2 | | | |
| | 96-99% | 0% | Block 1 | 2-4% | Block 4 | Block 1 | Block 2 | | | |

TABLE 7
Method and Composition G
30 to 50 micron thickness

| Type | Thermo- | Particle | | Particle | | | | | | |
|---|---|---|---|---|---|---|---|---|---|---|
| Themro- | plastic | 1 | | 2 | | Process | Process | Transmission Rates | | |
| plastic | Volume | Volume | Type | Volume | Type | #1 | #2 | MVTR | Oxygen | Water |
| Block 4 | 68-71% | 28% | Block 1 | 2-4% | Block 2 | Block 2 | none | 1.33-4.49 | 292-376 | .98-1.13 |
| | 70-75% | 23% | Block 1 | 2-4% | Block 2 | Block 2 | | 1.30-3.70 | 223-390 | .59-1.21 |
| | 76-79% | 19% | Block 1 | 2-4% | Block 2 | Block 2 | | 1.7-4.11 | 266-497 | .66-.99 |
| | 82-80% | 16% | Block 1 | 2-4% | Block 2 | Block 2 | | .91-2.22 | 175-374 | 0-.90 |
| | 83-85% | 14% | Block 1 | 1.5-3% | Block 2 | Block 2 | | .75-1.01 | 168-290 | 0-.79 |
| | 86-88% | 11% | Block 1 | 1.5-3% | Block 2 | Block 2 | | .81-1.05 | 151-222 | 0-.79 |
| | 89-90% | 9% | Block 1 | 1-2% | Block 2 | Block 2 | | .91-3.87 | 162-201 | 0-.82 |
| | 91-93% | 6% | Block 1 | 1-2% | Block 2 | Block 2 | | 1.18-2.88 | 187-300 | 1.1-2.28 |
| | 92-95% | 4% | Block 1 | 1-2% | Block 2 | Block 2 | | 1.00-2.99 | 211-328 | 1.2-2.84 |
| | 94-97% | 2% | Block 1 | 1-2% | Block 2 | Block 2 | | | | |
| | 96-99% | 0% | Block 1 | 1-2% | Block 2 | Block 2 | | | | |

TABLE 8
Method and Composition H
30 to 50 micron thickness

| Type | Thermo- | Particle | | Particle | | | | | | |
|---|---|---|---|---|---|---|---|---|---|---|
| Themro- | plastic | 1 | | 2 | | Process | Process | Transmission Rates | | |
| plastic | Volume | Volume | Type | Volume | Type | #1 | #2 | MVTR | Oxygen | Water |
| Block 4 | 68-66% | 28% | Block 1 | 4-6% | Block 2 | Block 2 | none | .46-1.21 | 220-390 | .91-1.83 |
| | 73-70% | 23% | Block 1 | 4-6% | Block 2 | Block 2 | | .78-1.19 | 194-448 | .69-1.66 |
| | 75-77% | 19% | Block 1 | 4-5% | Block 2 | Block 2 | | .79-1.03 | 238-400 | .76-1.47 |
| | 78-82% | 16% | Block 1 | 2-5% | Block 2 | Block 2 | | .49-.99 | 190-411 | .46-1.45 |
| | 83-85% | 14% | Block 1 | 2-5% | Block 2 | Block 2 | | .51-1.01 | 175-405 | 0.0-1.55 |
| | 84-87% | 11% | Block 1 | 2-5% | Block 2 | Block 2 | | .47-.91 | 180-461 | 0.0-1.44 |
| | 86-89% | 9% | Block 1 | 2-5% | Block 2 | Block 2 | | .50-.87 | 190-416 | 0.0-1.39 |
| | 90-93% | 6% | Block 1 | 2-5% | Block 2 | Block 2 | | 1.08-3.88 | 235-576 | .0-1.91 |
| | 92-95% | 4% | Block 1 | 2-4% | Block 2 | Block 2 | | 1.11-2.99 | 274-566 | .32-1.84 |
| | 94-97% | 2% | Block 1 | 2-4% | Block 2 | Block 2 | | | | |
| | 96-99% | 0% | Block 1 | 2-4% | Block 2 | Block 2 | | | | |

TABLE 9
Method and Composition I
30 to 50 micron thickness

| Type | Thermo- | Particle | | Particle | | | | | | |
|---|---|---|---|---|---|---|---|---|---|---|
| Themro- | plastic | 1 | | 2 | | Process | Process | Transmission Rates | | |
| plastic | Volume | Volume | Type | Volume | Type | #1 | #2 | MVTR | Oxygen | Water |
| Block 5 | 89-92% | 6% | Block 1 | 2-5% | Block 4 | Block 1 | Block 4 | 173-211 | 77-144 | 0.0-.71 |
| | 93-95% | 4% | Block 1 | 2-4% | Block 4 | | | 181-190 | 78-121 | 0.0-.57 |
| | 94%-96% | 2% | Block 1 | 2-4% | Block 4 | | | 171-181 | 89-138 | 0.0-.51 |
| | 96-98% | 0% | Block 1 | 2-4% | Block 4 | | | 140-196 | 66-122 | 0.0-.58 |

TABLE 10
Method and Composition
30 to 60 micron thickness

| | | | | | | | | Transmission Rates | | |
|---|---|---|---|---|---|---|---|---|---|---|
| Type | Thermo- | Particle | | Particle | | | | | | Water |
| Themro- | plastic | 1 | | 2 | | Process | Process | MVTR | Oxygen | Cobb |
| plastic | Volume | Volume | Type | Volume | Type | #1 | #2 | 90-100% RH | 0-75% RH | 24/hr |

| | | | | | | | | | |
|---|---|---|---|---|---|---|---|---|---|
| Block 6 | 94-96% | 4-6% | Block 2 | Block 1 | Block 2 | | | | |
| | 94-96% | 4-6% | Block 2 | Block 1 | Block 2 | | | | |
| | 94-96% | 4-5% | Block 2 | Block 1 | Block 2 | | | | |
| | 95-97% | 2.5-5% | Block 2 | Block 1 | Block 2 | | | | |
| | 95-97% | 2.5-5% | Block 2 | Block 1 | Block 2 | {close oversize brace} | 3.4-8.8 | 387-1198 | 41-1.60 |
| | 95-97% | 2.5-5% | Block 2 | Block 1 | Block 2 | | | | |
| | 95-97% | 2.5-5% | Block 2 | Block 1 | Block 2 | | | | |
| | 95-97% | 2.5-5% | Block 2 | Block 1 | Block 2 | | | | |
| | 96-98% | 2.5-4% | Block 2 | Block 1 | Block 2 | | | | |

TABLE 11
Method and Composition P
30 to 60 micron thickness

| | | | | | | | | Transmission Rates | | |
|---|---|---|---|---|---|---|---|---|---|---|
| Type | Thermo- | Particle | | Particle | | | | | | Water |
| Themro- | plastic | 1 | | 2 | | Process | Process | MVTR | Oxygen | Cobb |
| plastic | Volume | Volume | Type | Volume | Type | #1 | #2 | 90-100% RH | 0-75% RH | 24/hr |

| | | | | | | | | | |
|---|---|---|---|---|---|---|---|---|---|
| Block 6 | 94-97% | 2.5-6% | Block 2 | Block 2 | none | | | | |
| | 94-97% | 2.5-6% | Block 2 | Block 2 | | | | | |
| | 94-97% | 2.5-6% | Block 2 | Block 2 | | | | | |
| | 94-97% | 2.5-6% | Block 2 | Block 2 | | | | | |
| | 94-97% | 2.5-6% | Block 2 | Block 2 | | {close oversize brace} | 3.85-6.43 | 440-1436 | .26-1.9 |
| | 94-97% | 2.5-6% | Block 2 | Block 2 | | | | | |
| | 94-97% | 2.5-6% | Block 2 | Block 2 | | | | | |
| | 94-97% | 2.5-6% | Block 2 | Block 2 | | | | | |

TABLE 12
Method and Composition Q
30 to 60 micron thickness

| | | | | | | | | Transmission Rates | | |
|---|---|---|---|---|---|---|---|---|---|---|
| Type | Thermo- | Particle | | Particle | | | | | | Water |
| Themro- | plastic | 1 | | 2 | | Process | Process | MVTR | Oxygen | Cobb |
| plastic | Volume | Volume | Type | Volume | Type | #1 | #2 | 90-100% RH | 0-75% RH | 24/hr |

| | | | | | | | | | |
|---|---|---|---|---|---|---|---|---|---|
| Block 6 | 94-96% | 4-6% | Block 2 | Block 2 | none | | | | |
| | 94-96% | 4-6% | Block 2 | Block 2 | | | | | |
| | 94-96% | 4-5% | Block 2 | Block 2 | | | | | |
| | 95-98% | 2.5-5% | Block 2 | Block 2 | | | | | |
| | 95-98% | 2.5-5% | Block 2 | Block 2 | | | | | |
| | 95-98% | 2.5-5% | Block 2 | Block 2 | | {close oversize brace} | 2.98-4.66 | 238-1201 | .22-1.50 |
| | 95-98% | 2.5-5% | Block 2 | Block 2 | | | | | |
| | 95-98% | 2.5-5% | Block 2 | Block 2 | | | | | |
| | 96-98% | 2.5-4% | Block 2 | Block 2 | | | | | |
| | 96-98% | 2.5-4% | Block 2 | Block 2 | | | | | |

TABLE 13
Method and Composition R
30 to 60 micron thickness

| | | | | | | | | Transmission Rates | | |
|---|---|---|---|---|---|---|---|---|---|---|
| Type | Thermo- | Particle | | Particle | | | | | | Water |
| Themro- | plastic | 1 | | 2 | | Process | Process | MVTR | Oxygen | Cobb |
| plastic | Volume | Volume | Type | Volume | Type | #1 | #2 | 0-75% RH | 0-75% RH | 24/hr |

| | | | | | | | | | |
|---|---|---|---|---|---|---|---|---|---|
| Block 6 | 94-96% | 4.0-6.0 | Block 5 | Block 1 | Block 4 | | | | |
| | 96-96.5 | 3.5-4% | Block 5 | | | {close oversize brace} | 2.02-4.22 | 77-144% | 0-.51 |
| | 97-97.5% | 2.5-3% | Block 5 | | | | | | |

TABLE 14
Method and Composition N
30 to 60 micron thickness

| Type | Thermo- | Particle | | | | | Transmission Rates | |
|---|---|---|---|---|---|---|---|---|
| Themro- | plastic | 1 | | Process | Process | | MVTR | Oxygen |
| plastic | Volume | Volume | Type | #1 | #2 | | 0-75% RH | 0% RH |
| Block 4 | 94-97% | 3-6% | Block 4 | Block 5 | Block 7 | | | |
| | 94-97% | 3-6% | Block 4 | Block 5 | Block 7 | | | |
| | 94-97% | 3-6% | Block 4 | Block 5 | Block 7 | | | |
| | 94-97% | 3-6% | Block 4 | Block 5 | Block 7 | {close oversize brace} | 1.99-4.33 | 11 to 9.8 |
| | 96-97.5% | 2.5-4% | Block 4 | Block 5 | Block 7 | | | |
| | 96-97.5% | 2.5-4% | Block 4 | Block 5 | Block 7 | | | |
| | 96-97.5% | 2.5-4% | Block 4 | Block 5 | Block 7 | | | |

TABLE 15
Method and Composition
30 to 60 micron thickness

| Type | Thermo- | | Particle | Processing | | Transmission Rates | |
|---|---|---|---|---|---|---|---|
| Themro- | plastic | Particle | 1 | Blocks | | MVTR | Oxygen |
| plastic | Volume | Volume | Type | 5, 6, 7 | | 90% RH | 0% RH |
| Block 3 | 94-96% | 4-6% | Block 5 | 5, 6 7 | | | |
| | 94-96% | 4-6% | Block 5 | 5, 6, 7 | | | |
| | 94-96% | 4-5% | Block 5 | 5, 6, 7 | | | |
| | 95-97% | 2.5-5% | Block 5 | 5, 6, 7 | | | |
| | 95-97% | 2.5-5% | Block 5 | 5, 6, 7 | {close oversize brace} | 3.5-8.1 | .393-190 |
| | 95-97% | 2.5-5% | Block 5 | 5, 6, 7 | | | |
| | 95-97% | 2.5-5% | Block 5 | 5, 6, 7 | | | |
| | 95-97% | 2.5-5% | Block 5 | 5, 6, 7 | | | |
| | 96-98% | 2.5-4% | Block 5 | 5, 6, 7 | | | |

TABLE 16
Method and Composition
30 to 60 micron thickness

| | | | | | | Transmission | |
|---|---|---|---|---|---|---|---|
| Type | Thermo- | Particle | | | | Rates | |
| Themro- | plastic | 1 | | Processing | | MVTR | Oxygen |
| plastic | Volume | Volume | Type | Blocks | | 90-100% RH | 0% RH |
| Block 4 | 94-97% | 2.5-6% | Block 5 | 5, 6, 7 | | | |
| | 94-97% | 2.5-6% | Block 5 | 5, 6, 7 | | | |
| | 94-97% | 2.5-6% | Block 5 | 5, 6, 7 | | | |
| | 94-97% | 2.5-6% | Block 5 | 5, 6, 7 | | | |
| | 94-97% | 2.5-6% | Block 5 | 5, 6, 7 | {close oversize brace} | 2.77-6.43 | .21-91 |
| | 94-97% | 2.5-6% | Block 5 | 5, 6, 7 | | | |
| | 94-97% | 2.5-6% | Block 5 | 5, 6, 7 | | | |
| | 94-97% | 2.5-6% | Block 5 | 5, 6, 7 | | | |

TABLE 17
Method and Composition
30 to 60 micron thickness

| Type | Thermo- | Particle | | | | | Transmission Rates | |
|---|---|---|---|---|---|---|---|---|
| Themro- | plastic | 1 | | Process | Process | | MVTR | Oxygen |
| plastic | Volume | Volume | Type | #1 | #2 | | 90-100% RH | 0% RH |
| Block 6 | 94-96% | 4-6% | Block 5 | Block 2 | Block 6 | | | |
| | 94-96% | 4-6% | Block 5 | Block 2 | Block 6 | | | |
| | 94-96% | 4-5% | Block 5 | Block 2 | Block 6 | | | |
| | 95-98% | 2.5-5% | Block 5 | Block 2 | Block 6 | | | |
| | 95-98% | 2.5-5% | Block 5 | Block 2 | Block 6 | | | |
| | 95-98% | 2.5-5% | Block 5 | Block 2 | Block 6 | {close oversize brace} | 2.55-4.66 | .13-49 |
| | 95-98% | 2.5-5% | Block 5 | Block 2 | Block 6 | | | |
| | 95-98% | 2.5-5% | Block 5 | Block 2 | Block 6 | | | |
| | 96-98% | 2.5-4% | Block 5 | Block 2 | Block 6 | | | |
| | 96-98% | 2.5-4% | Block 5 | Block 2 | Block 6 | | | |

TABLE 18
Method and Composition R
30 to 60 micron thickness

| Type | Thermo- | Particle | | | | | Transmission Rates | |
|---|---|---|---|---|---|---|---|---|
| Themro- | plastic | 1 | | Process | Process | | MVTR | Oxygen |
| plastic | Volume | Volume | Type | #1 | #2 | | 0-75% RH | 0% RH |
| Block 6 | 94-96% | 4.0-6.0 | Block 5 | Block 1 | Block 4 | | | |
| | 96-96.5 | 3.5-4% | Block 5 | | | {close oversize brace} | 2.02-4.22 | 1.77-144 |
| | 97-97.5% | 2.5-3% | Block 5 | | | | | |

TABLE 19
Method and Composition
30 to 60 micron thickness

| Type | Thermo- | | Particle | | | Transmission Rates | |
|---|---|---|---|---|---|---|---|
| Themro- | plastic | Particle | 1 | Processing | | MVTR | Oxygen |
| plastic | Volume | Volume | Type | Blocks | | 90% RH | 0-75% RH |
| Block 4 | 94-96% | 4-6% | Block 5 | 6 | | | |
| | 94-96% | 4-6% | Block 5 | 6 | | | |
| | 94-96% | 4-5% | Block 5 | 6 | | | |
| | 95-97% | 2.5-5% | Block 5 | 6 | | | |
| | 95-97% | 2.5-5% | Block 5 | 6 | {close oversize brace} | 4.5-8.1 | .29-244 |
| | 95-97% | 2.5-5% | Block 5 | 6 | | | |
| | 95-97% | 2.5-5% | Block 5 | 6 | | | |
| | 95-97% | 2.5-5% | Block 5 | 6 | | | |
| | 96-98% | 2.5-4% | Block 5 | 6 | | | |

TABLE 20
Method and Composition
30 to 60 micron thickness

| Type | Thermo- | Particle | | | | Transmission Rates | |
|---|---|---|---|---|---|---|---|
| Themro- | plastic | 1 | | Processing | | MVTR | Oxygen |
| plastic | Volume | Volume | Type | Blocks | | 90-100% RH | 0-75% RH |
| Block 6 | 94-97% | 2.5-6% | Block 5 | 7 | | | |
| | 94-97% | 2.5-6% | Block 5 | 7 | | | |
| | 94-97% | 2.5-6% | Block 5 | 7 | | | |
| | 94-97% | 2.5-6% | Block 5 | 7 | | | |
| | 94-97% | 2.5-6% | Block 5 | 7 | {close oversize brace} | 1.916.43 | .21-313 |
| | 94-97% | 2.5-6% | Block 5 | 7 | | | |
| | 94-97% | 2.5-6% | Block 5 | 7 | | | |
| | 94-97% | 2.5-6% | Block 5 | 7 | | | |

TABLE 21
Method and Composition
30 to 60 micron thickness

| Type | Thermo- | Particle | | | | | Transmission Rates | |
|---|---|---|---|---|---|---|---|---|
| Themro- | plastic | 1 | | | Process | | MVTR | Oxygen |
| plastic | Volume | Volume | Type | Process | #1 | | 90-100% RH | 0% RH |
| Block 6 | 94-96% | 4-6% | Block 3 | | Block 6 | | | |
| | 94-96% | 4-6% | Block 3 | | Block 6 | | | |
| | 94-96% | 4-5% | Block 3 | | Block 6 | | | |
| | 95-98% | 2.5-5% | Block 3 | | Block 6 | | | |
| | 95-98% | 2.5-5% | Block 3 | | Block 6 | | | |
| | 95-98% | 2.5-5% | Block 3 | | Block 6 | {close oversize brace} | 1.89-4.66 | .13-298 |
| | 95-98% | 2.5-5% | Block 3 | | Block 6 | | | |
| | 95-98% | 2.5-5% | Block 3 | | Block 6 | | | |
| | 96-98% | 2.5-4% | Block 3 | | Block 6 | | | |
| | 96-98% | 2.5-4% | Block 3 | | Block 6 | | | |

TABLE 22
Method and Composition
30 to 60 micron thickness

| Type | Thermo- | Particle | | | | | Transmission Rates | |
|---|---|---|---|---|---|---|---|---|
| Themro- | plastic | 1 | | | Process | | MVTR | Oxygen |
| plastic | Volume | Volume | Type | Process | #1 | | 90-100% RH | 0% RH |
| 4 | 94-96% | 4-6% | Block 2 | Block 5 | Block 6 | | | |
| | 94-96% | 4-6% | Block 2 | Block 5 | Block 6 | | | |
| | 94-96% | 4-5% | Block 2 | Block 5 | Block 6 | | | |
| | 95-98% | 2.5-5% | Block 2 | Block 5 | Block 6 | | | |
| | 95-98% | 2.5-5% | Block 2 | Block 5 | Block 6 | | | |
| | 95-98% | 2.5-5% | Block 2 | Block 5 | Block 6 | {close oversize brace} | 1.79-4.66 | 49-88 |
| | 95-98% | 2.5-5% | Block 2 | Block 5 | Block 6 | | | |
| | 95-98% | 2.5-5% | Block 2 | Block 5 | Block 6 | | | |
| | 96-98% | 2.5-4% | Block 2 | Block 5 | Block 6 | | | |
| | 96-98% | 2.5-4% | Block 2 | Block 5 | Block 6 | | | |

TABLE 23
Method and Composition
30 to 60 micron thickness

| Type | Thermo- | Particle | | Particle | | | | | Transmission Rates | |
|---|---|---|---|---|---|---|---|---|---|---|
| Themro- | plastic | 1 | | 2 | | | Process | | MVTR | Oxygen |
| plastic | Volume | Volume | Type | Volume | Type | Process | #1 | | 90-100% RH | 0% RH |
| 3 | 94-96% | 4-6% | Block 4 | 4-6% | Block 2 | | Block 3 | | | |
| | 94-96% | 4-6% | Block 4 | 4-6% | Block 2 | | Block 3 | | | |
| | 94-96% | 4-5% | Block 4 | 4-5% | Block 2 | | Block 3 | | | |
| | 95-98% | 2.5-5% | Block 4 | 2.5-5% | Block 2 | | Block 3 | | | |
| | 95-98% | 2.5-5% | Block 4 | 2.5-5% | Block 2 | | Block 3 | | | |
| | 95-98% | 2.5-5% | Block 4 | 2.5-5% | Block 2 | | Block 3 | {close oversize brace} | 2.77-4.92 | .29-371 |
| | 95-98% | 2.5-5% | Block 4 | 2.5-5% | Block 2 | | Block 3 | | | |
| | 95-98% | 2.5-5% | Block 4 | 2.5-5% | Block 2 | | Block 3 | | | |
| | 96-98% | 2.5-4% | | 2.5-4% | Block 2 | | Block 3 | | | |
| | 96-98% | 2.5-4% | Block 4 | 2.5-4% | Block 2 | | Block 3 | | | |

TABLE 24
Method and Composition
30 to 60 micron thickness

| Type | Thermo- | Particle | | Particle | | | | | Transmission Rates | |
|---|---|---|---|---|---|---|---|---|---|---|
| Themro- | plastic | 1 | | 2 | | Process | Process | | MVTR | Oxygen |
| plastic | Volume | Volume | Type | Volume | Type | #1 | #2 | | 90-100% RH | 0% RH |
| 2 | 94-96% | 4-6% | Block 5 | 4-6% | Block 2 | Block 4 | Block 6 | | | |
| | 94-96% | 4-6% | Block 5 | 4-6% | Block 2 | Block 4 | Block 6 | | | |
| | 94-96% | 4-5% | Block 5 | 4-5% | Block 2 | Block 4 | Block 6 | | | |
| | 95-98% | 2.5-5% | Block 5 | 2.5-5% | Block 2 | Block 4 | Block 6 | | | |
| | 95-98% | 2.5-5% | Block 5 | 2.5-5% | Block 2 | Block 4 | Block 6 | | | |
| | 95-98% | 2.5-5% | Block 5 | 2.5-5% | Block 2 | Block 4 | Block 6 | {close oversize brace} | 2.51-4.99 | .12-194 |
| | 95-98% | 2.5-5% | Block 5 | 2.5-5% | Block 2 | Block 4 | Block 6 | | | |
| | 95-98% | 2.5-5% | Block 5 | 2.5-5% | Block 2 | Block 4 | Block 6 | | | |
| | 96-98% | 2.5-4% | Block 5 | 2.5-4% | Block 2 | Block 4 | Block 6 | | | |
| | 96-98% | 2.5-4% | Block 5 | 2.5-4% | Block 2 | Block 4 | Block 6 | | | |

TABLE 25
Method and Composition
30 to 60 micron thickness

| Type | Thermo- | Particle | | Particle | | | | | Transmission Rates | |
|---|---|---|---|---|---|---|---|---|---|---|
| Themro- | plastic | 1 | | 2 | | Process | Process | | MVTR | Oxygen |
| plastic | Volume | Volume | Type | Volume | Type | #1 | #2 | | 90-100% RH | 0% RH |
| 7 | 94-96% | 4-6% | Block 5 | 4-6% | Block 3 | Block 4 | Block 3 | | | |
| | 94-96% | 4-6% | Block 5 | 4-6% | Block 3 | Block 4 | Block 3 | | | |
| | 94-96% | 4-5% | Block 5 | 4-5% | Block 3 | Block 4 | Block 3 | | | |
| | 95-98% | 2.5-5% | Block 5 | 2.5-5% | Block 3 | Block 4 | Block 3 | | | |
| | 95-98% | 2.5-5% | Block 5 | 2.5-5% | Block 3 | Block 4 | Block 3 | | | |
| | 95-98% | 2.5-5% | Block 5 | 2.5-5% | Block 3 | Block 4 | Block 3 | {close oversize brace} | 4.33-6.51 | 39-333 |
| | 95-98% | 2.5-5% | Block 5 | 2.5-5% | Block 3 | Block 4 | Block 3 | | | |
| | 95-98% | 2.5-5% | Block 5 | 2.5-5% | Block 3 | Block 4 | Block 3 | | | |
| | 96-98% | 2.5-4% | Block 5 | 2.5-4% | Block 3 | Block 4 | Block 3 | | | |
| | 96-98% | 2.5-4% | Block 5 | 2.5-4% | Block 3 | Block 4 | Block 3 | | | |

TABLE 26
Method and Composition
15 to 25 micron thickness

| | | | | | | | | | Barrier Ranges | |
|---|---|---|---|---|---|---|---|---|---|---|
| Thremo- | Thermo- | | | | | | | | Transmission Rates | |
| plastic | plastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-98% | No | No | 2-5% | 3, 4, 5 | 7 | 9 | | | |
| 1, 2, 3, 4, 6 | 95-98% | No | No | 2-5% | 3, 4, 5 | 7 | 9 | | | |
| 1, 2, 3, 4, 6 | 95-98% | No | No | 2-5% | 3, 4, 5 | 7 | 9 | | | |
| 1, 2, 3, 4, 6 | 95-98% | No | No | 2-5% | 3, 4, 5 | 7 | 9 | {close oversize brace} | 1.20-4.88 | 5.99-75.4 |
| 1, 2, 3, 4, 6 | 95-98% | No | No | 2-5% | 3, 4, 5 | 7 | 9 | | | |
| 1, 2, 3, 4, 6 | 95-98% | No | No | 2-5% | 3, 4, 5 | 7 | 9 | | | |
| 1, 2, 3, 4, 6 | 95-98% | 11-20% | No | 2-5% | 3, 4, 5 | 7 | 9 | | | |
| 1, 2, 3, 4, 6 | 95-98% | 11-20% | No | 2-5% | 3, 4, 5 | 7 | 9 | {close oversize brace} | 1.9-6.60 | .12-9.8 |
| 1, 2, 3, 4, 6 | 95-95% | 11-20% | No | 2-5% | 3, 4, 5 | 7 | 9 | | | |

TABLE 27
Method and Composition
15 to 25 micron thickness

| | | | | | | | | | Barrier ranges | |
|---|---|---|---|---|---|---|---|---|---|---|
| Thremo- | Thermo- | | | | | | | | Transmission Rates | |
| plastic | plastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-98% | No | No | 2-5% | 3, 4, 5 | 6 | 9 | | | |
| 1, 2, 3, 4, 6 | 95-98% | No | No | 2-5% | 3, 4, 5 | 6 | 9 | | | |
| 1, 2, 3, 4, 6 | 95-98% | No | No | 2-5% | 3, 4, 5 | 6 | 9 | | | |
| 1, 2, 3, 4, 6 | 95-98% | No | No | 2-5% | 3, 4, 5 | 6 | 9 | {close oversize brace} | 1.31-3.81 | 31-229 |
| 1, 2, 3, 4, 6 | 95-98% | No | No | 2-5% | 3, 4, 5 | 6 | 9 | | | |
| 1, 2, 3, 4, 6 | 95-98% | No | No | 2-5% | 3, 4, 5 | 6 | 9 | | | |
| 1, 2, 3, 4, 6 | 80%-89% | 11-20% | No | 2-5% | 3, 4, 5 | 6 | 9 | | | |
| 1, 2, 3, 4, 6 | 80%-89% | 11-20% | No | 2-5% | 3, 4, 5 | 6 | 9 | {close oversize brace} | 1.9-6.60 | .12-24.7 |
| 1, 2, 3, 4, 6 | 80%-89% | 11-20% | No | 2-5% | 3, 4, 5 | 6 | 9 | | | |

TABLE 28
Methods and Compositions
15 to 30 micron thickness

| | | | | | | | | | Barrier ranges | |
|---|---|---|---|---|---|---|---|---|---|---|
| Thremo- | Thermo- | | | | | | | | Transmission Rates | |
| plastic | plastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-98% | No | No | 2-5% | 4, 5 | 5 | 9 | | | |
| 1, 2, 3, 4, 6 | 95-98% | No | No | 2-5% | 4, 5 | 5 | 9 | | | |
| 1, 2, 3, 4, 6 | 95-98% | No | No | 2-5% | 4, 5 | 5 | 9 | | | |
| 1, 2, 3, 4, 6 | 95-98% | No | No | 2-5% | 4, 5 | 5 | 9 | {close oversize brace} | .98-2.33 | 5.7-17 |
| 1, 2, 3, 4, 6 | 95-98% | No | No | 2-5% | 4, 5 | 5 | 9 | | | |
| 1, 2, 3, 4, 6 | 95-98% | No | No | 2-5% | 4, 5 | 5 | 9 | | | |
| 1, 2, 3, 4, 6 | 80%-89% | 11-20% | No | 2-5% | 4, 5 | 5 | 9 | | | |
| 1, 2, 3, 4, 6 | 80%-89% | 11-20% | No | 2-5% | 4, 5 | 5 | 9 | {close oversize brace} | 1.46-2.91 | .08-11.2 |
| 1, 2, 3, 4, 6 | 80%-89% | 11-20% | No | 2-5% | 4, 5 | 5 | 9 | | | |

TABLE 29
Methods and Compositions
15 to 30 micron thickness

| | | | | | | | | | Barrier ranges | |
|---|---|---|---|---|---|---|---|---|---|---|
| Thremo- | Thermo- | | | | | | | | Transmission Rates | |
| plastic | plastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-98% | No | No | 2-5% | 3 | 6, 7 | 9 | | | |
| 1, 2, 3, 4, 6 | 95-98% | No | No | 2-5% | 3 | 6, 7 | 9 | | | |
| 1, 2, 3, 4, 6 | 95-98% | No | No | 2-5% | 3 | 6, 7 | 9 | | | |
| 1, 2, 3, 4, 6 | 95-98% | No | No | 2-5% | 3 | 6, 7 | 9 | | | |
| 1, 2, 3, 4, 6 | 95-98% | No | No | 2-5% | 3 | 6, 7 | 9 | {close oversize brace} | .88-2.66 | 6.7-55 |
| 1, 2, 3, 4, 6 | 95-98% | No | No | 2-5% | 3 | 6, 7 | 9 | | | |
| 1, 2, 3, 4, 6 | 95-98% | No | No | 2-5% | 3 | 6, 7 | 9 | | | |
| 1, 2, 3, 4, 6 | 95-98% | No | No | 2-5% | 3 | 6, 7 | 9 | | | |
| 1, 2, 3, 4, 6 | 95-98% | No | No | 2-5% | 3 | 6, 7 | 9 | | | |

TABLE 30
Method and Composition
15 to 30 micron thickness

| | | | | | | | | | Barrier ranges | |
|---|---|---|---|---|---|---|---|---|---|---|
| Thremo- | Thermo- | | | | | | | | Transmission Rates | |
| plastic | plastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-98% | No | No | 2-5% | 3, 4, 5 | 6 | 10 | | | |
| 1, 2, 3, 4, 6 | 95-98% | No | No | 2-5% | 3, 4, 5 | 6 | 10 | | | |
| 1, 2, 3, 4, 6 | 95-98% | No | No | 2-5% | 3, 4, 5 | 6 | 10 | | | |
| 1, 2, 3, 4, 6 | 95-98% | No | No | 2-5% | 3, 4, 5 | 6 | 10 | | | |
| 1, 2, 3, 4, 6 | 95-98% | No | No | 2-5% | 3, 4, 5 | 6 | 10 | {close oversize brace} | 5.2-6.8 | 22-61.5 |
| 1, 2, 3, 4, 6 | 95-98% | No | No | 2-5% | 3, 4, 5 | 6 | 10 | | | |
| 1, 2, 3, 4, 6 | 95-98% | No | No | 2-5% | 3, 4, 5 | 6 | 10 | | | |
| 1, 2, 3, 4, 6 | 95-98% | No | No | 2-5% | 3, 4, 5, | 6 | 10 | | | |
| 1, 2, 3, 4, 6 | 95-98% | No | No | 2-5% | 3, 4, 5 | 6 | 10 | | | |

TABLE 31
Methods and Compositions
15 to 30 micron thickness

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95.5%-.98.5% | No | No | 1.5-4.5 | 7 | 3.5 | 10 | | | |
| 1, 2, 3, 4, 6 | 95.5%-98.5 | No | No | 1.5-4.5 | 7 | 3.5 | 10 | | | |
| 1, 2, 3, 4, 6 | 95.5%-98.5% | No | No | 1.5-4.5 | 7 | 3.5 | 10 | | | |
| 1, 2, 3, 4, 6 | 95.5%-98.5% | No | No | 1.5-4.5 | 7 | 3.5 | 10 | | | |
| 1, 2, 3, 4, 6 | 95.5%-98.5% | No | No | 1.5-4.5 | 7 | 3.5 | 10 | {close oversize brace} | 5.33-8.87 | 45.5-86.4 |
| 1, 2, 3, 4, 6 | 95.5%-98.5% | No | No | 1.5-4.5 | 7 | 3.5 | 10 | | | |
| 1, 2, 3, 4, 6 | 95.5%-98.5% | No | No | 1.5-4.5 | 7 | 3.5 | 10 | | | |
| 1, 2, 3, 4, 6 | 95.5%-98.5% | No | No | 1.5-4.5 | 7 | 3.5 | 10 | | | |
| 1, 2, 3, 4, 6 | 95.5%-98.5% | No | No | 1.5-4.5 | 7 | 3.5 | 10 | | | |

TABLE 32
Methods and Compositions
15 to 30 micron thickness

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95.5%-.98.5% | No | No | 1.5-4.5 | 6 | 8 | 10 | | | |
| 1, 2, 3, 4, 6 | 95.5%-98.5 | No | No | 1.5-4.5 | 6 | 8 | 10 | | | |
| 1, 2, 3, 4, 6 | 95.5%-98.5% | No | No | 1.5-4.5 | 6 | 8 | 10 | | | |
| 1, 2, 3, 4, 6 | 95.5%-98.5% | No | No | 1.5-4.5 | 6 | 8 | 10 | | | |
| 1, 2, 3, 4, 6 | 95.5%-98.5% | No | No | 1.5-4.5 | 6 | 8 | 10 | {close oversize brace} | 5.39-8.87 | 11.6-89.0 |
| 1, 2, 3, 4, 6 | 95.5%-98.5% | No | No | 1.5-4.5 | 6 | 8 | 10 | | | |
| 1, 2, 3, 4, 6 | 95.5%-98.5% | No | No | 1.5-4.5 | 6 | 8 | 10 | | | |
| 1, 2, 3, 4, 6 | 95.5%-98.5% | No | No | 1.5-4.5 | 6 | 8 | 10 | | | |
| 1, 2, 3, 4, 6 | 95.5%-98.5% | No | No | 1.5-4.5 | 6 | 8 | 10 | | | |

TABLE 33
Methods and Compositions
15 to 30 micron thickness

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-98% | No | No | 2-5% | 6 | 8 | 9 | | | |
| 1, 2, 3, 4, 6 | 95-98% | No | No | 2-5% | 6 | 8 | 9 | | | |
| 1, 2, 3, 4, 6 | 95-98% | No | No | 2-5% | 6 | 8 | 9 | | | |
| 1, 2, 3, 4, 6 | 95-98% | No | No | 2-5% | 6 | 8 | 9 | | | |
| 1, 2, 3, 4, 6 | 95-98% | No | No | 2-5% | 6 | 8 | 9 | {close oversize brace} | .91-2.66 | .98-75.4 |
| 1, 2, 3, 4, 6 | 95-98% | No | No | 2-5% | 6 | 8 | 9 | | | |
| 1, 2, 3, 4, 6 | 95-98% | No | No | 2-5% | 6 | 8 | 9 | | | |
| 1, 2, 3, 4, 6 | 95-98% | No | No | 2-5% | 6 | 8 | 9 | | | |
| 1, 2, 3, 4, 6 | 95-98% | No | No | 2-5% | 6 | 8 | 9 | | | |

TABLE 34
Methods and Compositions
15-25 g/m2 weight

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | | 6 | 9 | | | |
| 1, 2, 3, 4, 6 | 95-99% | No | No | 1-5% | | 6 | 9 | | | |
| 1, 2, 3, 4, 6 | 95-99% | No | No | 1-5% | | 6 | 9 | | | |
| 1, 2, 3, 4, 6 | 95-99% | No | No | 1-5% | | 6 | 9 | {close oversize brace} | 1.61-3.88 | 35-245 |
| 1, 2, 3, 4, 6 | 95-99% | No | No | 1-5% | | 6 | 9 | | | |
| 1, 2, 3, 4, 6 | 95-99% | No | No | 1-5% | | 6 | 9 | | | |
| 1, 2, 3, 4, 6 | 95-99% | 11-20% | No | 1-5% | | 6 | 9 | | | |
| 1, 2, 3, 4, 6 | 95-99% | 11-20% | No | 1-5% | | 6 | 9 | {close oversize brace} | 1.6-6.60 | .15-1.30 |
| 1, 2, 3, 4, 6 | 95-99% | 11-20% | No | 1-5% | | 6 | 9 | | | |

TABLE 35
Methods and Compositions
15-25 g/m2 weiht

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | | 5 | 9 | | | |
| 1, 2, 3, 4, 6 | 95-99% | No | No | 1-5% | | 5 | 9 | | | |
| 1, 2, 3, 4, 6 | 95-99% | No | No | 1-5% | | 5 | 9 | | | |
| 1, 2, 3, 4, 6 | 95-99% | No | No | 1-5% | | 5 | 9 | {close oversize brace} | .96-2.55 | 5.9-20 |
| 1, 2, 3, 4, 6 | 95-99% | No | No | 1-5% | | 5 | 9 | | | |
| 1, 2, 3, 4, 6 | 95-99% | No | No | 1-5% | | 5 | 9 | | | |
| 1, 2, 3, 4, 6 | 95-99% | 11-20% | No | 1-5% | | 5 | 9 | | | |
| 1, 2, 3, 4, 6 | 95-99% | 11-20% | No | 1-5% | | 5 | 9 | {close oversize brace} | 1.49-2.81 | .12-11.2 |
| 1, 2, 3, 4, 6 | 95-99% | 11-20% | No | 1-5% | | 5 | 9 | | | |

TABLE 36
Methods and Compositions
15-30 micron thickness

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | 3 | 6.7 | 9 | | | |
| 1, 2, 3, 4, 6 | 95-99% | No | No | 1-5% | 3 | 6.7 | 9 | | | |
| 1, 2, 3, 4, 6 | 95-99% | No | No | 1-5% | 3 | 6.7 | 9 | | | |
| 1, 2, 3, 4, 6 | 95-99% | No | No | 1-5% | 3 | 6.7 | 9 | | | |
| 1, 2, 3, 4, 6 | 95-99% | No | No | 1-5% | 3 | 6.7 | 9 | {close oversize brace} | .75-2.66 | 7.7-55 |
| 1, 2, 3, 4, 6 | 95-99% | No | No | 1-5% | 3 | 6.7 | 9 | | | |
| 1, 2, 3, 4, 6 | 95-99% | No | No | 1-5% | 3 | 6.7 | 9 | | | |
| 1, 2, 3, 4, 6 | 95-99% | No | No | 1-5% | 3 | 6.7 | 9 | | | |
| 1, 2, 3, 4, 6 | 95-99% | No | No | 1-5% | 3 | 6.7 | 9 | | | |

TABLE 37
Methods and Compositions
15 to 30 micron thickness

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | 3, 4, 5 | 6 | 10 | | | |
| 1, 2, 3, 4, 6 | 95-99% | No | No | 1-5% | 3, 4, 5 | 6 | 10 | | | |
| 1, 2, 3, 4, 6 | 95-99% | No | No | 1-5% | 3, 4, 5 | 6 | 10 | | | |
| 1, 2, 3, 4, 6 | 95-99% | No | No | 1-5% | 3, 4, 5 | 6 | 10 | | | |
| 1, 2, 3, 4, 6 | 95-99% | No | No | 1-5% | 3, 4, 5 | 6 | 10 | {close oversize brace} | 4.2-7.2 | 22-61.5 |
| 1, 2, 3, 4, 6 | 95-99% | No | No | 1-5% | 3, 4, 5 | 6 | 10 | | | |
| 1, 2, 3, 4, 6 | 95-99% | No | No | 1-5% | 3, 4, 5 | 6 | 10 | | | |
| 1, 2, 3, 4, 6 | 95-99% | No | No | 1-5% | 3, 4, 5, | 6 | 10 | | | |
| 1, 2, 3, 4, 6 | 95-99% | No | No | 1-5% | 3, 4, 5 | 6 | 10 | | | |

TABLE 33A
Methods and Compositions
15-25 g/m2 weight

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | 3, 4, 5 | 7 | 9 | | | |
| 1, 2, 3, 4, 6 | 95-99% | No | No | 1-5% | 3, 4, 5 | 7 | 9 | | | |
| 1, 2, 3, 4, 6 | 95-99% | No | No | 1-5% | 3, 4, 5 | 7 | 9 | | | |
| 1, 2, 3, 4, 6 | 95-99% | No | No | 1-5% | 3, 4, 5 | 7 | 9 | {close oversize brace} | 1.26-4.88 | 6.1-78.4 |
| 1, 2, 3, 4, 6 | 95-99% | No | No | 1-5% | 3, 4, 5 | 7 | 9 | | | |
| 1, 2, 3, 4, 6 | 95-99% | No | No | 1-5% | 3, 4, 5 | 7 | 9 | | | |
| 1, 2, 3, 4, 6 | 95-99% | 11-20% | No | 1-5% | 3, 4, 5 | 7 | 9 | | | |
| 1, 2, 3, 4, 6 | 95-99% | 11-20% | No | 1-5% | 3, 4, 5 | 7 | 9 | {close oversize brace} | 1.51-5.9 | .12-1.11 |
| 1, 2, 3, 4, 6 | 95-99% | 11-20% | No | 1-5% | 3, 4, 5 | 7 | 9 | | | |

TABLE 34
Methods and Compositions
15-25 g/m2 weight

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | | 6 | 9 | | | |
| 1, 2, 3, 4, 6 | 95-99% | No | No | 1-5% | | 6 | 9 | | | |
| 1, 2, 3, 4, 6 | 95-99% | No | No | 1-5% | | 6 | 9 | | | |
| 1, 2, 3, 4, 6 | 95-99% | No | No | 1-5% | | 6 | 9 | {close oversize brace} | 1.61-3.88 | 35-245 |
| 1, 2, 3, 4, 6 | 95-99% | No | No | 1-5% | | 6 | 9 | | | |
| 1, 2, 3, 4, 6 | 95-99% | No | No | 1-5% | | 6 | 9 | | | |
| 1, 2, 3, 4, 6 | 95-99% | 11-20% | No | 1-5% | | 6 | 9 | | | |
| 1, 2, 3, 4, 6 | 95-99% | 11-20% | No | 1-5% | | 6 | 9 | {close oversize brace} | 1.6-6.60 | .15-1.30 |
| 1, 2, 3, 4, 6 | 95-99% | 11-20% | No | 1-5% | | 6 | 9 | | | |

TABLE 35
Methods and Compositions
15-25 g/m2 weith

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | | 5 | 9 | | | |
| 1, 2, 3, 4, 6 | 95-99% | No | No | 1-5% | | 5 | 9 | | | |
| 1, 2, 3, 4, 6 | 95-99% | No | No | 1-5% | | 5 | 9 | | | |
| 1, 2, 3, 4, 6 | 95-99% | No | No | 1-5% | | 5 | 9 | {close oversize brace} | .96-2.55 | 5.9-20 |
| 1, 2, 3, 4, 6 | 95-99% | No | No | 1-5% | | 5 | 9 | | | |
| 1, 2, 3, 4, 6 | 95-99% | No | No | 1-5% | | 5 | 9 | | | |
| 1, 2, 3, 4, 6 | 95-99% | 11-20% | No | 1-5% | | 5 | 9 | | | |
| 1, 2, 3, 4, 6 | 95-99% | 11-20% | No | 1-5% | | 5 | 9 | {close oversize brace} | 1.49-2.81 | .12-11.2 |
| 1, 2, 3, 4, 6 | 95-99% | 11-20% | No | 1-5% | | 5 | 9 | | | |

TABLE 38
Methods and Compositions
15 to 30 micron thickness

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | 7 | 3.5 | 10 | | | |
| 1, 2, 3, 4, 6 | 95-99% | No | No | 1-5% | 7 | 3.5 | 10 | | | |
| 1, 2, 3, 4, 6 | 95-99% | No | No | 1-5% | 7 | 3.5 | 10 | | | |
| 1, 2, 3, 4, 6 | 95-99% | No | No | 1-5% | 7 | 3.5 | 10 | | | |
| 1, 2, 3, 4, 6 | 95-99% | No | No | 1-5% | 7 | 3.5 | 10 | {close oversize brace} | 4.9-8.9 | 44-90 |
| 1, 2, 3, 4, 6 | 95-99% | No | No | 1-5% | 7 | 3.5 | 10 | | | |
| 1, 2, 3, 4, 6 | 95-99% | No | No | 1-5% | 7 | 3.5 | 10 | | | |
| 1, 2, 3, 4, 6 | 95-99% | No | No | 1-5% | 7 | 3.5 | 10 | | | |
| 1, 2, 3, 4, 6 | 95-99% | No | No | 1-5% | 7 | 3.5 | 10 | | | |

TABLE 39
Methods and Compositions
15 to 30 micron thickness

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | 6 | 8 | 10 | | | |
| 1, 2, 3, 4, 6 | 95-99% | No | No | 1-5% | 6 | 8 | 10 | | | |
| 1, 2, 3, 4, 6 | 95-99% | No | No | 1-5% | 6 | 8 | 10 | | | |
| 1, 2, 3, 4, 6 | 95-99% | No | No | 1-5% | 6 | 8 | 10 | | | |
| 1, 2, 3, 4, 6 | 95-99% | No | No | 1-5% | 6 | 8 | 10 | {close oversize brace} | 3.5-9.4 | 10.6-93 |
| 1, 2, 3, 4, 6 | 95-99% | No | No | 1-5% | 6 | 8 | 10 | | | |
| 1, 2, 3, 4, 6 | 95-99% | No | No | 1-5% | 6 | 8 | 10 | | | |
| 1, 2, 3, 4, 6 | 95-99% | No | No | 1-5% | 6 | 8 | 10 | | | |
| 1, 2, 3, 4, 6 | 95-99% | No | No | 1-5% | 6 | 8 | 10 | | | |

TABLE 40
Methods and Compositions
15 to 30 micron thickness

| | | | | | | | | | Barrier ranges | |
|---|---|---|---|---|---|---|---|---|---|---|
| | | | | | | | | | Transmission Rates | |
| Thremoplastic | Thermoplastic | EVOH | PEN | Particle blocks | | Intial | Final | | MVTR | Oxygen |
| blocks | Volume | Content | Content | Volume | Type | process | process | | 90% RH | 0% RH |
| 1, 2, 3 4, 6 | 95-99% | No | No | 1-5% | 6 | 8 | 9 | | | |
| 1, 2, 3, 4, 6 | 95-99% | No | No | 1-5% | 6 | 8 | 9 | | | |
| 1, 2, 3, 4, 6 | 95-99% | No | No | 1-5% | 6 | 8 | 9 | | | |
| 1, 2, 3, 4, 6 | 95-99% | No | No | 1-5% | 6 | 8 | 9 | | | |
| 1, 2, 3, 4, 6 | 95-99% | No | No | 1-5% | 6 | 8 | 9 | {close oversize brace} | .27-1.66 | .69-75.4 |
| 1, 2, 3, 4, 6 | 95-99% | No | No | 1-5% | 6 | 8 | 9 | | | |
| 1, 2, 3, 4, 6 | 95-99% | No | No | 1-5% | 6 | 8 | 9 | | | |
| 1, 2, 3, 4, 6 | 95-99% | No | No | 1-5% | 6 | 8 | 9 | | | |
| 1, 2, 3, 4, 6 | 95-99% | No | No | 1-5% | 6 | 8 | 9 | | | |

TABLE 41
Methods and
Compositions
25 micron thickness

| | | | | | | | Barrier ranges | |
|---|---|---|---|---|---|---|---|---|
| | | | | | | | Transmission Rates | |
| Thermoplastic | Thermoplastic | EVOH | PEN | Particle blocks | | Process | MVTR | Oxygen |
| block | Mass | Content | Content | mass | Type | blocks | 90% RH | 0% RH |
| 3 | 95-98.0 | No | No | 2.0-5% | 7 | 1, 2, 3, 10 | 7.6-8.1 | 20-50 |
| 3 | 95-98.0 | No | No | 2.0-5% | 7 | 1, 2, 3, 9 | 1.2-2.5 | 3-35 |
| 1 | 95-98.0 | No | No | 2.0% | 7 | 1, 2, 3, 9 | 1.8-3.5 | 5-41 |
| 1 | 95-98.0 | No | No | 2.0-5% | 7 | 1, 2, 3, 10 | 7.1-8.6 | 11-48 |
| 2 | 95-98.0 | No | No | 2.0.-5% | 7 | 1, 2, 3, 9 | 1.2-2 | .11-22 |
| 2 | 95-98.0 | No | No | 2.0-5% | 7 | 1, 2, 3, 10 | 5.4-8.9 | 11-29 |

TABLE 42
Methods and Compositions
25 micron thickness

| | | | | | | | Barrier ranges | |
|---|---|---|---|---|---|---|---|---|
| | | | | | | | Transmission Rates | |
| Thermoplastic | Thermoplastic | EVOH | PEN | Particle blocks | | Process | MVTR | Oxygen |
| block | Mass | Content | Content | mass | Type | block | 90% RH | 0% RH |
| 3 | 94-97.5% | No | No | 2.5-6% | 8 | 9 | 1.3-2.4 | 3-19 |
| 3 | 94-97.5% | No | No | 2.5-6% | 8 | 10 | 7.1-9.0 | 18-47 |
| 1 | 94-97.5% | No | No | 2.5-6% | 8 | 9 | 1.0-2.9 | 9-32 |
| 1 | 94-97.5% | No | No | 2.5-6% | 8 | 10 | 6.4-8.8 | 15-55 |
| 2 | 94-97.5% | No | No | 2.5-6% | 8 | 9 | 1.4-2.2 | .18-17 |
| 2 | 94-97.5% | No | No | 2.5-6% | 8 | 10 | 7.7-8.9 | 15-36 |

TABLE 43
Methods and Compositions
25 micron thickness

| | | | | | | | Barrier ranges | |
|---|---|---|---|---|---|---|---|---|
| | | | | | | | Transmission Rates | |
| Thermoplastic | Thermoplastic | EVOH | PEN | Particle blocks | | Process | MVTR | Oxygen |
| block | Mass | Content | Content | mass | Type | block | 90% RH | 0% RH |
| 2, 3, 4, 6, 7 | 94-97.5% | No | No | 2.6-% | 7, 8, 9, 10 | 7, 9 | 1.5-2.4 | 1.5-19 |
| 2, 3, 4, 6, 7 | 94-97.5% | No | No | 2.5-6% | 7, 8, 9, 10 | 7, 9, 10 | 5.4-9.0 | 7.3-47 |
| 2, 3, 4, 6, 7 | 94-97.5% | No | No | 2.5-6% | 7, 8, 9, 10 | 7, 9 | 1.0-2.9 | 1.1-32 |
| 2, 3, 4, 6, 7 | 94-97.5% | No | No | 2.5-6% | 7, 8, 9, 10 | 7, 9, 10 | 6.0-8.2 | 8.6-15 |
| 2, 3, 4, 6, 7 | 94-97.5% | No | No | 2.5-6% | 7, 8, 9, 10 | 7, 9 | .9-3.1 | .18-17 |
| 2, 3, 4, 6, 7 | 94-97.5% | No | No | 2.5-6% | 7, 8, 9, 10 | 7, 10 | .77-3.8 | .59-9.1 |

TABLE 44
Methods and Compositions
25 micron thickness

| | | | | | | | Barrier ranges | |
|---|---|---|---|---|---|---|---|---|
| | | | | | | | Transmission Rates | |
| Thermoplastic | Thermoplastic | EVOH | PEN | Particle blocks | | Process | MVTR | Oxygen |
| block | Mass | Content | Content | mass | Type | block | 90% RH | 0% RH |
| 3.4 | 94-97.5% | No | No | 2.5-6% | 10, 8 | 6, 10 | 6.4-8.8 | 20-45 |
| | 94-97.5% | No | No | 2.5-6% | | | 5.3-7.5 | 15-32 |
| | 94-97.5% | No | No | 2.5-6% | | | 7.8-9.8 | 10-45 |
| | 94-97.5% | No | No | 2.5-6% | | | 7.3-8.3 | 15-64 |
| | 94-97.5% | No | No | 2.5-6% | | | | |
| | 94-97.5% | No | No | 2.5-6% | | | | |

TABLE 45
Natural fiber layer characteristics in extrusion coatings and
laminations used with particles, e.g., Processing Block 10 for
thermoplastics and barrier results found within Tables 1-44

| | |
|---|---|
| Fiber Aspect Ratio (Average) | 5-100 |
| Fiber Thickness (Softwood) | 1.5-30 mm |
| Fiber Thickness (Hardwood) | 0.5-30 mm |
| Filled Fiber Content | 1% to 30% |
| Fiber Density | 0.3-0.7 g/cm² |
| Fiber Diameter | 16-42 microns |
| Fiber Coarseness | 16-42 mg/100m |
| Fiber Pulp Types (Single- to | Mechanical, Thermo-Mechanical, |
| Triple-Layered) | Chemi-Thermo-Mechanical, and Chemical |
| Permeability | 0.1-110 m² × 10¹⁵ |
| Hydrogen Ion Concentration | 4.5-10 |
| Tear Strength (Tappi 496, 402) | 56-250 |
| Tear Resistance (Tappi 414) | m49-250 |
| Moisture Content | 2%-18% by Weight |

TABLE 46
Composite fiber content used during extrusion coatings and laminations to fiber substates
per Processing Block 10 found within some of Tables 1-44.

| Fiber Weight (lbs/3 msf) | g/m² | Tear Resistance (Mn) | Surface Roughness | Burst Strength (kPa) |
|---|---|---|---|---|
| 40-75 | 60-110 | 400-700 | 2.0-5.5 mm | 140-300 |
| 75 | 110-130 | 650-750 | 2.0-3.5 mm | 175-400 |
| 115 | 180-190 | 1400-1900 | 100-2500 mls/min | 175-475 |
| 130 | 205-215 | 1600-2200 | 100-2500 mls/min | 250-675 |
| 200 | 315-330 | 1900-3200 | 100-2500 mls/min | 500-950 |
| 300 | 460-195 | 500-4000 | 100-2500 mls/min | 700-1850 |

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

I claim:

1. A composite packaging structure having an oxygen and moisture barrier, comprising:
a thermoplastic nanocomposite comprising one or more polymer layers, each containing a plurality of nanoparticle content;
wherein the one or more polymer layers have net negative charged hydrophobic particles that are contained within the thermoplastic nanocomposite with a chemical formula of Al2,H2,O12,Si4;
wherein the one or more polymer layers comprise a montmorillonite clay structure that comprises one or more of OMMT, OMT and, MMT;
wherein the montmorillonite clay structure further comprises at least one octahedral sheet that contains one or more of aluminum hydroxide and magnesium hydroxide;
wherein said at least one octahedral sheet has a cation exchange capacity (CEC) of about 250 meq/100 g;
wherein the OMMT, OMMT, and MMT each have a purity of about 99.99%;
wherein the plurality of nanoparticle content has sizes in the range of about 80-100 nm, as measured using dynamic light scattering, and a crystalline nanoclay phase identity of about 2.1 smectite particles to montmorillonite particles;
wherein the plurality of nanoparticle content comprises one or more plate-like structures;
wherein the one or more plate-like structures comprise two silica tetrahedral sheets having the at least one octahedral sheet, forming about a 2:1 layer structure, and which are free-flowing particle structures;
wherein the free-flowing particle structures have surface modifications to include dimethyldialkyl (C16-C18) ammonium chloride;
wherein the free-flowing particle structures have a CEC of about 250 meq/100 g as measured by one or more of atomic absorption spectroscopy and inductively coupled plasma spectroscopy;
wherein the free-flowing particle structures have a pH of about 7.5 as measured indirectly by creating a suspension of the particles in deionized water and then measuring the pH of that deionized water;
wherein the free-flowing particle structures have a particle specific surface area in the range of about 220-270 m2/g as measured using the Brunauer-Emmett-Teller method;
wherein the free-flowing particle structures, after intercalation and exfoliation, have aspect ratios within the range of about 300-700, as determined by transmission electron microscopy; and
wherein the one or more plate-like structures have a plate size length of about 600-700 nm and a plate size width of about 600-700 nm, as measured using one or more of transmission electron microscopy and atomic force microscopy, and have a thickness in the range of about 1-2 nm as measured using X-ray diffraction.

2. The composite packaging structure of claim 1, wherein said composite packaging structure is used to form a packaging selected from the group of packaging consisting of: a rigid package and a flexible package.

3. The composite packaging structure of claim 1, wherein the plurality of nanoparticle content, when compounded in polyethylene, and then forming a 50-micron barrier layer, has a moisture barrier transmission rate, at about 38 C and about 90% relative humidity, in the range of about 0.37 to 0.51 as per ASTM 1249.

4. The composite packaging structure of claim 1, wherein the plurality of nanoparticle content, when compounded into a thermoplastic, and then forming a 50-micron barrier layer, has an oxygen transmission rate, at about 23 C and about 0% relative humidity, in the range of about 0.28 to 0.36 as per ISO 15105-1.

5. The composite packaging structure of claim 1, wherein the plurality of nanoparticle content, when forming a 25 g/m2 fiber coating layer has, at about 38 C and about 90% relative humidity, a moisture barrier transmission rate from about 7.1-9.0, as per ISO 4592.

6. A composite packaging structure having a thermoplastic oxygen and moisture barrier structure as a monolayer or individual layer in a coextrusion, comprising:
a plurality of montmorillonite particles, selected from the group of particles consisting of one or more of: OMMT; OMT; and MMT;
wherein the plurality of montmorillonite particles have a cation exchange capacity of about 200 to 300 meq/100 g as measured by one or more of atomic absorption spectroscopy and inductively coupled plasma spectroscopy.

7. The composite packaging structure according to claim 6, wherein the thermoplastic oxygen and moisture barrier structure has a (i) moisture barrier transmission rate, at about 37.8 C and about 90% relative humidity in one or more of the ranges selected from the group of ranges consisting of: about 1.5-2.9; about 3.4-4.9; about 1.0-2.9, about 6.0-8.2; 0.9-3.2; about 0.77-3.8; per Tappi T464; (ii) an oxygen barrier transmission rate, at about 23 C and about 0% relative humidity in one or more of the ranges selected from the group of ranges consisting of: about 1.5-19; about 7.3-47; about 1.1-320; about 8.6-15; about 0.18-1.2; about 0.59-9; per ASTM F2622, at 760 mmHg gas pressure, test gas is 100% oxygen per Mocon QMS 702-002, measured at cc/m2/day.

8. The composite packaging structure according to claim 6, wherein the thermoplastic oxygen and moisture barrier structure has a (i) moisture barrier transmission rate, at about 37.8 C and about 90% relative humidity in one or more of the ranges selected from the group of ranges consisting of: about 1.3-2.4; about 7.1-9.0; about 1.0-2.9; about 6.4-8.8; about 1.4-2.2; about 7.7-8.9; per Tappi T464; (ii) an oxygen barrier transmission rate, at about 23 C and about 0% relative humidity in one or more of the ranges selected from the group of ranges consisting of: about 3-19; about 18-47; about 9-32; about 15-155; about 0.18-17; about 15-36; per ASTM F2622, at 760 mmHg gas pressure, test gas is 100% oxygen per Mocon QMS 702-002, measured at cc/m2/day.

9. The composite packaging structure according to claim 6, wherein the thermoplastic oxygen and moisture barrier structure has a (i) moisture barrier transmission rate, at about 37.8 C and about 90% relative humidity in one or more of the ranges selected from the group of ranges consisting of: about 6.4-8.8; about 5.3-7.5; about 7.8-9.8; about 7.3-8.3; per Tappi T464; (ii) an oxygen barrier transmission rate, at about 23 C and about 0% relative humidity in one or more of the ranges selected from the group of ranges consisting of: about 20-45; about 15-32; about 10-45; about 15-64; per ASTM F2622, at 760 mmHg gas pressure, test gas is 100% oxygen per Mocon QMS 702-002, measured at cc/m2/day.

10. The composite packaging structure according to claim 6, wherein the plurality of montmorillonite particles have a pH in the range of about 6-8 as measured indirectly by creating a suspension of the particles in a liquid and then measuring the pH of that liquid.

11. The composite packaging structure according to claim 6, wherein the plurality of montmorillonite particles have a particle specific surface area in the range of about 200-290 m2/g measured using the Brunauer-Emmett-Teller method.

12. The composite packaging structure according to claim 6, further comprising:
a plurality of nanoparticle content comprising net negative charged hydrophobic particles that are contained within a thermoplastic nanocomposite;
wherein the plurality of nanoparticle content comprises said plurality of montmorillonite particles that have a montmorillonite clay structure comprising at least one octahedral sheet that contains one or more of aluminum hydroxide and magnesium hydroxide;
the plurality of montmorillonite particles having an isomorphous substitution rate in one or more of the ranges selected from the group of ranges consisting of: 0.25-0.50; 0.51-1.0; 1.01-1.50; 1.51-2.0; 2.01-2.5; 2.6-3.5; and 3.6-4.0; units per formula unit as characterized by calculating a charge deficit; and
wherein said isomorphous substitution rate is the net negative charge that results from substitution of one or more Al3+ with one or more Mg2+.

13. The composite packaging structure according to claim 12, wherein the plurality of nanoparticle content has particle sizes in at least one dimension of about 65-100 nm, as determined by one or more of the following: an instrument of Malvern Instruments, Ltd., Malvern, UK; a Mastersizer 3000; and analytical methods pertaining to ISO 13320-2020; and a crystalline nanoclay phase identity of 2.1 smectite particles to montmorillonite particles.

14. The composite packaging structure according to claim 12, wherein the plurality of nanoparticle content comprises one or more plate-like structures;
wherein the one or more plate-like structures comprise two silica tetrahedral sheets having the at least one octahedral sheet, forming about a 2:1 layer structure, and which are free-flowing particle structures;
wherein the free-flowing particle structures have surface modifications to include dimethyldialkyl (C16-C18) ammonium chloride;
wherein the free-flowing particle structures, after intercalation and exfoliation, have aspect ratios within the range of about 200-900;
wherein the plurality of nanoparticle content has a density in the range of about 1.2 g/cm to 2.7 g/cm3; and
wherein the plurality of nanoparticle content of about 1.5% to 15% by weight of the thermoplastic oxygen and moisture barrier structure.

15. The composite packaging structure according to claim 14, wherein the plurality of nanoparticle content has particle sizes of about 70-100 nm as measured using dynamic light scattering; and
wherein the one or more plate-like structures have a plate size length of about 500-800 nm and have a plate size width of about 500-800 nm, as measured using one or more of transmission electron microscopy and atomic force microscopy, and have a thickness in the range of about 1-3 nm as measured using X-ray diffraction.

16. The composite packaging structure according to claim 12, wherein the plurality of nanoparticle content has at least two nucleation densities, a first within a first range of about 10\hat{ }6-10\hat{ }8 and a second within a second range of about 10\hat{ }9-10\hat{ }12, as determined by polarized optical microscopy and as provided in ASTM D3324.

17. The composite packaging structure according to claim 12, wherein the plurality of nanoparticle content is about 2.5-6% by volume of the thermoplastic oxygen and moisture barrier structure.

18. The composite packaging structure according to claim 6, further comprising a mineral-containing polymer layer that comprises a polymer matrix;
wherein the plurality of montmorillonite particles are bimodal particles that are dispersed within the polymer matrix;
wherein the bimodal particles have at least two nucleation densities, a first within a first range of about 10\hat{ }6-10\hat{ }8 and a second within a second range of 10\hat{ }9-10\hat{ }12, as determined by polarized optical microscopy and as provided in ASTM D3324.

19. The composite packaging structure according to claim 6, wherein the plurality of montmorillonite particles comprise one or more plate-like structures;
wherein the one or more plate-like structures comprise at least two silica tetrahedral sheets having at least one octahedral sheet, forming about a 2:1 layer structure, and which are free-flowing particle structures;
wherein the free-flowing particle structures have surface modifications to include dimethyldialkyl (C16-C18) ammonium chloride; and
wherein the one or more plate-like structures have aspect ratios within the range of about 300-700, as determined by transmission electron microscopy.

20. The composite packaging structure according to claim 6, wherein the plurality of montmorillonite particles, pre-intercalation, have a particle size distribution of about 35-175 nm and have a D90 is about 73.6-110.4 nm, as determined by one or more of: an instrument of Malvern Instruments, Ltd., Malvern, UK; a Mastersizer 3000; and
analytical methods pertaining to ISO 13320-2020.

21. The composite packaging structure according to claim 6, wherein the plurality of montmorillonite particles have mean particles sizes of about 5-75 nm or of about 5-100 nm, as determined by one or more of: volumetric dynamic laser light scattering method, Malvern® particle size analyzer, Mastersizer® 3000 particle size analyzer, a particle size analyzer using analytical methods pertaining to ISO 13320-2020, and transmission electron microscopy.

22. The composite packaging structure according to claim 6, wherein the plurality of montmorillonite particles have a density between about 1.2 g/cm3 to 2.7 g/cm3, as characterized by the Pycnometer Method, ASTM D3878, ISO 1183, and X-ray reflectivity.

23. The composite packaging structure according to claim 6, wherein, wherein the plurality of montmorillonite particles, pre-intercalation, have an organic interlayer d-spacing between about 0.9 nm to 3.0 nm;
wherein the plurality of montmorillonite particles, when partially or fully intercalated, have an organic interlayer d-layer spacing between about 2.0-10 nm; and
wherein the plurality of montmorillonite particles, when partially to predominantly exfoliated, have an organic interlayer d-spacing between about 10 nm to an obscure to invisible XRD peak, as measured by transmission electron microscopy.

24. The composite packaging structure according to claim 14, wherein the one or more plate-like structures have a plate size length of about 500-800 nm and a plate size width of about 500-800 nm, as measured using one or more of transmission electron microscopy and atomic force microscopy, and have a thickness in the range of about 1-3 nm as measured using X-ray diffraction.

25. The composite packaging structure of claim 6, wherein the composite packaging structure is used to form a packaging selected from the group of packaging consisting of: a rigid package and a flexible package.
